(19) United States
(12) Patent Application Publication
(10) Pub. No.: US 2018/0190080 A1
(43) Pub. Date: Jul. 5, 2018

(54) MATCH-X WAGERING GAME WITH POKER HANDS

(71) Applicant: SYNERGY BLUE, LLC, Palm Desert, CA (US)

(72) Inventors: GEORG WASHINGTON, RANCHO MIRAGE, CA (US); Joe Serra, Palm Desert, CA (US); Michael Oberberger, Spring Hill, TN (US)

(73) Assignee: SYNERGY BLUE, LLC, PALM DESERT, CA (US)

(21) Appl. No.: 15/910,969

(22) Filed: Mar. 2, 2018

Related U.S. Application Data
(63) Continuation-in-part of application No. 15/597,099, filed on May 16, 2017.
Application No. 15/597,099 is a continuation-in-part of application No. 14/865,538, filed on Sep. 25, 2015, now Pat. No. 9,542,799.
(60) Provisional application No. 62/466,340, filed on Mar. 2, 2017.
(60) Provisional application No. 62/091,451, filed on Dec. 12, 2014.
(60) Provisional application No. 62/127,821, filed on Mar. 3, 2015.

(51) Int. Cl. G07F 17/32

(52) U.S. Cl. CPC G07F 17/3293; G07F 17/3267; G07F 17/3272; G07F 17/3244

(57) ABSTRACT

Various techniques are disclosed for implementing different types of automated wager-based game techniques during play of hybrid skill-based/wager-based games conducted at an electronic gaming device of a computer network.

### RELATED APPLICATION DATA

The present application claims benefit, pursuant to the provisions of 35 U.S.C. § 119, of U.S. Provisional Application Ser. No. 62/466,340 (Attorney Docket No. SYNBP011P), titled “MATCH-X WAGERING GAME WITH POKER HANDS”, naming Washington et al. as inventors, and filed 2-Mar.-2017, the entirety of which is incorporated herein by reference for all purposes.

This application is a continuation-in-part (CIP) application, pursuant to the provisions of 35 U.S.C. § 120, of prior U.S. patent application Ser. No. 15/597,099 (Attorney Docket No. SYNBP009US) titled “ACHIEVEMENT-BASED PAYOUT SCHEDULE UNLOCK TECHNIQUES IMPLEMENTED IN WAGER-BASED GAMING NETWORKS” naming Washington et al. as inventors, and filed on 16 May 2017, the entirety of which is incorporated herein by reference for all purposes.

This application is also a continuation-in-part (CIP) application, pursuant to the provisions of 35 U.S.C. § 120, of prior U.S. patent application Ser. No. 14/865,538 (Attorney Docket No. SYNBP001X1US) titled “HYBRID ARCADE-TYPE, WAGER-BASED GAMING TECHNIQUES AND PREDETERMINED RNG OUTCOME BATCH RETRIEVAL TECHNIQUES” by Washington et al., filed on 25 Sep. 2015, the entirety of which is incorporated herein by reference for all purposes.

U.S. patent application Ser. No. 14/865,538 claims benefit, pursuant to the provisions of 35 U.S.C. § 119, of U.S. Provisional Application Ser. No. 62/091,451 (Attorney Docket No. SYNBP001P), titled “HYBRID ARCADE-TYPE, WAGER-BASED GAMING TECHNIQUES”, naming Washington et al. as inventors, and filed 12 Dec. 2014, the entirety of which is incorporated herein by reference for all purposes.

U.S. patent application Ser. No. 14/865,538 also claims benefit, pursuant to the provisions of 35 U.S.C. § 119, of U.S. Provisional Application Ser. No. 62/127,821 (Attorney Docket No. SYNBP001P2), titled “RPG AND SPORTS THEMED HYBRID ARCADE-TYPE, WAGER-BASED GAMING TECHNIQUES”, naming Washington et al. as inventors, and filed 3 Mar. 2015, the entirety of which is incorporated herein by reference for all purposes.

### BACKGROUND

U.S. patent application Ser. No. 14/865,538 (herein “Parent Application”) discloses various aspects for implementing hybrid arcade/wager-based gaming techniques in casino gaming networks, in which the hybrid arcade/wager-based game may include a non-wager based gaming portion and a wager-based gaming portion. A player engaged in play of the hybrid arcade/wager-based game is able to concurrently engage in continuous game play of the non-wager based gaming portion during execution of wager-based gaming events which are automatically triggered based on events which occur during play of the non-wager based gaming portion. One of the benefits of the hybrid arcade/wager-based gaming techniques disclosed in the parent application is that various hybrid arcade/wager-based game embodiments may be configured or designed such that the outcomes and/or payouts of the wager-based game events are not dependent on, or influenced by, the level of skill of the player. Accordingly, many of the hybrid arcade/wager-based game embodiments disclosed in the parent application may be characterized (e.g., from a regulatory perspective) as games of chance since, for example, in at least some embodiments, the wager-based game events are implemented as a RNG-based games of chance. In at least some embodiments described in the parent application, the outcome of at least one wager-based game event occurring in the hybrid arcade/wager-based game may be predetermined before initiation of the wager-based game event, and the outcome of the wager-based game event may be subsequently revealed to the player in response to input provided by the player during play of the hybrid arcade/wager-based game. In other embodiments, the outcome of at least one wager-based game event occurring in the hybrid arcade/wager-based game may be determined after initiation of the wager-based game event, and the outcome of the wager-based game event may be subsequently revealed to the player in response to input provided by the player during play of the hybrid arcade/wager-based game.

### BRIEF DESCRIPTION OF THE DRAWINGS

FIG. 1 illustrates a simplified block diagram of a specific example embodiment of a Gaming Network 100 which may be configured or designed to implement various hybrid skill-based/wager-based gaming techniques described and/or referenced herein.

FIG. 2 shows an example block diagram of an electronic gaming system 200 in accordance with a specific embodiment.

FIG. 3 illustrates a network diagram of an example embodiment of a Gaming Network 300 which may be configured or designed to implement various hybrid skill-based/wager-based gaming techniques described and/or referenced herein.

FIG. 4 shows a block diagram of electronic gaming device 400, in accordance with a specific embodiment.

FIG. 5 is a simplified block diagram of an exemplary intelligent electronic gaming system 500 in accordance with a specific embodiment.

FIG. 6 is a simplified block diagram of an exemplary mobile gaming device 600 in accordance with a specific embodiment.

FIG. 7 illustrates an example embodiment of a System Server 780 which may be used for implementing various aspects/features described herein.

FIG. 8 illustrates an example of a functional block diagram of a Gaming System Server in accordance with a specific embodiment.

FIG. 9 shows a block diagram illustrating components of a gaming system 900 which may be used for implementing various aspects of example embodiments.

FIGS. 10-13 illustrate various example embodiments of different hybrid skill-based/wager-based gaming procedures and/or procedural flows which may be used for facilitating activities relating to one or more of the Match-X Wagering Game aspects disclosed herein.

FIG. 14 shows a block diagram of electronic gaming machine (e.g., EGM), in accordance with a specific embodiment.

FIG. 15 shows a screenshot of an example embodiment of a hybrid skill-based/wager-based Match-X Poker Game GUI 1500 which may be used for facilitating game play and wagering activities relating to play of one or more HAWG-type Match-X Wagering Games.

FIG. 16 shows an example flow diagram of a Match-X Wagering Game Procedure A 1600 in accordance with an example embodiment.

FIGS. 17-26, and 29-31 illustrate example screenshot of different graphical user interfaces (GUIs) which may be used to facilitate, initiate and/or perform various operation(s) and/or action(s) relating to one or more of the Match-X Wagering Game aspects disclosed herein.

FIGS. 27, and 33-36 illustrate simplified representations of paytables which may be used for facilitating wager-related activities relating to play of one or more embodiments of Match-X Wagering Games.

FIG. 28 shows an example flow diagram of a Match-X Wagering Game Procedure B 2800, in accordance with an example embodiment.

FIG. 32 illustrates simplified representation of a Paytable Lookup Table which may be used for facilitating wager-related activities relating to play of one or more embodiments of Match-X Wagering Games

### DETAILED DESCRIPTION OF EXAMPLE EMBODIMENTS

### Overview

Various aspects described or referenced herein are directed to different methods, systems, and computer program products for implementing and facilitating various hybrid skill-based/wager-based gaming (“HAWG”) techniques, and Match-X Wagering Game techniques via computer networks, including one or more casino gaming networks.

In at least one embodiment, various method(s), system(s) and/or computer program product(s) may be implemented in computer network including a first electronic, wager-based gaming device (“first EGD”), and a first random number generator engine (“first RNG engine”), the first EGD including a first display and a first input device. In at least one embodiment, at least one processor may execute a plurality of instructions stored in at least one memory to: display, at the first display, a first game graphical user interface (“first game GUI”) configured to enable a player to engage in a first wager-based gaming session of a wager-based game conducted at the first EGD, the first game GUI including a skill-based game GUI portion; display, at the skill-based game GUI portion, a playing field GUI portion, the playing field GUI portion being configured to display an array of virtual playing cards, the playing field GUI portion being further operable to enable the player to engage in interactive activity with at least one virtual playing card displayed at the playing field GUI portion; store in a first memory a plurality of paytable data structures representing a first plurality of paytables; store in the first memory, poker hand criteria defining a plurality of different types of poker hands, including a first poker hand type and a second poker hand type; establish an account balance at the first EGM using at least a portion of cash or credit received from the first player; enable the player to select a first set of virtual playing cards displayed at the playing field GUI portion; identify, using the poker hand criteria, the first set of virtual playing cards as corresponding to the first poker hand type; initiate, during the first wager-based gaming session and in response to the selection of the first set of virtual playing cards, a first wager-based event at the first EGD; automatically fund a first amount wagered on the first wager-based event using funds from the account balance; select a first paytable based on the identified first poker hand type, wherein the first paytable includes a first plurality of payout amounts including a first payout amount and a second payout amount which is different from the first payout amount; randomly select, as an outcome of the first wager-based event, the first payout amount from the first plurality of payout amounts; automatically distribute the first payout amount to the account balance; enable the player to select a second set of virtual playing cards displayed at the playing field GUI portion; identify, using the poker hand criteria, the second set of virtual playing cards as corresponding to the first poker hand type; initiate, during the first wager-based gaming session and in response to the selection of the second set of virtual playing cards, a second wager-based event at the first EGD; automatically fund a second amount wagered on the second wager-based event using funds from the account balance; select the first paytable based on the identified first poker hand type; randomly select, as an outcome of the second wager-based event, the second payout amount from the first plurality of payout amounts; and automatically distribute the second payout amount the account balance. In at least some embodiments, the first amount wagered and the second amount wagered are identical.

Additional method(s), system(s) and/or computer program product(s) may be further operable to cause at least one processor to execute additional instructions to establish at least a portion of the account balance using at least a portion of cash or credit received via a first bill or ticket acceptor.

Additional method(s), system(s) and/or computer program product(s) may be further operable to cause at least one processor to execute additional instructions to: display, at the first game GUI, a wager-based game GUI portion configured to display wager-based game events relating to the wager-based gaming session; display a representation of the first wager-based event being executed at the wager-based game GUI portion during the wager-based gaming session; display a representation of the second wager-based event being executed at the wager-based game GUI portion during the wager-based gaming session at the wager-based game GUI portion; and enable the player to concurrently engage in skill-based game play activities at the skill-based game GUI portion during execution of the second wager-based game event at the wager-based game GUI portion.

Additional method(s), system(s) and/or computer program product(s) may be further operable to cause at least one processor to execute additional instructions to: enable the player to select a third set of virtual playing cards displayed at the playing field GUI portion; identify, using the poker hand criteria, the third set of virtual playing cards as corresponding to the second poker hand type; initiate, during the first wager-based gaming session and in response to the selection of the third set of virtual playing cards, a third wager-based event at the first EGD; automatically fund a third amount wagered on the third wager-based event using funds from the account balance; select the second paytable based on the identified second poker hand type, wherein the second paytable includes a second plurality of payout amounts including a third payout amount and a fourth payout amount which is different from the third payout amount; randomly select, as an outcome of the third wager-based event, the third payout amount from the second plurality of payout amounts; automatically distribute the third payout amount the account balance; enable the player to select a fourth set of virtual playing cards displayed at the playing field GUI portion; identify, using the poker hand criteria, the fourth set of virtual playing cards as corresponding to the second poker hand type; initiate, during the first wager-based gaming session and in response to the selection of the fourth set of virtual playing cards, a fourth wager-based event at the first EGD; automatically fund a fourth amount wagered on the fourth wager-based event using funds from the account balance; select the second paytable based on the identified second poker hand type; randomly select, as an outcome of the fourth wager-based event, the fourth payout amount from the second plurality of payout amounts; and automatically distribute the third payout amount the account balance.

In at least some embodiments, the first EGM may be configured or designed to automatically perform selection of one or more set(s) of virtual playing cards from the skill-based game GUI portion during play of the wager-based gaming session.

Various objects, features and advantages of the various aspects described or referenced herein will become apparent from the following descriptions of its example embodiments, which descriptions should be taken in conjunction with the accompanying drawings.

### Specific Example Embodiments

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way. Devices that are in communication with each other need not be in continuous communication with each other, unless expressly specified otherwise. In addition, devices that are in communication with each other may communicate directly or indirectly through one or more intermediaries. A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (e.g., whether or not they cooperate) may be used in place of a single device/article. Similarly, where more than one device or article is described (e.g., whether or not they cooperate), it will be readily apparent that a single device/article may be used in place of the more than one device or article. The functionality and/or the features of a device may be alternatively embodied by one or more other devices that are not explicitly described as having such functionality/features. Thus, other embodiments of one or more of the invention(s) need not include the device itself. Techniques and mechanisms described or reference herein will sometimes be described in singular form for clarity. However, it should be noted that particular embodiments include multiple iterations of a technique or multiple instantiations of a mechanism unless noted otherwise.

Currently existing slot machine technology is dated and lacking younger demographics due to the same format of gambling gameplay element displays. Problems with existing slot machine and video-based casino gaming technology include: the gambling gameplay display method, and the player interaction method with the gambling game elements using a slot machine.

Veteran gamblers (e.g., older gambler demographic age 50+) have been accustomed to a standard set of video gaming symbols (e.g., A, J, K, Q) which, for example, may be accompanied with a multitude of additional themed symbols (e.g., animals, fantasy creatures, media personas, etc.) presented on a series of wheels or drums. Newer technology has made possible the use of digital display screens that present the reels and symbols in a digital format. Younger generations of gamblers (e.g., herein referred to as “garners”), on the other hand, have been accustomed to increasingly intense and graphically glorified 2D & 3D world environments where an untold amount of possibilities may arise. These gamers, who are used to fast paced, energetic, and visually stunning games, feel that the display method of the traditional slot machines are “boring.” As for the veteran gamblers, they feel that the fast paced, new aged action, is “too much.”

Veteran gamblers have experienced player interaction in a few different ways: (1) a pull lever (2) a spin button (3) interact with a touch screen. Gamers have experienced player interaction in dozens of different ways, such as, for example:
gaming controllers (e.g., Nintendo, PlayStation, XBOX, Wii)
PC HIDs (e.g., mouse, trackball, keyboard)
joysticks
shooting apparatuses
head & body gear (e.g., Victormaxx, Power Glove)
etc.

Much like the comparison between gamers and gamblers in regards to gambling gameplay display methods, the results are similar. The younger players are “bored” whereas the older players feel “intimidated.”

In many existing casino venues, standard classic slot machines are deployed which include an electromagnetic mechanism with a “lever” interface device. Slot machines have also evolved using video screens and electronic push button interfaces, which are typically referred to as “Hybrid Machines” that use a combination of both the mechanical portion and video elements of both designs.

In light of the above, it may be desirable to create and/or implement “hybrid skill-based/wager-based games” or “Gambling Arcade Games” which provide hybrid skill-based, wager-based gaming techniques which may more suitably appeal to the Casino Gamer demographic. However, one significant obstacle regarding such hybrid skill-based, wager-based gaming techniques is that they are often comprised of new/different and complex back end solutions that may require lengthy and costly processes of regulatory review and approvals in many different gaming jurisdictions.

One possible workaround to this significant obstacle is to configure/design a hybrid skill-based, wager-based game such that it is compliant with currently approved wager-based gaming regulatory standards such as, for example, the well-known GLI standards, which have already been approved in various gaming jurisdictions. One example of a GLI standard is the GLI-11 standard version 3.0, Published Sep. 21, 2016 by Gaming Laboratories International, LLC, the entirety of which is herein incorporated by reference for all purposes.

For example, in one embodiment, a hybrid skill-based, wager-based game may be configured or designed to provide a skill-based gaming interface which enables a player to participate in a skill-based game at the wager-based gaming machine. One or more events and/or activities performed by the player (e.g., during play of the skill-based game) may automatically trigger an RNG wager-based event such as, for example, one or more of the following (or combinations thereof):
the spinning of a virtual wager-based slot machine reel (e.g., which may be configured or designed to be compliant with the GLI standard(s));
the spinning of a virtual wheel such as a roulette wheel or “Wheel-of-Fortune”™ wheel;
the throwing/rolling of one or more dice;
the dealing of one or more card(s);
and/or other types of RNG-based video games of chance (preferably which have been configured or designed to be compliant gaming standards, rules and regulations).

Because the wager-based activities of the hybrid skill-based, wager-based game comply with currently existing GLI standard(s) (and/or other national, regional, local gaming rules and regulations), such hybrid skill-based, wager-based games may not require additional regulatory approval for deployment in Casino venues.

Some benefits and advantages of the hybrid skill-based/wager-based gaming techniques described herein may include, but are not limited to, one or more of the following (e.g., or combinations thereof):
Enabling the utilization of the same (e.g., proven/GLI approved) slot machine back end and RNG for gambling functionality.
Enables new and unique ways to display a slot machine gambling game to specific demographics based on gameplay type and/or theme.
May increase overall house gambling demographics, revealing untapped markets, more profits, more coin-ins & more “butts in seats.”
Hybrid skill-based, wager-based games may be purposefully configured or designed to avoid (or to not require) any additional regulatory approval for deployment in Casino venues.
Provides mechanisms to Casinos/gaming establishments for facilitating achievement of desired minimum wagering goals (e.g., overtime), such as those established by Casinos (e.g., Casino desires at least one wager-based reel spin by a given player every 10 seconds).
Etc.

In one embodiment, a hybrid skill-based, wager-based game may be created by combining a new and different visual game representation with a new and different method of player interaction on a slot machine. The hybrid skill-based, wager-based game may be configured or designed to provide the assemblage of graphical elements and gameplay features for portraying a visually different experience while also providing the enhanced method of player interaction via a particular Human Interface Device (e.g., HID), which is based on the theme/style of the visually enhanced gambling game. For example, the game “Duck Hunt” uses a gun controller where as “Super Mario Bros.” utilizes a D-pad multi-button controller as the HID. According to different embodiments, either (or both) of these skill-based video games may be adapted (e.g., using the hybrid skill-based/wager-based gaming techniques described and/or referenced herein) to function as hybrid skill-based/wager-based games. According to different embodiments, one or more hybrid skill-based/wager-based game(s) may also be configured or designed to include one or more of the following (or combinations thereof): graphical elements (e.g., 2D and/or 3D) animations, sound effects, programming, etc.

In some embodiments, the format of the hybrid skill-based, wager-based game may focus on “first person shooter” type, skill-based games such as, for example, “House of the Dead,” “Area 51”, “Lethal Enforcers”, etc. At least a portion of such games may feature a player character that automatically moves on a “rail” system (e.g., automatically moving the player's character through different scenes of the game, without requiring the player to provide input for moving his/her game character), which allows the player to concentrate his/her focus on shooting the targets which appear throughout gameplay.

The format of the hybrid skill-based, wager-based game may also focus on other types of video and/or skill-based games such as, for example, one or more of the following (e.g., or combinations thereof):
“non-linear” (e.g., open world) type video and/or skill-based games such as, for example, Grand Theft Auto
“linear” type video and/or skill-based games such as, for example, Half-Life
Massively multiplayer online “MMO” type video and/or skill-based games such as, for example, World of Warcraft
Role-playing game “RPG” type video and/or skill-based games such as, for example, Final Fantasy.

Such games may feature a player character that may be moved through the game world via player input, (e.g., HID), which allows for an increased sense of excitement through gameplay by providing a multitude of player-choice possibilities through a wide-array of path directions.

In some embodiments, the format of the hybrid skill-based, wager-based game may facilitate a gameplay environment in which multiplayer functionality takes place. The multiplayer gameplay may have multiple “enrollment” aspects in which one, for example, particular player could be on location at a casino playing a hybrid skill-based/wager-based game, while another (e.g., different) player could be at a different location (e.g., at a different location in the casino, at a different casino, at a different establishment such as a home or office, etc.), concurrently participating in the same hybrid skill-based/wager-based game, but without participating in any wagering aspect/portions of hybrid skill-based/wager-based game. A non-wagering game such as this is commonly known as a “free to play” game, in which the player is allowed to download and install said game on their own devices, which then allows the player progress through the game (e.g., which is no different than the wager based counter-part) without taking place in wager based events.

In some embodiments, different players concurrently participating in the same hybrid skill-based/wager-based game may each separately configure his/her respective wagering parameters/amounts, which may be different from the wagering parameters/amounts configured by other game player-participants.

The various hybrid skill-based/wager-based gaming techniques described herein may be used to improve the visual relationship between player and machine to increase player immersion and facilitate longer more exciting gambling durations without providing a completely new back-end delivery structure. It also improves the player method of interaction with the gambling game by allowing for a plethora of new age interface devices to be coupled with specific themed games (e.g., guns, joysticks, controllers, etc.). Existing technology and gameplay, although proven, is becoming dated and “not as fun” to younger players. The hybrid skill-based/wager-based gaming techniques described herein may satisfy the younger demographics gameplay needs while still satisfying the house and regulatory needs by having the same foundation which has already been tested/approved. The presentation of the gaming elements are comprised in such a way where younger demographics may be more compelled to gamble while still allowing older demographics to understand and enjoy the experience if they so desire to participate. The hybrid skill-based/wager-based gaming techniques described herein may also be utilized for enabling enhanced slot machine gambling with new and exciting twists, while still being compliant with local/state/Federal gaming regulations.

According to different embodiments, one or more different types of gameplay-related triggering event(s)/condition(s) may be defined for initiating a wager-based event to occur during game play (e.g., execution of wager-based slot reel spin may take place concurrently with or simultaneously with the player's continued and active participation in the skill-based portion of the game). Examples of different types of triggering event(s)/condition(s) may include, but are not limited to, one or more of the following (e.g., or combinations thereof):
Selecting a set of cards or tiles which satisfy minimum specified criteria;
In-game achievement satisfied or accomplished
Player interaction with an in-game object;
Occurrence of an in-game event or condition which satisfies specific criteria;
Destroying a specified virtual object;
An environmental object event, such as, for example, volcano eruption, avalanche, earthquake, or sci-fi/fantasy element (e.g., a strange alien world may harbor anti-matter pockets and/or worm-holes in space-time) and/or weather (e.g., “Lightning Strike” trigger);
Predetermined outcome via host application such as, for example, a property may “credit/reward” a specific patron by triggering an event (e.g., “Hot Seat bonus” etc.), and/or may initiate an event based on a situation deemed necessary for triggering such an event. (e.g., See, e.g., 1208, FIG. 12);
A multiplayer and/or team and/or co-op event (e.g., similar to other embodiments described and/or referenced herein) in occurrence with multiple players and situations thereof;
And/or other types of event(s)/condition(s) may be defined for initiating a wager-based event to occur during game play.

Examples of different types of wager-based gaming events which may be initiated may include, but are not limited to, one or more of the following (e.g., or combinations thereof):
Spin of virtual slot reel (e.g., based on RNG). Examples of these types of wager-based games of chance include the RNG-based virtual slot games.
Throw of virtual dice. An example of this type of wager-based game of chance includes the RNG-based virtual dice game.
Spin of a virtual roulette wheel or other type of wheel (such as, for example, “Wheel of Fortune”). Examples of these types of wager-based games of chance include the RNG-based virtual roulette game, and the RNG-based “Wheel of Fortune” game.
Dealing of one or more virtual cards.
Pick & choose/find hidden item.
Scramble elements/find hidden item.
“Scratch off”/reveal hidden item.
A pachinko-type game.
A bingo-type game.
“Virtual” carnival/parlor events/spin of a wheel, etc.
And/or other types of RNG-based games of chance known in the art and/or described and/or referenced herein.

According to different embodiments, different hybrid skill-based/wager-based games may be configured or designed to include at least one skill-based game play portion and at least one wager-based game play portion. Examples of various skill-based games or skill-based themes which may be used in implementing the skill-based game play portion of the hybrid skill-based/wager-based game may include, but are not limited to, one or more of the following (or combinations thereof):
“First person shooter” type, skill-based games such as, for example, “House of the Dead,” “Area 51”, “Lethal Enforcers”.
“Non-linear” (e.g., open world) type video and/or skill-based games such as, for example, Grand Theft Auto.
“Linear” type video and/or skill-based games such as, for example, Half-Life.
Massively multiplayer online “MMO” type video and/or skill-based games such as, for example, World of Warcraft.
Role-playing game “RPG” type video and/or skill-based games such as, for example, “Final Fantasy”.
Racing/Driving arcade style game(s) (e.g., Cars, boats, planes etc.).
Sports-themed arcade style game(s) (e.g., Football, Baseball, downhill skiing, etc.).
Challenge arcade style game(s) (e.g., Archery, Darts, Hunting, Shooting, etc.).
Recreation arcade style game(s) (e.g., Horseshoes, Croquet, Fishing etc.).
TV-themed arcade style game(s).
Match-X type game;
And/or other types of skill-based games.

Examples of various wager-based games or wager-based themes which may be used in implementing the wager-based game play portion of the hybrid skill-based/wager-based game may include, but are not limited to, one or more of the following (or combinations thereof):

According to different embodiments, different types of electronic gaming machine cabinets may be configured with different human interface devices (“HIDs”) for enabling players/participants to engage in one or more of the hybrid skill-based/wager-based gaming activities described and/or referenced herein. Examples of different human interface devices (“HIDs”) may include, but are not limited to, one or more of the following (or combinations thereof):
Touchscreen interfaces
Mechanical Buttons
Gun, Pistol, Shooting Device
Mechanical Joystick
Gaming Controller such as, for example, remote gaming controllers similar to those used for X-Box™, Playstation™, Wii™, etc.
Mechanical vehicle components such as, for example, vehicle steering wheel, gear shift, gas pedal, brake pedal, clutch pedal, etc.
And/or other types of HIDs described and/or referenced herein and/or commonly known.

As described in greater detail herein, various embodiments of hybrid skill-based/wager-based games may be configured or designed in a manner such that the respective wager event outcomes associated with a given wager-based triggering event may be predetermined before the occurrence of a wager-based triggering event. For example, in at least one embodiment, a hybrid skill-based/wager-based game may be configured or designed to:
enable a player to engage in interactive game play of a hybrid skill-based/wager-based game at a first EGD, wherein the hybrid skill-based/wager-based game includes a skill-based gaming portion and a wager-based gaming portion;
link a first predetermined wager-based game event outcome to a first in-game event which may occur during play of the skill-based game portion;
detect an occurrence of the first in-game event in the skill-based game portion;
determine if the occurrence of the first in-game event qualifies as a wager-based triggering event;
if it is determined that the occurrence of the first in-game event qualifies as a wager-based triggering event, initiate a first wager-based game event;
automatically fund an amount wagered on the first wager-based game event; and
reveal, after initiation of the first wager-based game event, the first predetermined wager-based game event outcome as an outcome of the first wager-based game event.

Additionally, according to different embodiments, the hybrid skill-based/wager-based game may be configured or designed to facilitate, enable, initiate, and/or perform one or more of the following operation(s), action(s), and/or feature(s) (or combinations thereof):
Enable the player to concurrently engage in continuous game play of the skill-based gaming portion of the hybrid skill-based/wager-based game during execution of the first wager-based game event.
Analyze the first wager-based game event outcome to determine whether or not to automatically modify an availability of at least one resource or attribute of the skill-based gaming portion; if the first wager-based game event outcome satisfies a first set of conditions, automatically modify an availability of at least one resource or attribute of the skill-based gaming portion; if the first wager-based game event outcome does not satisfy the first set of criteria, not perform modification of the at least one resource or attribute of the skill-based gaming portion in response to the first wager-based game event outcome.
Analyze the first wager-based game event outcome to determine whether or not a skill-based gaming award should be distributed at the skill-based gaming portion; if the first wager-based game event outcome satisfies a first set of criteria, automatically cause the skill-based gaming award to be distributed at the skill-based gaming portion; and wherein the distribution of the skill-based gaming award includes causing at least one component of the gaming network to modify at least one in-game resource or attribute which is available for use by an in-game character during play of the skill-based gaming portion.
Automatically retrieve a first batch of predetermined wager-based game event outcomes from a first RNG engine; and select the first wager-based game event outcome from the first batch of predetermined wager-based game event outcomes.

In at least some embodiments where the first in-game event corresponds to the satisfying or accomplishing of a first achievement (“First Achievement”) in the skill-based gaming portion, the hybrid skill-based/wager-based game may be configured or designed to: link a first predetermined wager-based game event outcome to the First Achievement; detect a that the First Achievement has been accomplished or satisfied during play of the skill-based gaming portion; determine if the accomplishing of the First Achievement qualifies as a wager-based triggering event; if it is determined that the accomplishing of the First Achievement qualifies as a wager-based triggering event, initiate the first wager-based game event; and reveal, after initiation of the first wager-based game event, the first predetermined wager-based game event outcome as the outcome of the first wager-based game event which was initiated in response to the accomplishing of the First Achievement.

In at least some embodiments, the RPG hybrid skill-based/wager-based game may be configured or designed to provide opportunities in which the player is awarded specific non-monetary “points” or rewards. For example, a player may be awarded a nonmonetary payout of points based upon the outcome of a wager-based game event initiated during play of the RPG hybrid skill-based/wager-based game.

In at least some embodiments, the RPG hybrid skill-based/wager-based game may be configured or designed to include functionality for enabling the player to acquire or purchase various types of in-game resources (e.g., items, skills, and abilities, etc.) using points that were awarded to the player from non-monetary payouts of wager-based game events. In at least some embodiments, the hybrid skill-based/wager-based game may be configured or designed to offer the ability for a player to exchange earned points for other types of in-game assets and/or in-game event opportunities.

### Match-X Wagering Game Embodiments

Some embodiments of hybrid skill-based/wager-based games may be configured or designed as wager-based “Match-X” type games (such as, for example, Bejeweled™ or Candy Crush™), in which a player is presented with a plurality of objects in the game environment, and is required to match selected combinations of the displayed objects in order to receive in-game awards/rewards and/or monetary payout(s). For reference purposes, such “Match-X” type wager-based games may be referred to herein as “Match-X Wagering Games”. As described in greater detail herein, Match-X Wagering Games provide players with a new gaming experience, which provides for a new form of entertainment while concurrently enabling players to engage in wagering activities.

In at least some Match-X Wagering Game embodiments deployed at EGMs, a player is allowed to select a set of tiles (or cards) displayed at the playing field GUI. This set may be of arbitrary size, or it may be limited to a specific number of tiles (e.g. 5 tiles), or it may be limited to a range of sizes (e.g. 3-5 tiles). The tiles selected by the player may form the singular Player's Poker Hand. Poker Hands established in this way may be referred to as “Player Selected Poker Hands”.

In other Match-X Wagering Game embodiments, the player is allowed to select two adjacent tiles which may swap positions on the playing field. Sometimes, the tiles are only allowed to be swapped if, in doing so, one or more Poker Hands can be found anywhere in the playing field. If the cards are indeed swapped, then zero or more Poker Hands may be found (one or more if the aforementioned rule is taken into account). These are also called the Player's Poker Hands. Poker Hands established in this way may be referred to as “Automatically Selected Poker Hands”.

In some Match-X Wagering Game embodiments, each time that a Player's Poker Hand is established or identified, that hand may be evaluated against certain rules. These rules may be unique to each and every level, and may be modified within a level by certain in-game events, conditions, etc. These rules are typically designed to award value to the player for assembling high-ranking Poker Hands. This value may either be granted to the player immediately upon identification of a Player's Poker Hand, or it may be accumulated and awarded once the level has been complete or the player has decided to quit playing. For example, if a Player's Poker Hand is evaluated and determined to be a “Flush”, then the player may be awarded a prize equal to 3 times his wager.

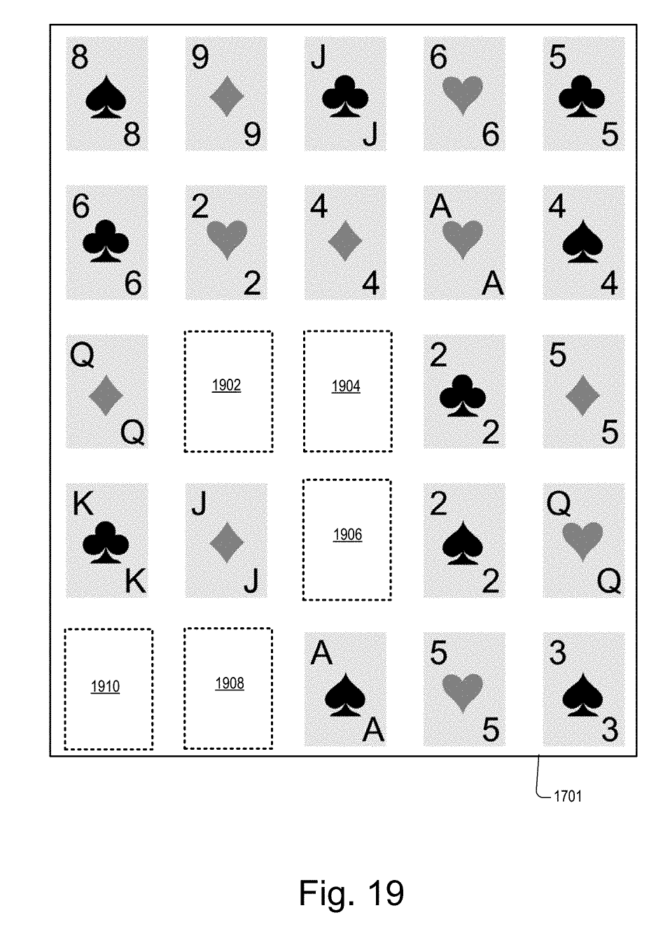

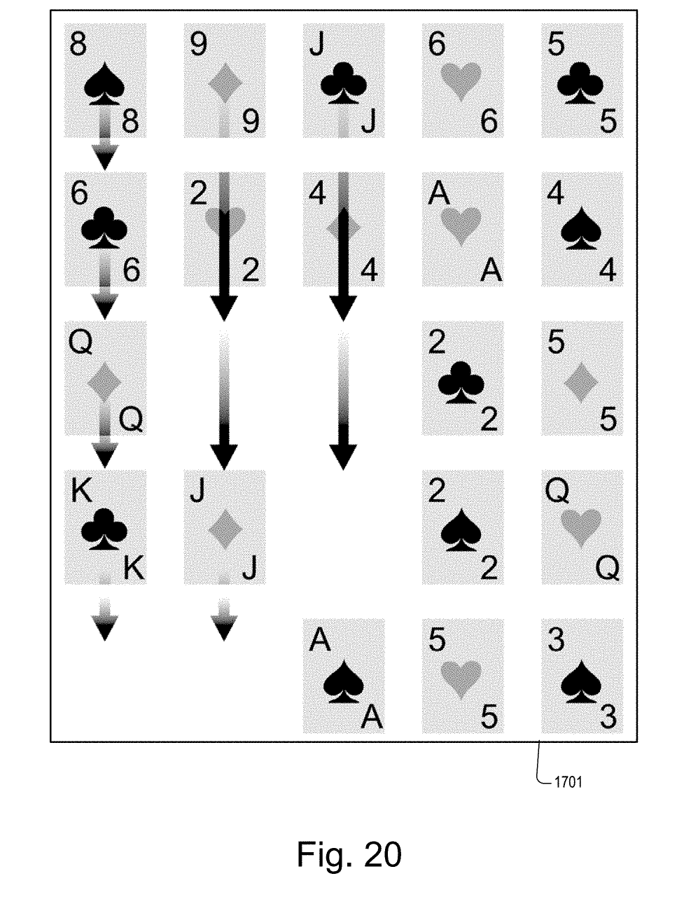

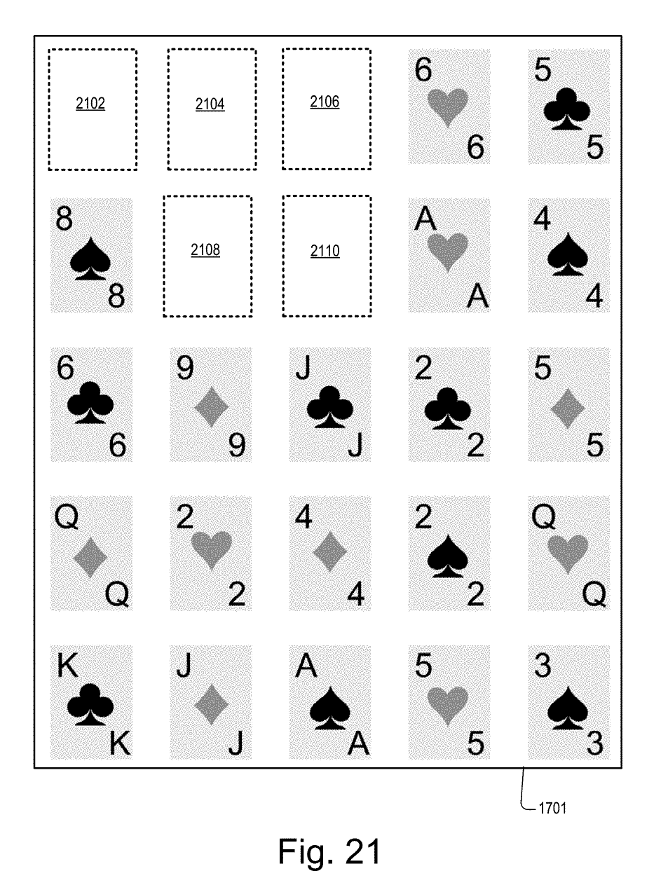

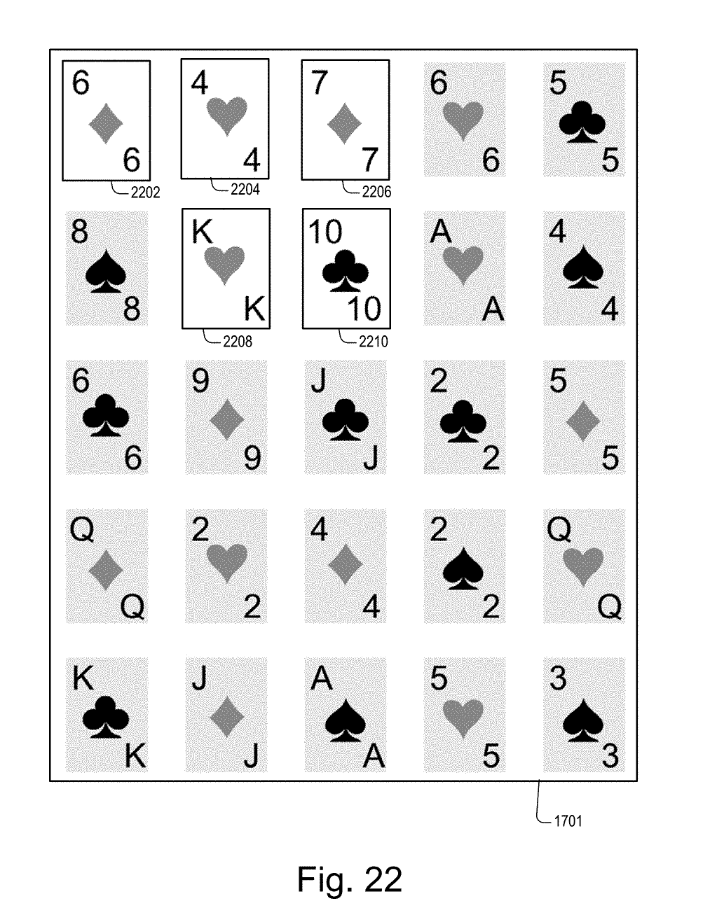

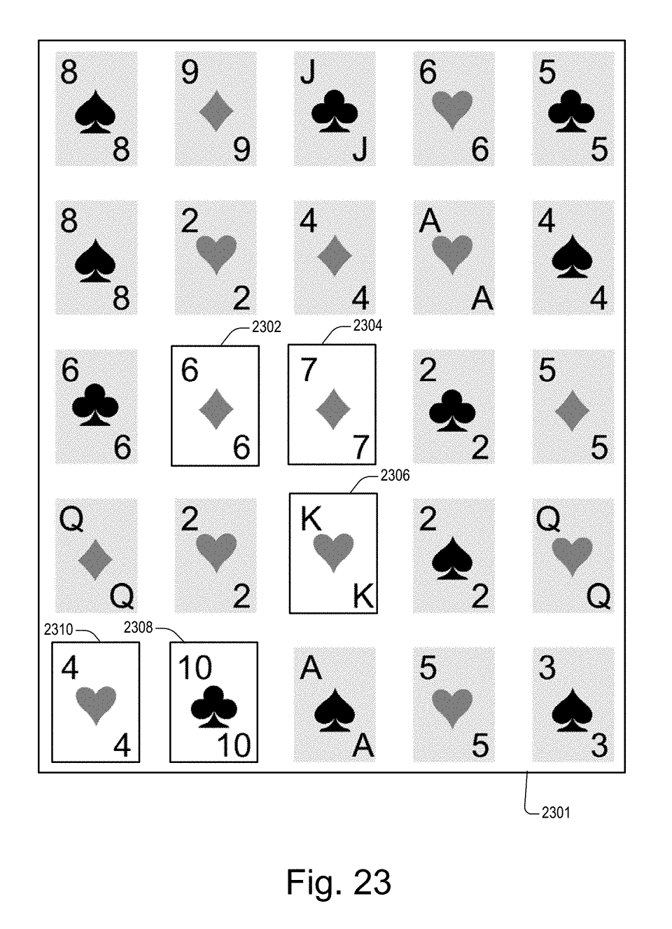

In some Match-X Wagering Game embodiments, when at least one Player's Poker Hand is established, the cards included in that hand are removed from the playing field. See FIG. 19. The empty spaces left after removing those cards may typically be filled by the cards that were above the removed cards, but this is not a strict requirement. See FIG. 20. Regardless, any empty spaces may then be populated by other presumably randomly chosen cards, if any cards are available. See FIGS. 21 and 22. In FIG. 23, we show a game design where the cards did not “fall” into the empty spaces, but instead were simply replaced with new cards.

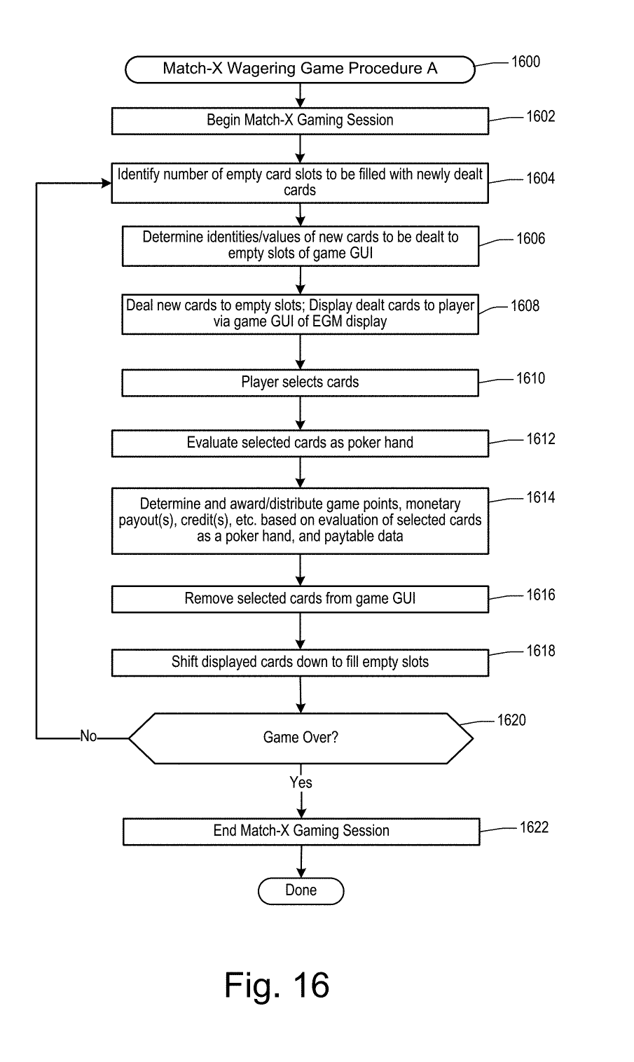

In some Match-X Wagering Game embodiments, if the Player's Poker Hand(s) were Automatically Selected Poker Hands, then the playing field is searched for any new Poker Hands that may have been formed, either by the movement of cards or by the introduction of new cards. These new Poker Hands are also Player's Poker Hands, and they are also called automatically selected Poker Hands. If any such new Player's Poker Hands are found, then the process started in the previous paragraph is repeated. An example of this is illustrated in the procedural flow diagram of FIG. 16.

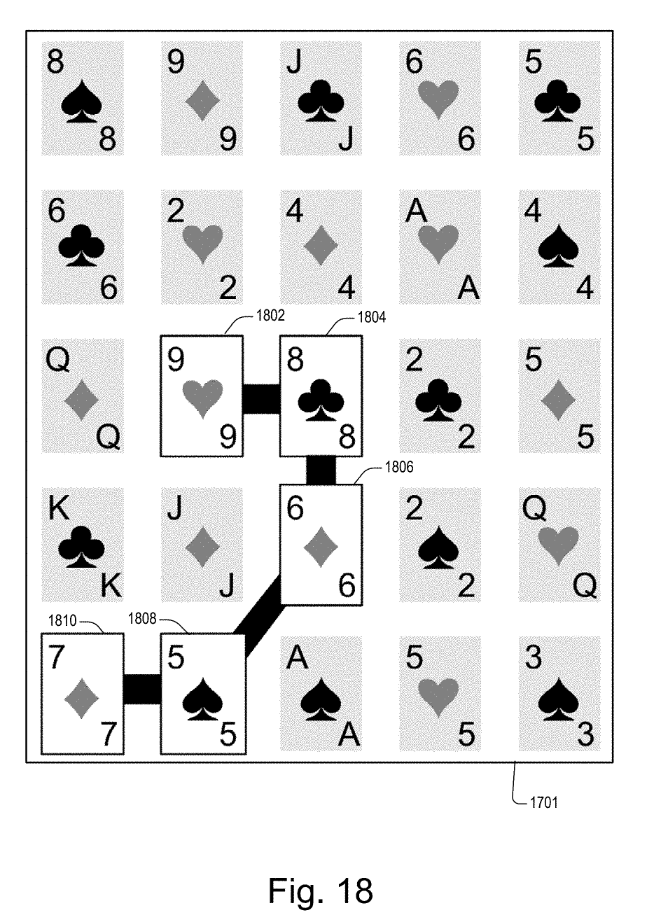

In some Match-X Wagering Game embodiments, various rules and/or criteria may be defined in the Match-X Wagering Game configuration to influence or control how a Player's Poker Hands are established within the playing field. For example, FIG. 18 shows an embodiment whereby cards may be connected horizontally, vertically, or diagonally. The cards in this figure are also not in sequential order. Other embodiments may restrict connected cards to horizontal lines, may prohibit diagonal connections, may require straights to be in sequential order, etc.

For purposes of example and ease of explanation of one or more of the Match-X Wagering Game embodiments described herein, it may be assumed that a deck contains 52 cards, and that the cards are the standard Poker cards well known world-wide, and that a Poker Hand is comprised of any 5 cards.

For example, in one embodiment, a Match-X Wagering Game may be configured or designed to allow a player to place a wager to begin a gaming session or game level. At the beginning of the level, the Match-X Wagering Game may populate a game graphical user interface (“Game GUI”) (such as, for example, a grid, array, or other topological organization) with a first plurality of playing cards (or other virtual objects such as, for example, jewels, animals, vehicles, food items, etc.). The player may then be allowed to select a second plurality (e.g., subset) of cards contained within the first plurality of cards. According to different embodiments, selection of the second plurality of cards may be controlled or governed based on various criteria such as, for example: the player's current wager, the player's wager history, the rules of the game, house rules, level of play, etc. After the second plurality of cards is selected by the player, the Match-X Wagering Game may automatically perform or initiate one or more of the following actions (or combinations thereof):
(a) the second plurality of cards may be evaluated based on some version of “Poker” rules;
(b) the player may receive or accumulate some value or reward if the second plurality of cards meets certain criteria;
(c) cards of the second plurality may be removed from the Game GUI;
(d) the cards remaining in the grid may move in some manner to fill in the empty spaces;
(e) one or more empty spaces remaining on the grid (if any) may be replaced with new cards, if there are new cards available;
(f) etc.

In at least one embodiment, a Match-X Wagering Game may be implemented using a combination of hardware and software. For example, in one embodiment, various aspects of a Match-X Wagering Game may be embodied in a software package which is installed at a specially configured gaming hardware system which includes various hardware components such as, for example: a touch-screen, bill validator, ticket printer, and/or other wager-based gaming machine components.

In at least some embodiments, the Match-X Wagering Gaming device may be required to have connectivity to one or more gaming server(s), such as, for example, one or more casino gaming servers, and/or one or more remote gaming servers.

In some embodiments, the Match-X Wagering Game may be implemented on a mobile gaming device (e.g., smartphone, tablet, etc.) which is configured or designed to include specially designed componentry for providing and/or handling game security mechanisms, encryption mechanisms, geolocation verification mechanisms, user identification and verification mechanisms, device authentication mechanisms, and/or other specially designed componentry for achieving regulatory compliance with regional and/or federal wager-based game regulations.

In at least one embodiment, the Match-X Wagering Game may be configured or designed to operate in a manner similar to that of skill-based “Match-X” type games (such as, for example, Bejeweled™, Candy Crush™, etc.). However, instead of matching similar colors/shapes/icons, the player builds a Poker Hand consisting of different cards (e.g., a hand of 2-7 cards, a hand of 5 cards, etc.). In order to attempt to build/select a Poker Hand, the player may be required to make one or more wagers. In one embodiment, the Poker Hand that is selected by the player may be used to determine the outcome of one or more of the player's wager(s).

One benefit of the Match-X Wagering Game is that it may be configured or designed to build on well-known concepts common to many arcade-type games, thereby allowing the Match-X Wagering Game to provide a familiar and readily recognizable gaming experience to most players, especially those in the targeted gambling demographics.

### Example Match-X Wagering Game Embodiments

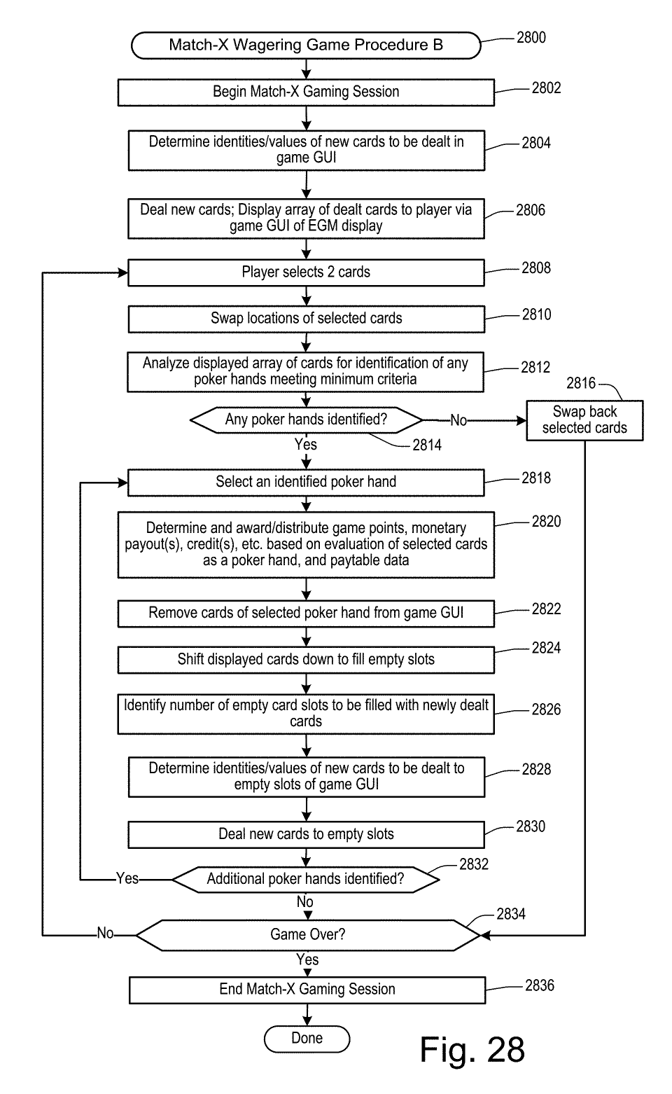

FIGS. 16 and 28 illustrate various example embodiments of different Match-X Wagering Game procedures and/or procedural flows which may be used for facilitating activities relating to one or more of the Match-X Wagering Game aspects disclosed herein. According to different embodiments, at least a portion of the various types of functions, operations, actions, and/or other features provided by the Match-X Wagering Game Procedures of FIGS. 16 and 28 may be implemented at one or more electronic gaming machines, at one or more gaming servers(s), at one or more gaming network components, and/or combinations thereof.

In at least one embodiment, one or more of the Match-X Wagering Game procedures may be operable to utilize and/or generate various different types of data and/or other types of information when performing specific tasks and/or operations. This may include, for example, input data/information and/or output data/information. For example, in at least one embodiment, the Match-X Wagering Game procedures may be operable to access, process, and/or otherwise utilize information from one or more different types of sources, such as, for example, one or more local and/or remote memories, devices and/or systems. Additionally, in at least one embodiment, the Match-X Wagering Game procedures may be operable to generate one or more different types of output data/information, which, for example, may be stored in memory of one or more local and/or remote devices and/or systems. Examples of different types of input data/information and/or output data/information which may be accessed and/or utilized by the Match-X Wagering Game procedures may include, but are not limited to, player input data, executable computer code stored on local memory devices, data communications with one or more RNG engines, game play content, game play graphics, game state information, wager information, data communications with one or more remote servers, and/or other types of input data/information and/or output data/information described herein.

In at least one embodiment, a given instance of the Match-X Wagering Game procedures may access and/or utilize information from one or more local and/or remote databases. In at least one embodiment, at least a portion of the database information may be accessed via communication with one or more local and/or remote memory devices. Examples of different types of data which may be accessed by the Match-X Wagering Game procedures may include, but are not limited to, player tracking data, game state data, game event data, wager data, wager-based game event outcome data, paytable data, and/or other types of information and/or data described herein.

According to specific embodiments, multiple instances or threads of one or more Match-X Wagering Game procedures may be concurrently implemented and/or initiated via the use of one or more processors and/or other combinations of hardware and/or hardware and software. For example, in at least some embodiments, different instances of one or more Match-X Wagering Game procedures may be implemented and/or initiated (e.g., concurrently or asynchronously) at different electronic gaming machines of a casino gaming network.

According to different embodiments, one or more different threads or instances of the Match-X Wagering Game procedures may be initiated in response to detection of one or more conditions or events satisfying one or more different types of minimum threshold criteria for triggering initiation of at least one instance of the Match-X Wagering Game procedures, and/or various aspects or features thereof. Various examples of conditions or events which may trigger initiation and/or implementation of one or more different threads or instances of the Match-X Wagering Game procedures may include, but are not limited to, one or more of those described and/or referenced herein.

In at least one embodiment, initial configuration of a given instance of the Match-X Wagering Game procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the Match-X Wagering Game procedures may correspond to and/or may be derived from the input data/information.

It will be appreciated that the procedural diagrams of FIGS. 16 and 28 are merely specific examples of procedural flows and/or other activities which may be implemented to facilitate or enable one or more aspects of the Match-X Wagering Game techniques described herein. Other embodiments of procedural flows (not shown) may include additional, fewer and/or different steps, actions, and/or operations than those illustrated in the example procedural diagrams of FIGS. 16 and 28. Additionally, it is to be noted that, although various process steps, method steps, algorithms or the like may be described in a sequential order, such processes, methods and algorithms may be configured to work in alternate orders. Accordingly, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

For purposes of illustration, various aspects, features, benefits and advantages of one or more Match-X Wagering Game embodiments may now be described by way of example via a descriptive walk-through of a simplified Match-X Wagering Game embodiment. This specific embodiment may be considered one of many illustrative embodiments described herein.

FIG. 16 shows an example flow diagram of a Match-X Wagering Game Procedure A 1600 in accordance with an example embodiment. In at least one embodiment, one or more Match-X Game Procedure(s) may be implemented at an electronic gaming machine (EGM) of a gaming network which comprises at least one processor and non-transient memory which is configured to store executable code. The at least one processor is operable to execute a plurality of instructions stored in the memory to cause hardware and/or software components of the EGM to perform various operations for hosting one or more Match-X Wagering Game session(s) (“Match-X Gaming sessions”), such as, for example, some or all of the various steps or operations illustrated in the Match-X Game Procedure(s) of FIGS. 16 and 28.

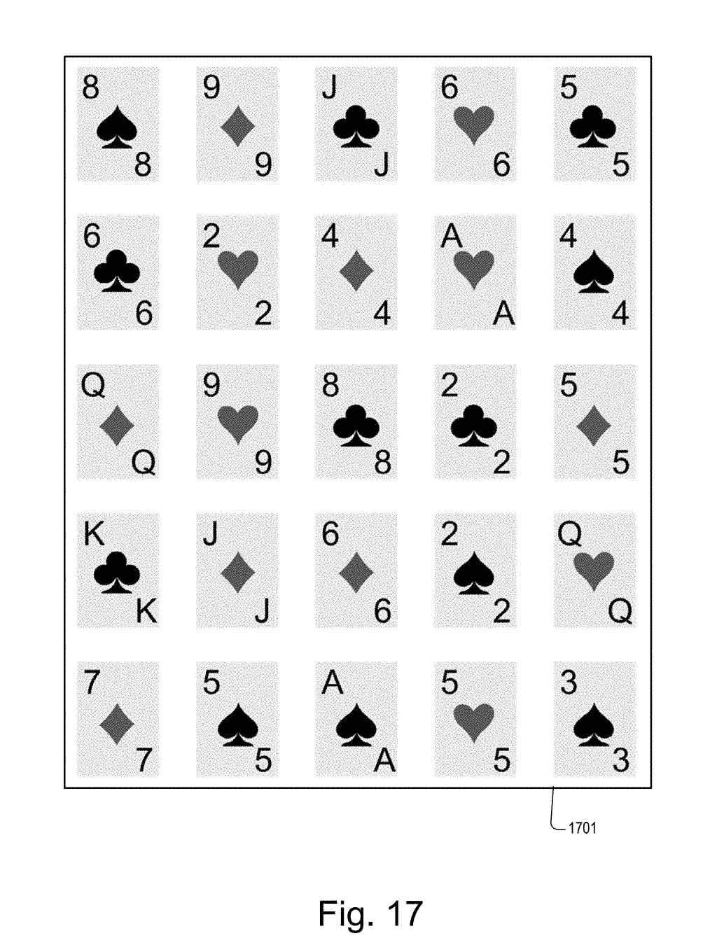

FIGS. 17-26, and 29-31 illustrate example screenshot of different graphical user interfaces (GUIs) which may be used to facilitate, initiate and/or perform various operation(s) and/or action(s) relating to one or more of the Match-X Wagering Game aspects disclosed herein. For purposes of illustration, the flow diagram of FIG. 16 will be described by way of illustration with reference to FIGS. 17-26.

It is noted that the example Match-X Wagering Game embodiment(s) represented by FIGS. 16-23, corresponds to a specific variation of how a Match-X Wagering Game may be implemented at an EGM in accordance with a specific set of Match-X Wagering Game rules. For reference purposes, the specific variation of the Match-X Wagering Game represented by FIGS. 16-23 may be referred to as “Five Card Poker Hand Match-X”.

As shown at 1602 of FIG. 16, it is assumed that a player initiates a Match-X Gaming session at an EGM. In some embodiments, the player may be required to place a wager at the EGM in order to initiate a Match-X Gaming session. For example, in one embodiment, prior to the system shuffling the deck of virtual (or physical) cards, the player may place a wager at the EGM. For this wager, the player may be entitled to participate in a session of the Match-X Wagering Game using all of the cards in the card deck (e.g., 52 cards). In some embodiments, each time the player makes a selection of n cards (e.g., n=5), the player has the potential to win some amount of payout (e.g., money, credits, etc.) based on the poker hand formed by those selected cards. In one embodiment, after all of the 52 cards have been dealt out to either: (a) populate the initial playing field (e.g., as illustrated in FIGS. 17, 24, 25); or (b) fill in the empty card slots (e.g., as illustrated in FIGS. 19 and 21, no more cards may be dealt to fill in the subsequent empty spaces, and these empty spaces may remain empty. In one embodiment, the Match-X Wagering Game session may be considered over when there are no possible ways in which the player can connect (e.g. select) n neighboring cards.

In some embodiments, wagers may be automatically placed on behalf of the player in response to the player's game play activities during the Match-X Gaming session.

In this example illustration, it is assumed that the Match-X Wagering Game is played using a Game GUI which is configured to display a playing field grid or array that has slots for 5 cards per row and 5 cards per column, as illustrated, for example, in FIG. 17. This grid may be referred to as the playing field. The playing field shown in FIG. 17 is exemplary of a playing field. A playing field is the arrangement of the cards, along with predefined rules stored in non-transient memory which, for example, may govern or control which cards a player may select together (or select to swap), how cards may “fall” or otherwise “move” into the empty spaces created by the removal of other cards, etc.

As shown at 1604, at least one processor may execute a plurality of instructions to identify the number of empty card slots to be filled with newly dealt cards. For example, if the Game GUI is configured to display a 5×5 playing field, when the Match-X Wagering Game first commences, the system may identify 25 empty card slots to be filled with newly dealt cards.

As shown at 1606, at least one processor may execute a plurality of instructions to determine the identities/values of new cards to be dealt to empty slots of Game GUI. In one embodiment, a real or simulated deck of 52 standard Poker playing cards may be shuffled, and 25 of those randomly ordered cards may be dealt into each of the 25 grid spaces such that the player can see the faces of each card (FIG. 17). In other embodiments, a real or simulated shoe comprising multiple decks of cards may be employed. In some embodiments, one or more local and/or remote RNG engine(s) may be used to determine the identities/values of new cards to be dealt to empty slots of Game GUI.

In some embodiments, in order to reduce gameplay latency which, for example, may be caused by communication latency (e.g., attributable to communications with a remote RNG engine/server) and/or processing latency (e.g., attributable to strained or overloaded local system resources), the EGM may be configured to acquire one or more batches of “undealt” cards from the RNG engine(s), and to store the acquired batches of “undealt” cards in local memory, which may then be utilized for current and/or future Match-X Gaming sessions conducted at the EGM.

As shown at 1608, at least one processor may execute a plurality of instructions to virtually deal or distribute new cards to the empty slots, and display the populated playing field of dealt cards to the player via the Game GUI (e.g., 1701, FIG. 17) of the EGM display.

As shown at 1610, at least one processor may execute a plurality of instructions to enable the player select one or more cards from the playing field. In at least some embodiments where the Game GUI is displayed on an a touch-screen display, the player may select one or more desired cards by tapping directly on the touchscreen display.

In some embodiments, the player may be required to select specific number of cards such as, for example, 2 cards, 5 cards, 7 cards, etc. In some embodiments, the player may be allowed to select any desired number of cards within a specified range such as, for example, player must select 2-5 cards, player must select 2-7 cards, player must select 5-7 cards, etc. According to different embodiments, other conditions, restrictions, and/or requirements may be imposed upon the player's selection of cards such as, for example, one or more of the following (or combinations thereof):
Each selected card must be adjacent to at least one other selected card.
Player may only select cards matching one or more specified suits (e.g., clubs, hearts, diamonds, spades).
Player may only select cards from specifically designated rows and/or columns.
Player is not allowed to select one or more specifically designated cards displayed in the playing field.
Player is only allowed to select two adjacent cards.
Player is only allowed to select cards which are not adjacent to each other.
Player must select 5 cards, and each selected card must be adjacent to at least one other selected card.
Player must place an additional wager in order to be able to select one or more additional cards.
The number of cards which the player is allowed to select is determined based on the player's initial wager.
Etc.

Referring to the example Game GUI of FIG. 18, it is assumed that the player selects five cards (e.g., 1802, 1804, 1806, 1808, 1810) from the displayed playing field of cards (e.g., 1701). In some embodiments, when the player selects a card from the playing field, the visual appearance or properties of that card may be automatically and dynamically changed so as to visually convey to the player that that card has been selected.

As shown at 1612, at least one processor may execute a plurality of instructions to evaluate the selected cards as a poker hand. For example, as illustrated in the example Game GUI of FIG. 18, the player has selected: nine of hearts, eight of clubs, six of diamonds, five of spades, and seven of diamonds. The system evaluates or analyzes this selected set of cards as a poker hand, and identifies the selected set of cards as a “Straight” run of cards (e.g. 5, 6, 7, 8, 9; standard Poker definition).

In other Match-X Wagering Games embodiments, various different types of playing cards may be used other than 52 standard Poker cards, such as, for example: Tarot card deck, Muushig card deck, Pinochle card deck, and the like. Additionally, in at least some other Match-X Wagering Games embodiments, the player's selected set of cards may be evaluated based on various different card game rules other than Poker, such as, for example: Rummy, Blackjack, Cribbage, Bridge, Pinochle, Texas hold'em, and the like.

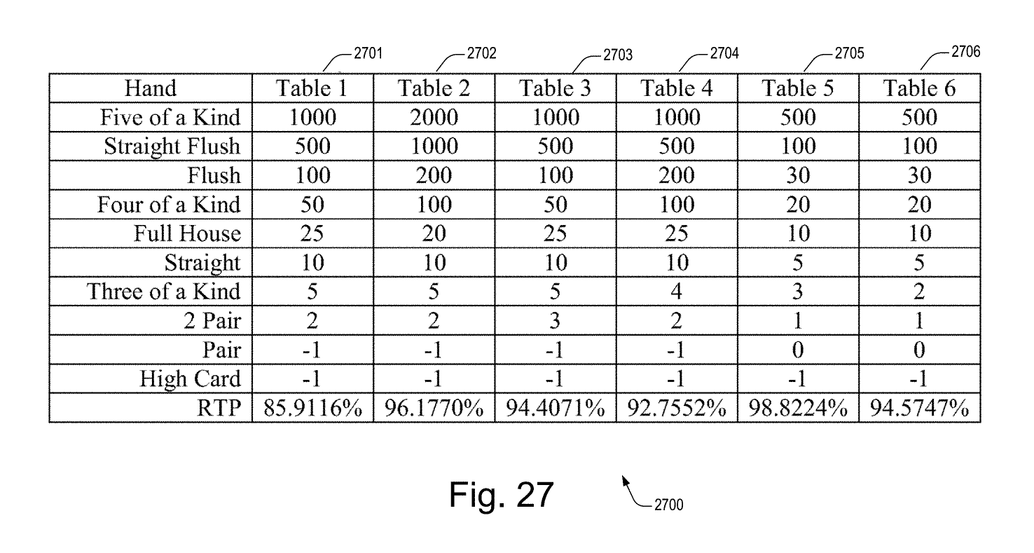

As shown at 1614, at least one processor may execute a plurality of instructions to determine and award/distribute game points, monetary payout(s), credit(s), etc. to the player based, at least in part, on the evaluation of selected cards as a poker hand (or other types of card game rules), and also based, at least in part, on paytable data from one or more paytables (e.g., such as, for example, paytable 2700 of FIG. 27). For example, based on the player's selection of the 5 cards (e.g., 1802, 1804, 1806, 1808, 1810) illustrated in FIG. 18, the system may determine that the selected set of cards corresponds to a “Straight” poker hand, and may award/distribute game points, monetary payout(s), credit(s), etc. to the player based on identifying the type or outcome of the Poker Hand as a “Straight”. In some embodiments, the system may determine the value(s) of the payout amount(s) which are to be paid or distributed to the player using one or more paytables. A simplified example set of paytables is illustrated in FIG. 27.

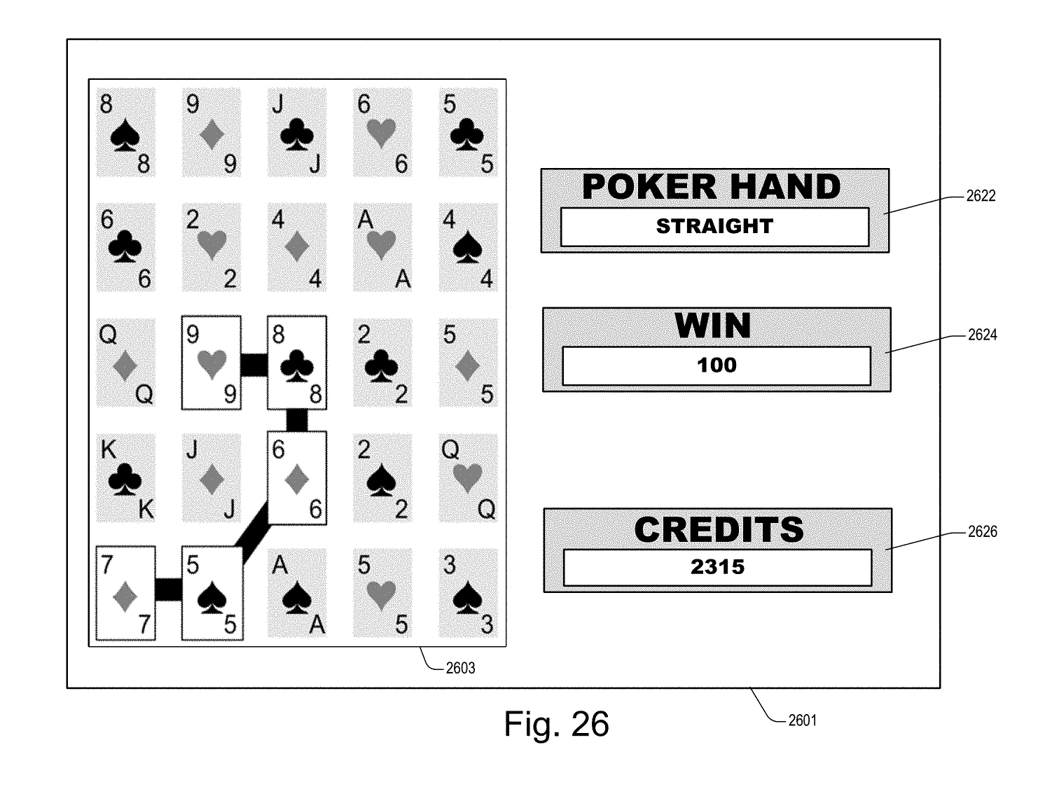

FIG. 26 shows an alternate example embodiment of a Match-X Game GUI 2601 which is configured to include:
Playing grid GUI portion 2603.
Game event outcome GUI portion 2622. In the specific example embodiment of FIG. 26, the game event outcome GUI portion 2622 is configured to display the type or outcome of the poker hand (e.g., “Straight”) corresponding to the set of cards which were selected by the player in the playing field GUI portion 2603.
Win amount GUI portion 2624. In at least one embodiment, the win amount GUI portion 2624 may be configured to display the value of the payout amount (e.g., 100 credits) which the system has determined is to be paid or distributed to the player (e.g., based on the player's selected poker hand and wager amount(s)).
Credit meter GUI portion 2626. In one embodiment, the credit meter GUI portion 2626 may be configured to display the value of the EGM's credit meter, which, for example, may represent the total credits available to the player during the current Match-X Gaming session.

Returning to the example illustration of FIG. 16, as shown at 1616, at least one processor may execute a plurality of instructions to remove the selected set of cards from the playing field, as illustrated, for example, in FIG. 19. As illustrated in the example embodiment of FIG. 19, the removal of the five cards selected by the player creates five empty card slots (e.g., 1902, 1904, 1906, 1908, 1910). In at least some embodiments, once cards have been selected by the player and removed from the playing field, those cards will longer be available for use during the remainder of the Match-X Gaming session.

As shown at 1618, after removal of the selected set of cards from the playing field, at least one processor may execute a plurality of instructions to shift selected displayed cards down to fill any lower empty card slots in the playing field. An example graphical representation of this activity is illustrated in FIG. 20, which depicts the cards above the empty card slots shifting downward to fill the empty spaces, thereby yielding a modified playing field configuration as illustrated in FIG. 21, in which the positions or locations of the empty card slots (e.g., 2102, 2104, 2106, 2108, 2110) in the playing field have been shifted upwards relative to their previous positions.

According to different embodiments, one or more of the empty slots of the playing field (if any) may be filled by newly dealt cards in a manner similar to that described previously with respect to procedural steps 1604, 1606, and 1608. For example, referring to the playing field Game GUI illustrated in FIG. 21, empty card slots 2102, 2104, 2106, 2108, 2110 may be filled with new cards dealt from the deck of unused/undealt cards (if any such cards remain in the deck), thereby yielding a modified or updated playing field configuration as illustrated in FIG. 22, which includes five newly dealt cards 2202, 2204, 2206, 2208, and 2210.

In at least some alternate embodiments, the card shifting operations described in procedural step 1618 may be omitted, and the empty card slots of the playing field (e.g., corresponding to the locations of selected cards which were removed from the playing field) may be filled with new cards dealt from the deck of unused/undealt cards. For example, referring to the playing field Game GUI illustrated in FIG. 19, empty card slots 1902, 1904, 1906, 1908, 1910 may be filled with new cards dealt from the deck of unused/undealt cards (if any such cards remain in the deck), thereby yielding a modified or updated playing field configuration as illustrated in FIG. 23, which includes five newly dealt cards 2302, 2304, 2306, 2308, and 2310.

Returning to the example illustration of FIG. 16, as shown at 1620, at least one processor may execute a plurality of instructions to determine if a game over condition has occurred or been detected. According to different embodiments, the system may be configured or designed to evaluate various different criteria in order to determine whether a game over condition has occurred. Illustrative examples of such criteria may include, but are not limited to, one or more of the following (or combinations thereof):
Player has used up his/her single opportunity per game/wager to select cards and receive payout (if any).
Player has exhausted all available opportunities to select cards from the playing field.
Game play timer has expired.
Insufficient number of cards in the deck to continue playing.
Insufficient number of cards in the deck to fill all empty slots.
There are no possible ways in which the player can connect (e.g. select) a minimum of n neighboring/adjacent cards.
Player's hand does not meet minimum criteria to continue playing. For example, in one embodiment, player must select a poker hand of “three of a kind” or higher to continue playing.
Player elects to quit game, for example, by depressing a “Cash Out” button on the EGM button panel.
Credit meter balance is zero.
Etc.

In at least one embodiment, if the system determines that a game over condition has not occurred, the system may allow the player to continue playing additional hands/rounds of the Match-X Wagering Game. Alternatively, if the system determines that at least one game over condition has occurred (or is detected), the system may execute a plurality of instructions to end (1622) the Match-X Gaming session.

It will be appreciated that alternate embodiments of the Match-X Wagering Game may be configured or designed to utilize different types of topological configurations for the playing field. For example, in some Match-X Wagering Game embodiments, the playing field may be configured as a square or rectangular shaped grid. In some embodiments, all slots of the playing field may be used to display cards which are dealt out (e.g., as illustrated in FIG. 17).

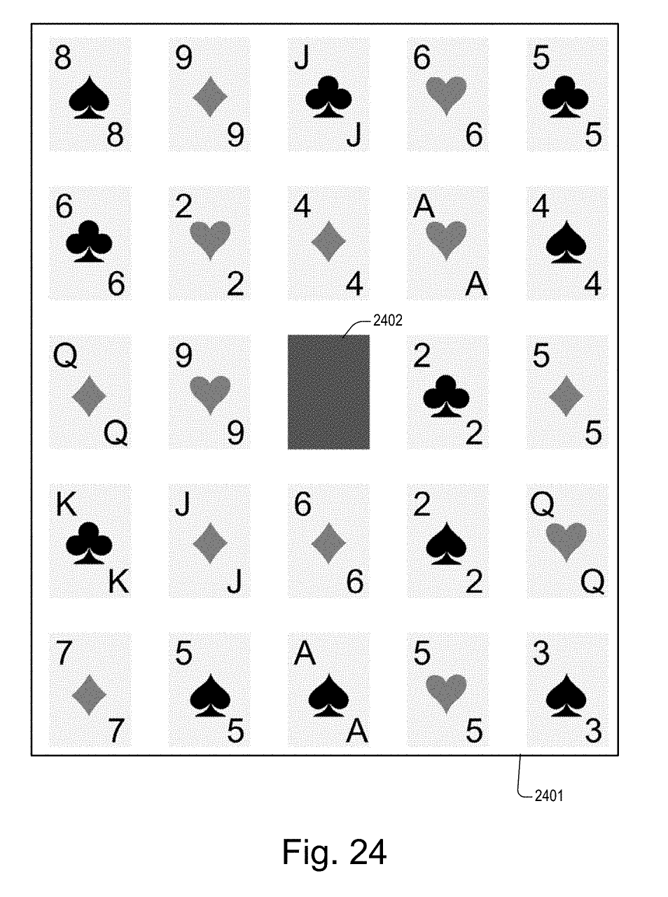

In other embodiments, the playing field may have areas that are locked or unavailable, as illustrated, for example, in FIG. 24. FIG. 24 shows an alternate embodiment of a Match-X Wagering Game GUI 2401, in which the playing field includes at least one slot (e.g., 2402) which is locked or unavailable for receiving or displaying cards during game play of the Match-X Wagering Game session.

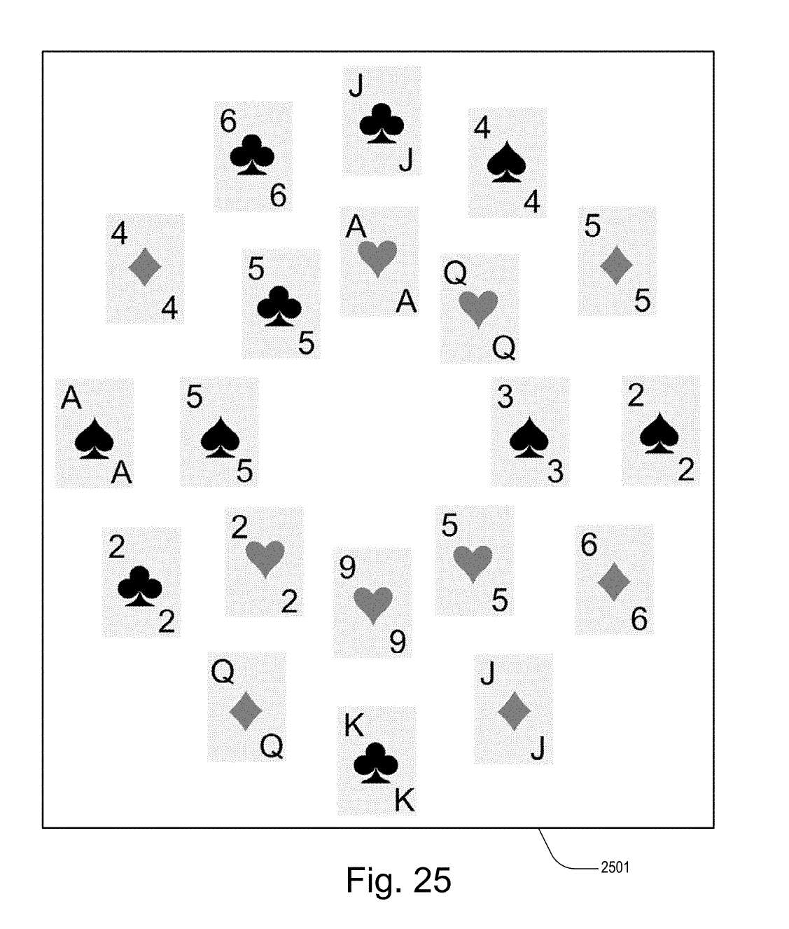

In yet other Match-X Wagering Game embodiments, the topology or configuration of the playing field may be represented by shapes that are not rectangular grids. For example, FIG. 25 shows an alternate embodiment of a Match-X Wagering Game GUI 2501, in which a circular-shaped playing field is used.

As noted above, the example Match-X Wagering Game which has been described herein with respect to FIGS. 16-23, corresponds to a specific variation of Match-X Wagering Game embodiment(s) which may be referred to as “Five Card Poker Hand Match-X”. However, it will be appreciated that other variations of Match-X Wagering Game embodiments may be deployed at one or more EGMs, where each Match-X Wagering Game variation has associated therewith its own respective set of Match-X Wagering Game rules, and wherein portions of each set of game rules may differ from each other and/or may differ from the Five Card Poker Hand Match-X set of game rules.

By way of illustration, a different Match-X Wagering Game variation is represented by FIGS. 28-31. For reference purposes, the specific variation of the Match-X Wagering Game represented by FIGS. 28-31 may be referred to as “Two Card Swap Match-X”. As described in greater detail below, in the Two Card Swap Match-X Game variation, a player is allowed to select two adjacent tiles which may swap positions on the playing field. After the cards are swapped, the system may analyze the updated arrangement of cards in the playing field to identify one or more Poker Hands which meet minimum criteria (e.g., such as, for example, 5-card poker hand comprising a pair of jacks or higher). Poker Hands identified by the system in this manner may be referred to as “Automatically Selected Poker Hands”. In some embodiments, the cards selected by the player are only allowed to be swapped if, in doing so, one or more Poker Hands (meeting minimum criteria) can be identified (e.g., by the EGM hardware/software) anywhere in the playing field.

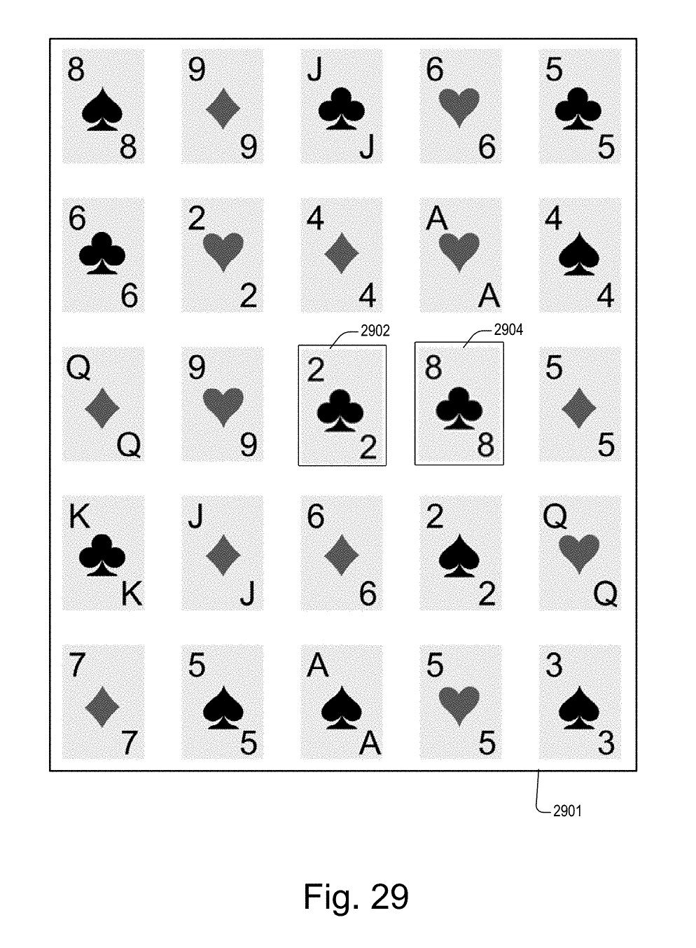

FIG. 28 shows an example flow diagram of a Match-X Wagering Game Procedure B 2800, which is based on the Two Card Swap Match-X variation of the Match-X Wagering Game. Similarly, FIGS. 29-31 illustrate example Game GUIs in accordance with the Two Card Swap Match-X variation of the Match-X Wagering Game. For purposes of illustration, the flow diagram of FIG. 28 will be described by way of illustration with reference to FIGS. 29-31.

It is noted that some of the procedural steps illustrated in the flow diagram of FIG. 28 are substantially similar to those described previously in the description of FIG. 16, and therefore will not be repeated in the description of FIG. 28.

As shown at 2802 of FIG. 28, it is assumed that a player initiates a Match-X Gaming session at an EGM, in which the Match-X Gaming session is conducted in accordance with the Two Card Swap Match-X variation game rules. In this example illustration, it is assumed that the Match-X Wagering Game is played using a Game GUI which is configured to display a 5×5 playing field grid or array, as illustrated, for example, in FIG. 29.

In at least one embodiment, at least one processor may execute a plurality of instructions to identify the number of empty card slots of the playing field to be filled with newly dealt cards. For example, if the Game GUI is configured to display a 5×5 playing field, when the Match-X Wagering Game first commences, the system may identify 25 empty card slots to be filled with newly dealt cards.

As shown at 2804, at least one processor may execute a plurality of instructions to determine the identities/values of new cards to be dealt to empty slots of Game GUI. In one embodiment, a real or simulated deck of 52 standard Poker playing cards may be shuffled, and 25 of those randomly ordered cards may be dealt into each of the 25 grid spaces such that the player can see the faces of each card (FIG. 29). In other embodiments, a real or simulated shoe comprising multiple decks of cards may be employed. In some embodiments, one or more local and/or remote RNG engine(s) may be used to determine the identities/values of new cards to be dealt to empty slots of Game GUI.

As shown at 2806, at least one processor may execute a plurality of instructions to virtually deal or distribute new cards to the empty slots, and display the populated playing field of dealt cards to the player via the Game GUI (e.g., 2901, FIG. 29) of the EGM display.

As shown at 2808, at least one processor may execute a plurality of instructions to enable the player select two cards from the playing field. According to different embodiments, the EGM may be configured or designed to impose various conditions, restrictions, and/or requirements upon the player's selection of cards such as, for example: the selected cards must be adjacent or neighboring each other; and/or one or more other conditions, restrictions, and/or requirements such as those described previously with respect to FIG. 16.

As illustrated in the example Game GUI of FIG. 29, it is assumed that the player selects two cards (e.g., 2902, 2904) from the displayed playing field of cards. In some embodiments, when the player selects a card from the playing field, the visual appearance or properties of that card may be automatically and dynamically changed so as to visually convey to the player that that card has been selected.

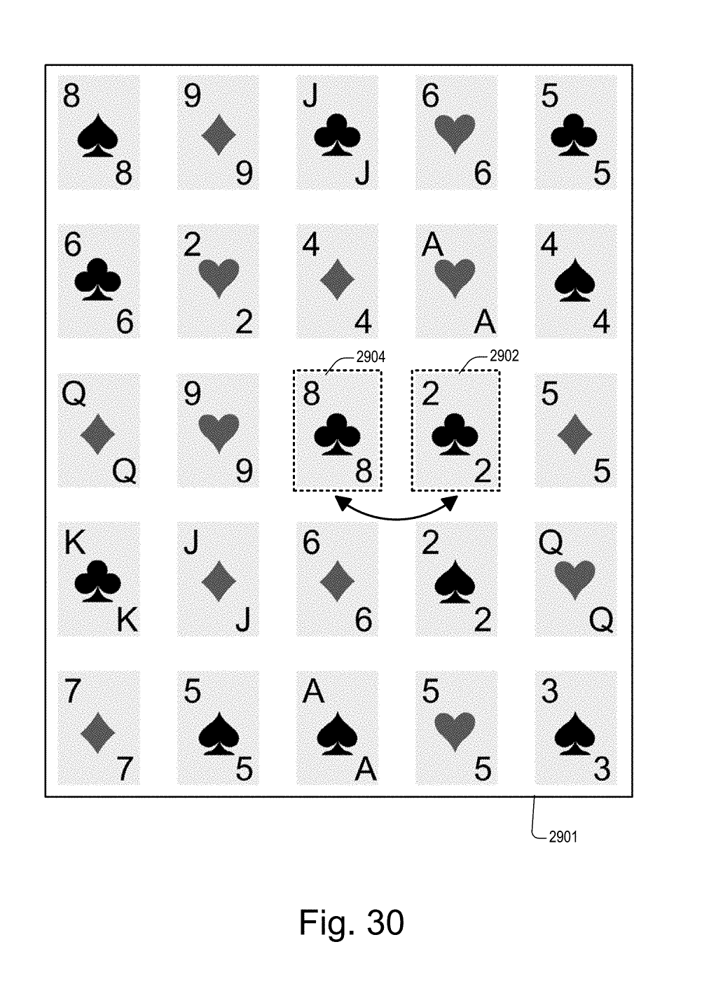

As shown at 2810, at least one processor may execute a plurality of instructions to cause the locations or positions of the selected cards to be swapped, thereby yielding a modified or updated arrangement of cards in the playing field, as illustrated in FIG. 30. In the example Game GUI embodiment of FIG. 30, it can be seen that the positions of the two selected cards 2902, and 2904 have been swapped or exchanged, as compared to their original positions illustrated in FIG. 29.

As shown at 2812, at least one processor may execute a plurality of instructions to analyze the updated arrangement of cards of the playing field (e.g., as illustrated in FIG. 30) in order to identify any Poker Hands which satisfy minimum criteria, in accordance with the Match-X Wagering Game rules. For example, in one embodiment, the game rules may specify that: (i) a Poker Hand includes 5 cards; and (ii) each card of the Poker Hand must be adjacent to (or must be neighboring) at least one other card of the Poker Hand. In some embodiments, the game rules may also specify additional criteria such as, for example, a valid Poker Hand must include at least a pair of jacks or higher, and/or other criteria as determined by the game designer.

At 2814, at least one processor may execute a plurality of instructions to determine if any Poker Hands satisfying the game rule criteria are identified in the playing field. In one embodiment, if the system determines that the playing field does not contain any Poker Hands satisfying the game rule criteria, the system may respond by automatically swapping the two selected cards (e.g., 2902, 2904) back to their original positions (e.g., as represented in FIG. 29).

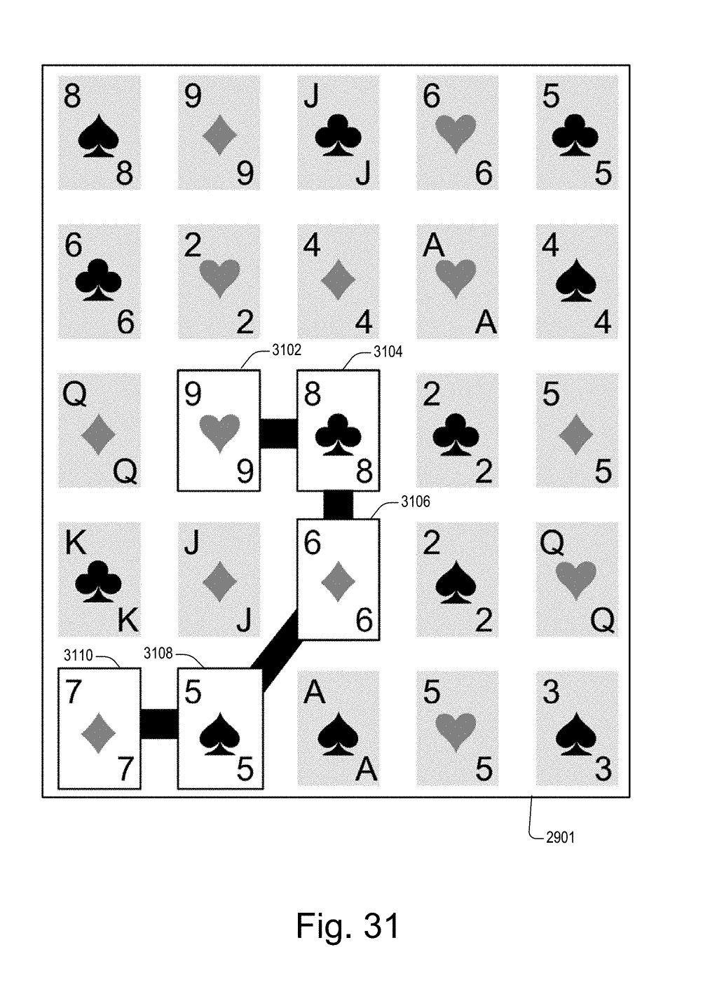

Alternatively, in at least one embodiment, if the system determines that the playing field does contain at least one Poker Hand satisfying the game rule criteria, the system may respond by selecting (2818) an identified Poker Hand, and analyzing the set of cards of the selected poker hand to determine the type or outcome of the Poker Hand (e.g., 2 pair, three of a kind, straight, flush, full house, etc.). In at least one embodiment, the system may automatically and dynamically modify the visual appearance or properties of the set of cards forming the selected Poker Hand, so as to visually convey to the player the set of cards forming the selected Poker Hand, as illustrated, for example, in FIG. 31.

As shown at 2820, at least one processor may execute a plurality of instructions to determine and award/distribute game points, monetary payout(s), credit(s), etc. to the player based, at least in part, on the type or outcome of the selected Poker Hand. For example, as illustrated in the example embodiment of FIG. 31, the system may determine that the selected set of cards (e.g., 3102, 3104, 3106, 3108, 3110) corresponds to a “Straight” poker hand, and may award/distribute game points, monetary payout(s), credit(s), etc. to the player based on identifying the type or outcome of the Poker Hand as a “Straight”. In some embodiments, the system may determine the value(s) of the payout amount(s) which are to be paid or distributed to the player using one or more paytables.

At 2832, the system may determine if any additional Poker Hand(s) satisfying the game rule criteria is/are identified in the playing field. In one embodiment, if the system identifies another Poker Hand in the playing field satisfying the game rule criteria, the system may respond by selecting (2818) an identified Poker Hand from the playing field, and processing the selected Poker Hand by performing one or more of the procedural steps to a 2820-2830 for the currently selected Poker Hand. This process may continue until no more Poker Hands satisfying the game rule criteria are identified in the playing field.

In at least one embodiment, the system may be configured or designed to execute procedural steps 2824, 2826, 2828, 2830 before execution of procedural step 2832, thereby causing new cards to be dealt into the empty slots of the playing field before the system proceeds (at 2832) to identify, process, and remove additional Poker Hands from the playing field.

Alternatively, in other embodiments, the system may be configured or designed to execute procedural steps 2824, 2826, 2828, 2830 after execution of procedural step 2832, thereby causing the system to identify, process, and remove all Poker Hands in the playing field which satisfy the game rule criteria, before any cards from the playing field are shifted down, and before any new/additional cards are dealt into the empty slots of the playing field.

In yet another alternate embodiment, the system may be configured or designed to execute procedural step 2824 before execution of procedural step 2832, and to execute procedural steps 2826, 2828, 2830 after execution of procedural step 2832, thereby causing the system to defer dealing any new/additional cards into the empty slots of the playing field until after the system has completed: (i) identifying, processing, and removing each Poker Hand in the playing field which satisfies the game rule criteria, and (ii) shifting selected cards of the playing field down to fill any lower empty card slots in the playing field each time an identified Poker Hand is removed from the playing field.

As shown at 2834, at least one processor may execute a plurality of instructions to determine if a game over condition has occurred or been detected. In at least one embodiment, if the system determines that a game over condition has not occurred, the system may allow the player to continue playing additional hands/rounds of the Match-X Wagering Game. Alternatively, if the system determines that at least one game over condition has occurred (or is detected), the system may execute a plurality of instructions to end (2836) the Match-X Gaming session.

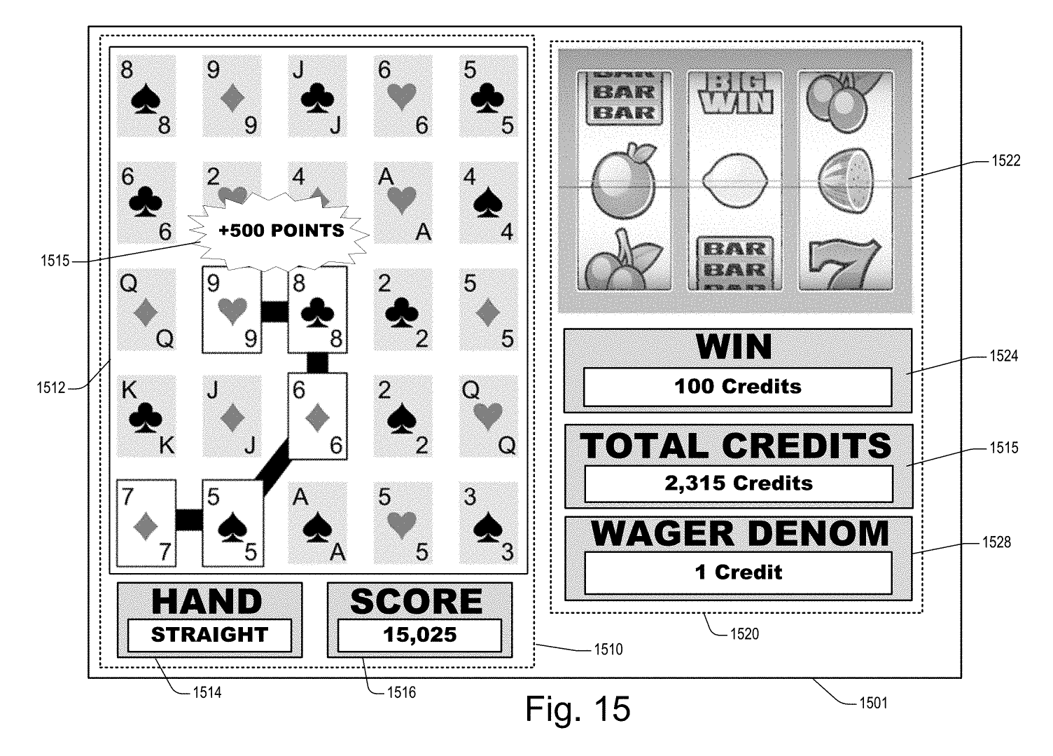

An alternate embodiment of a Match-X Wagering Game is illustrated in FIG. 15. FIG. 15 shows a screenshot of an example embodiment of a hybrid skill-based/wager-based Match-X Poker Game GUI 1500 which may be used for facilitating game play and wagering activities relating to play of one or more HAWG-type Match-X Wagering Games (herein referred to as “HAWG Match-X Poker Games”, or “HAWG Match-X Poker Game” in singular form) at one or more EGMs.

As illustrated in the example embodiment of FIG. 15, the HAWG Match-X Poker Game GUI 1501 includes a skill-based game GUI portion 1510 and a wager-based game GUI portion 1520. In accordance with one variation of a HAWG Match-X Poker Game embodiment, a player engages in Match-X Poker Game play activities via interaction with the playing field 1512 of the skill-based game GUI portion (e.g., in a manner similar to that described above with respect to the Five Card Poker Hand Match-X Game embodiment). In at least one HAWG Match-X Poker Game embodiment, wherever the system detects that the player has selected a set of five cards from the playing field 1512 which satisfy specific criteria (e.g., specifically defined wager-based triggering event criteria), the system may determine that such a condition qualifies as a wager-based triggering event, and, in response, may automatically execute a plurality of instructions to initiate (e.g., on behalf of the player) a wager-based spin of the virtual slot reel 1522. The system may then calculate and distribute to the player any wager-based payout(s) which may be due to the player based on the outcome of the wager-based slot reel spin.

According to different embodiments, the wager-based portion of the game (e.g., conducted at wager-based game GUI portion 1520) may be implemented as a RNG-based game of chance (e.g., such as, for example, a slot reel spin, roulette wheel spin, dice roll, etc.). In some embodiments, the outcome of the wager-based game event is determined after the wager-based triggering event has occurred. In other embodiments, as described in greater detail herein, the outcome of the wager-based game event is determined before the wager-based triggering event has occurred, but not revealed until after the wager-based game event (e.g., wager-based spin of the slot reels) has been initiated.

According to different embodiments, the HAWG Match-X Poker Game GUI 1500 may be configured or designed to display GUIs, graphics, animation, images, video, text, and/or other types of content such as, for example, one or more of the following (or combinations thereof):
Skill-based game GUI portion 1510. As illustrated in the example embodiment of FIG. 15, the skill-based game GUI portion may be configured or designed to include: interactive Playing Field GUI portion 1512, Match-X Poker Hand Outcome GUI portion 1514, Match-X Poker Game Score GUI 1510, etc.
Wager-based game GUI portion 1520. In the specific example embodiment of FIG. 15, the wager-based game GUI portion may be configured or designed to include: slot reel game GUI portion 1522, win amount GUI portion 15624, credit meter GUI portion 2626; wager denomination GUI portion 1528 (e.g., specifying an amount to be automatically wagered for each wager-based spin of the slot reel which is initiated during play of the HAWG Match-X Poker Game), etc.

In the specific example embodiment of FIG. 15, it is assumed that the outcome of the wager-based slot game 1522 results in the player winning 100 credits (1524), which may be automatically distributed to the player's account or to the EGM's credit meter. In at least some embodiments, credits won by the player during play of the HAWG Match-X Poker Game may be converted into cash or other forms of monetary currency or credit.

In at least some embodiments, the player may be awarded points or other non-monetary rewards based on the player's game play activities at the skill-based game GUI portion. For example, as illustrated in the example embodiment of FIG. 15, the system has awarded the player+500 points (1515) based on the player's selection of cards in the playing field, which form a “Straight” poker hand. In one embodiment, the player's total or overall score for this skill-based portion of the game may be displayed at Match-X Poker Game Score GUI 1510. In at least some embodiments, the game play activities conducted at the skill-based game GUI portion are non-wager based.

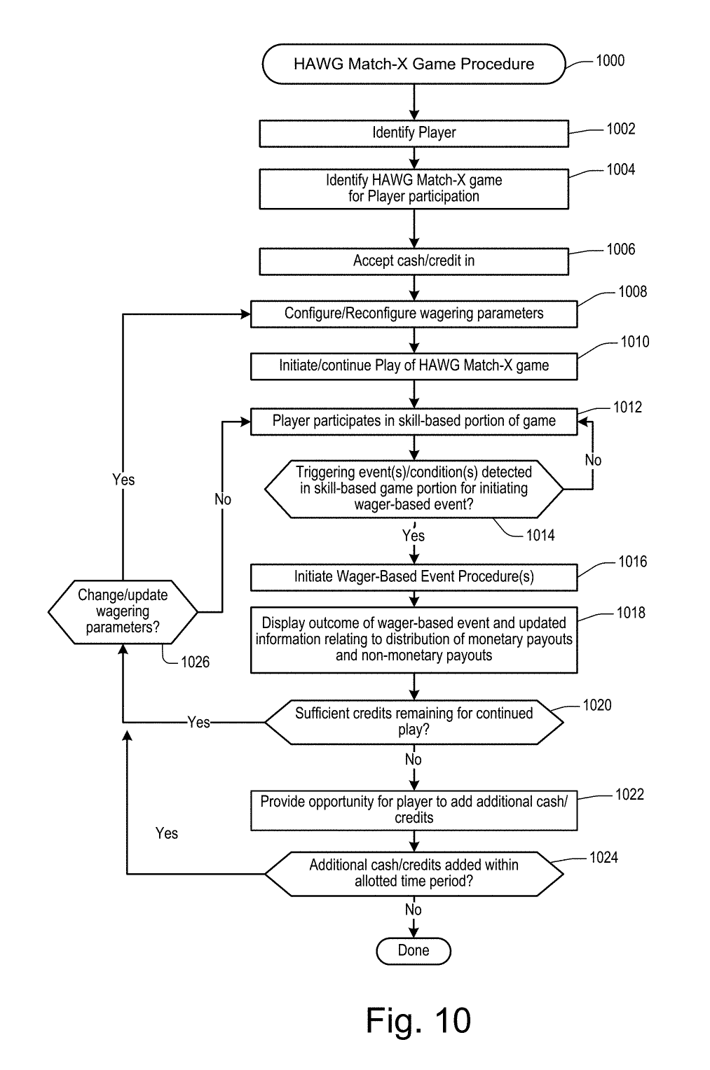

FIGS. 10-13 illustrate various example embodiments of different hybrid skill-based/wager-based Gaming procedures and/or procedural flows which may be used for facilitating activities relating to one or more of the HAWG Match-X Poker Game aspects disclosed herein. For purposes of illustration, an example walk-through of a specific embodiment of a HAWG Match-X Poker Game will now be described by way of example with reference to the FIGS. 10-13.

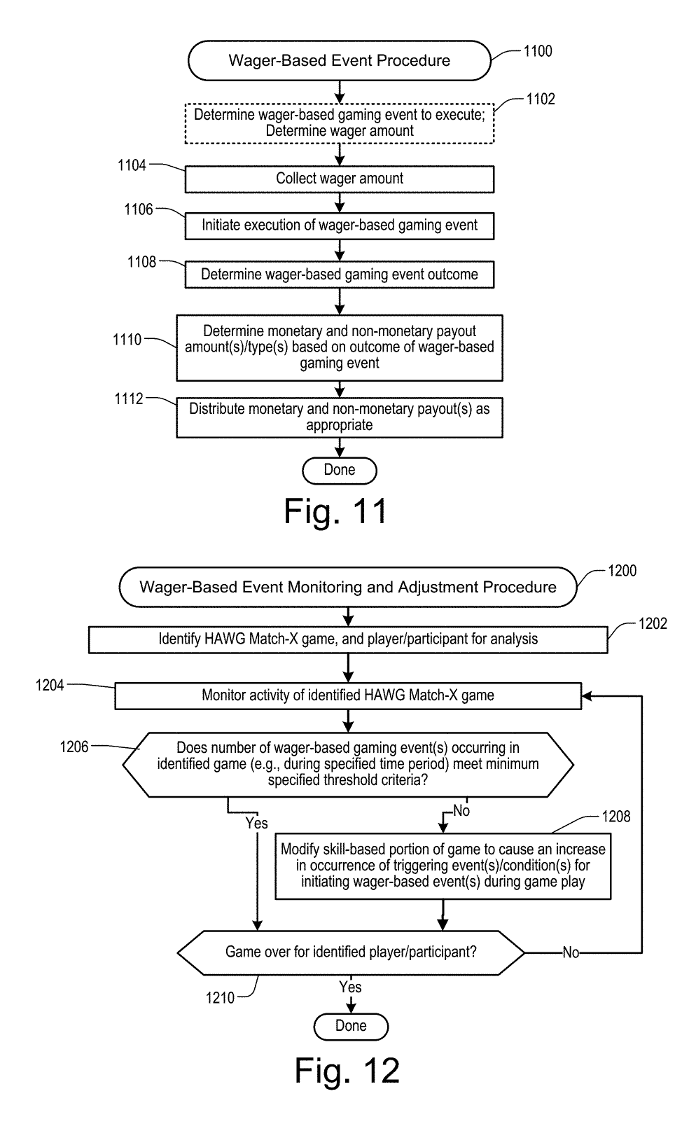

FIG. 10 shows an illustrative example of an embodiment of a HAWG Match-X Poker Game Procedure 1000. As illustrated in the example embodiment of FIG. 10, the HAWG Match-X Poker Game Procedure may facilitate, enable, initiate, and/or perform one or more of the following operation(s), action(s), and/or feature(s) (or combinations thereof):
Identify Player 1002.
Identify HAWG Match-X Poker Game for Player participation 1004.
Accept cash/credit in 1006.
Configure/Reconfigure wagering parameters 1008. Reconfigure wagering parameters during continued game play, if desired.
Initiate/continue Play of hybrid skill-based, wager-based Game 1010. Continue play of game (if start of game already initiated).
Player participates in skill-based portion of game 1012, which corresponds to the non-wager based portion of the HAWG Match-X Poker Game.
Triggering event(s)/condition(s) detected in skill-based game portion for initiating wager-based event? For example:
   Player selects set of cards which form a Poker Hand comprising at least a pair of jacks or better?
   Achievement satisfied or accomplished in skill-based portion of game?
   Other type of wager-based triggering event detected?
If yes to 1014, Initiate Wager-Based Event Procedure(s) 1016, such as those described with respect to FIG. 11. By way of illustration:
   Initiate wager-based virtual slot reel spin in response to player selecting set of cards from playing field which form a Poker Hand comprising at least a pair of jacks or better.
   Initiate wager-based virtual slot reel spin in response to player achieving an objective in the non-wager-based portion of the HAWG Match-X Poker Game.
   Etc.
Display outcome of wager-based event and updated information relating to distribution of monetary payouts and non-monetary payouts.
Display outcome of wager-based event and updated information relating to distribution of monetary payouts and non-monetary payouts 1018 (e.g., display outcome of virtual slot reel spin and update player's credits based on payout from virtual slot reel spin). In some embodiments, depending upon the wager-based game event outcome, one or more non-monetary payouts may also be distributed (e.g., within the skill-based portion of the HAWG Match-X Poker Game).
Sufficient credits remaining for continued play of HAWG Match-X Poker Game 1020?
If yes to 1020, change/update wagering parameters 1026?
If no to 1020, provide opportunity for player to add additional cash/credits 1022.
Additional cash/credits added within allotted time period 1024?
If yes to 1024, present opportunity to change wager parameters 1026, and continue game play 1012.
If no to 1024, end player's participation in HAWG Match-X Poker Game.

FIG. 11 shows an illustrative example of a Wager-Based Event Procedure 1100 in accordance with a specific example embodiment. In at least one embodiment, the Wager-Based Event Procedure 1100 may be initiated or implemented concurrently during HAWG Match-X Poker Game play, allowing player to seamlessly continue skill-based game play while wagering event is executed and outcome determined. As illustrated in the example embodiment of FIG. 11, the Wager-Based Event Procedure may facilitate, enable, initiate, and/or perform one or more of the following operation(s), action(s), and/or feature(s) (or combinations thereof):
Determine wager-based gaming event to execute, and determine wager amount(s) 1102.
Collect wager amount 1104. For example, collect one credit.
Initiate execution of wager-based gaming event 1106. For example, initiate spin of RNG-based virtual slot reels.
Determine wager-based gaming event outcome 1108. For example, determine outcome of virtual slot reel spin.
Determine monetary and non-monetary payout amount(s)/type(s) (if any) based on outcome of wager-based gaming event 1110. According to different embodiments, depending on the wager-based game event outcome, monetary payouts and/or non-monetary-payouts may be identified for distribution.
Distribute monetary and non-monetary payout(s) as appropriate 1112. For example, distribute any monetary payout(s) (e.g., credits) and/or non-monetary payouts due to player based on outcome of virtual slot reel spin.

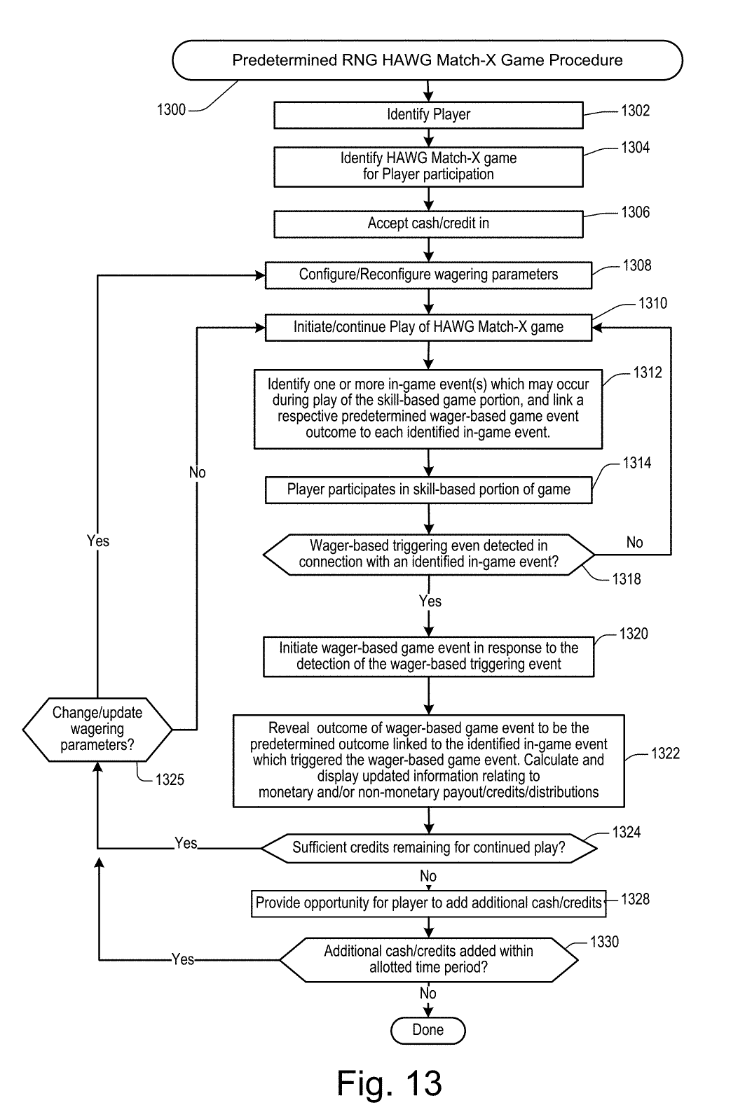

FIG. 13 shows an illustrative example of a Predetermined RNG HAWG Match-X Poker Game Procedure 1300 in accordance with a specific example embodiment. As illustrated in the example embodiment of FIG. 13, the Predetermined RNG HAWG Match-X Poker Game Procedure may facilitate, enable, initiate, and/or perform one or more of the following operation(s), action(s), and/or feature(s) (or combinations thereof):
Identify Player 1302.
Identify HAWG Match-X game for Player participation 1304.
Accept cash/credit in 1306.
Configure/Reconfigure wagering parameters 1308. Reconfigure wagering parameters during continued game play, if desired.
Initiate/continue Play of HAWG Match-X game 1310. Continue play of game (if start of game already initiated).
Identify one or more in-game event(s) which may occur during play of the skill-based game portion, and link a respective predetermined wager-based game event outcome to each identified in-game event 1312. In at least one embodiment, this may involve generating or acquiring a respective, predetermined outcome (e.g., RNG-based outcome) for one or more identified in-game event(s). For example, in the HAWG Match-X Poker Game, each different type of Poker Hand (e.g., 2 pair, three of a kind, straight, flush, full house, etc.) may be linked to a respective RNG-based game of chance outcome, which has been determined before the initiation of the associated RNG-based game of chance (e.g., before the spin of virtual slot reels). In at least some embodiments, the HAWG Match-X Poker Game may be configured or designed to prevent the player from being aware that the outcome of the wager-based game of chance has been predetermined. In such embodiments, even though the outcome of the wager-based game of chance has been predetermined, the HAWG Match-X Poker Game may be configured or designed to lead the player to believe that the outcome of the wager-based game of chance was determined subsequent to the execution of the wager-based game of chance.
Player participates in skill-based portion of game 1314, which, in the embodiment of FIG. 15 may correspond to the playing field GUI portion 1512 of the HAWG Match-X Poker Game GUI.
Wager-based triggering event detected in connection with an identified in-game event 1318? For example, in at least one embodiment, the gaming device may be configured or designed to monitor activities in the skill-based GUI portion of the HAWG Match-X Poker Game for occurrences of in-game event(s) which qualify as wager-based triggering event(s). In one embodiment, if an occurrence of an in-game event is detected, the gaming device may determine whether or not the occurrence of the detected in-game event qualifies as a wager-based triggering event. For example, a player selecting 5 neighboring cards in the playing field which form a “Straight” poker hand may correspond to an in-game event which qualifies as a wager-based triggering event.
If it is determined that the occurrence of the first in-game event qualifies as a wager-based triggering event, the gaming device may initiate 1320 a wager-based game event in response to the occurrence or detection of the wager-based triggering event. For example, in at least one embodiment, when a wager-based triggering event occurs in the skill-based portion of the HAWG Match-X Poker Game, the HAWG Match-X Poker Game may respond by automatically initiating a wager-based game event such as, for example, initiating wager-based spin of a set of virtual slot reels. In at least one embodiment, the process of initiating a wager-based game event may include:
   automatically identifying an amount to be wagered on the outcome of the wager-based game event; and
   automatically using funds from the player's account to initiate and fund a wager (for the identified wager amount) on the outcome of the wager-based game event.
Reveal the outcome of wager-based game event to be the predetermined outcome which has been linked to the identified in-game event that triggered initiation of the wager-based game event. Calculate and display updated information relating to monetary and/or non-monetary payouts/credits/distributions (if any).
Sufficient credits remaining for continued play of HAWG Match-X Poker Game 1324?
If yes to 1324, change/update wagering parameters 1325?
If no to 1324, provide opportunity for player to add additional cash/credits 1328.
Additional cash/credits added within allotted time period 1330?
If yes to 1330, present opportunity to change wager parameters 1325, and continue game play 1310.
If no to 1330, end player's participation in HAWG Match-X Poker Game.

In at least some embodiments where HAWG Match-X Poker Games are deployed in casino/regulated environments in which voluntary and/or mandatory rules/regulations are imposed (e.g., based on GLI standards, specific jurisdiction rules/regulations, and/or casino rules/regulations), one or more mechanisms may be implemented (see, e.g., FIG. 12) to cause wager-based game events to be initiated or triggered in a manner which conforms with governing rules/regulations. For example, according to different embodiments, a HAWG Match-X Poker Game may be configured or designed to automatically create conditions for a wager-based triggering event to occur in situations where there is lack of player input while credits are present, and gameplay is expected. In other embodiments, one or more HAWG Match-X Poker Games may be configured or designed to automatically cause wager-based game events to be initiated or triggered in accordance with specifically defined rules and/or criteria such as, for example, one or more of the following (or combinations thereof):
One wager-based event (e.g., virtual reel spin) about every 10 seconds (or sooner);
6 wager-based events (e.g., 6 separate reel spins) w/in 30 seconds);
10 wager-based events (e.g., 10 separate reel spins) during each level of game play);
Etc.

FIG. 12 shows an illustrative example of a Wager-Based Event Monitoring and Adjustment Procedure 1200 in accordance with a specific example embodiment. As illustrated in the example embodiment of FIG. 12, the Wager-Based Event Monitoring and Adjustment Procedure may facilitate, enable, initiate, and/or perform one or more of the following operation(s), action(s), and/or feature(s) (or combinations thereof):
Identify HAWG Match-X Poker Game, and player/participant for analysis 1202.
Monitor activity of identified HAWG Match-X Poker Game 1204.
Does number of wager-based gaming event(s) occurring in identified game (e.g., during specified time period) meet minimum specified threshold criteria 1206?
If no to 1206, modify arcade portion of game to cause an increase in occurrence of triggering event(s)/condition(s) for initiating wager-based event(s) during game play 1208. For example, in one embodiment, a minimum specified threshold criteria may be configured by the Casino such as, for example, one or more of the following (or combinations thereof):
   One wager-based event (e.g., virtual reel spin) about every 10 seconds (or sooner);
   6 wager-based events (e.g., 6 separate reel spins) w/in 30 seconds);
   10 wager-based events (e.g., 10 separate reel spins) during each level of game play);
   Etc.
If yes to 1206, game over for identified player/participant 1210?
If no to 1210, continue to monitor activity of identified hybrid skill-based, wager-based Game 1204.

In at least one embodiment, if the system determines (1206) that the number of wager-based gaming event(s) occurring in identified game (e.g., during specified time period) does not meet minimum specified threshold criteria, the system may respond by automatically and/or dynamically modifying aspects of the skill-based portion of game to cause or facilitate an increase in occurrence of wager-based triggering events in the skill-based portion of the HAWG Match-X Poker Game.

It is to be noted that, although various process steps, method steps, algorithms or the like may be described in a sequential order, such processes, methods and algorithms may be configured to work in alternate orders. Accordingly, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

### Match-X Wagering Game Paytables

FIG. 27 shows a simplified representation of a set of paytables 2700 which may be used by the system for determining the value(s) of the payout amount(s) which are to be paid or distributed to the player. As illustrated in the example embodiment of FIG. 27, the set of paytables 2700 includes a plurality of distinct paytables (e.g., Table 1, Table 2, Table 3, etc.), wherein each distinct paytable is populated with its own respective set of paytable data representing different payout amounts (e.g., in credits) for different types of poker hands which may occur during one or more Match-X Wagering Game sessions. For example, as illustrated in the example embodiment of FIG. 27, Table 1 (2701) indicates a payout amount of 10 credits for a “Straight”, whereas Table 5 (2705) indicates a payout amount of 5 credits for a “Straight”. In at least one embodiment, the system may be configured or designed to utilize various criteria for automatically and dynamically selecting one of the distinct paytables for determining the value of the payout amount for a given set of cards selected by the player. Examples of such criteria may include, but are not limited to, one or more of the following (or combinations thereof):
Initial wager amount. For example, if player initially bets one credit, Table 1 (2701) may be used; if player initially bets 2 credits, Table 4 (2704) may be used; etc.
Game level.
Number of card decks used during game play (e.g., single deck, double deck, 6 decks, etc.).
Player's wager history.
In-game achievement(s) and/or bonus(es) earned by player.
Skill-based criteria.
Time-based criteria.
Wager-based criteria.
Input received from player.
Randomized selection.
Etc.

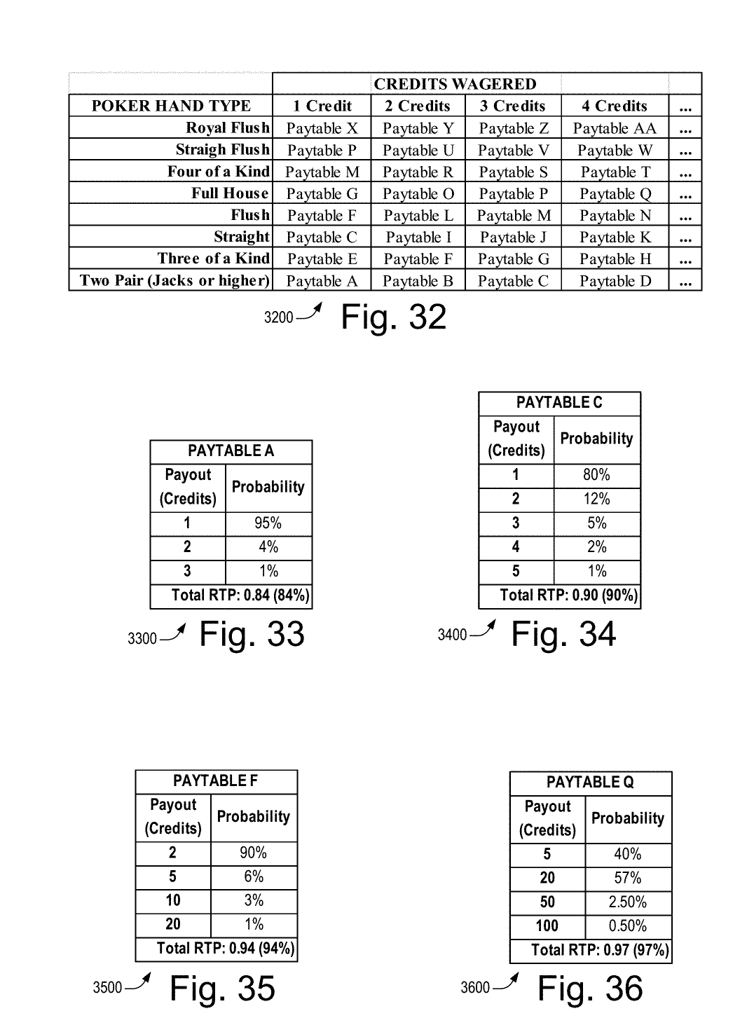

FIGS. 32, and 33-36 illustrate simplified representations of different types of paytable-related data structures which may be used for facilitating wager-related activities relating to play of one or more embodiments of Match-X Wagering Games.

More specifically, FIG. 32 illustrates a simplified representation of a Paytable Lookup Table 3200 which may be used by the system to identify an appropriate paytable to be used for determining the value of a payout amount to be paid to the player. As illustrated in the example embodiment of FIG. 32, the Paytable Lookup Table 3200, each different type of Poker Hand (e.g., Straight) references a respective set of paytables (e.g., Paytable C, Paytable I, Paytable J, Paytable K, etc.), each of which may be used for determining payout value(s) associated with that specific type of poker hand. In the specific example embodiment of FIG. 32, the selection of the specific paytable to be used for a given type of poker hand may be determined based upon the amount of credits wagered. Thus, for example, utilizing (1) the poker hand type, and (2) amount of credits wagered as lookup parameters, the system may access the Paytable Lookup Table to identify and select the appropriate paytable to be used for determining the value of a payout amount to be paid to the player for a given wager-based event.

By way of illustration, in at least one embodiment, when the system analyzes a set of selected cards from the playing field (which, for example, may either be manually selected by the player, or automatically selected by the system) and determines that the set of selected cards forms a valid poker hand (e.g., in accordance with game rule criteria), the system may identify the type of poker hand which has been selected (e.g., Pair, Three Of A Kind, Straight, Flush, Full House, etc.) along with the amount of credits which has been wagered, and may consult the Paytable Lookup Table 3200 in order to identify and select the appropriate paytable to be used for determining the value of a payout amount to be paid to the player for that particular selection of cards. For example, if the system identifies the selected set of cards to correspond to a Flush poker hand, and determines that the wagered amount is 2 credits, the system may access the Paytable Lookup Table to identify Paytable L as the appropriate paytable to be used for determining the value of a payout amount to be paid to the player for that selected set of cards. Alternatively, if the system identifies the selected set of cards to correspond to a Straight poker hand, and determines that the wagered amount is 1 credit, the system may access the Paytable Lookup Table to identify Paytable C as the appropriate paytable to be used for determining the value of a payout amount to be paid to the player for that selected set of cards.

FIGS. 33-36 illustrate simplified representations of various different paytables which may be referenced by the Paytable Lookup Table 3200. For example, FIG. 33 illustrates a simplified example representation of a Paytable A; FIG. 34 illustrates a simplified example representation of a Paytable C; FIG. 35 illustrates a simplified example representation of a Paytable F; FIG. 36 illustrates a simplified example representation of a Paytable Q.

As illustrated in the example embodiment of FIGS. 33-36, each paytable includes respective paytable data specifying, for example, one or more payout amount(s), and a respective weighted probability value associated with each different payout amount. Using this information, the system may utilize a weighted randomization technique in order to determine a final payout amount to be paid out.

For example, if the system were to utilize Paytable A (FIG. 33) to determine the final payout amount, there would be:
a 95% probability that the final payout amount is 1 credit;
a 4% probability that the final payout amount is 2 credits; and
a 1% probability that the final payout amount is 3 credits.

In a similar manner, if the system were to utilize Paytable F (FIG. 35) to determine the final payout amount, there would be:
a 90% probability that the final payout amount is 2 credits;
a 6% probability that the final payout amount is 5 credits.
a 3% probability that the final payout amount is 10 credits; and
a 1% probability that the final payout amount is 20 credits.

### Additional Match-X Wagering Game Features

As mentioned previously, various embodiments of Match-X Wagering Games may be configured or designed to utilize different themes from existing non-wager based and/or skill-based “Match-X” type games such as, for example, Bejeweled™, Candy Crush™, etc. Other types of skill-based “Match-X” type games are described in the book, “A Casual Revolution/Reinventing Video Games and their Players”, ISBN 9780262013376, by Jesper Juul, herein incorporated by reference in its entirety for all purposes. It will be appreciated that various embodiments of Match-X Wagering Games may be configured or designed to incorporate selected aspects from one or more skill-based “Match-X” type games.

Poker games are also well known. One significant aspect of Poker is the rankings and descriptions of the Poker hands such as, for example: Pair, Two Pairs, Three-of-a-Kind, Straight, Flush, Full House, Four-of-a-Kind, Straight Flush, Royal Flush, etc. What is specifically interesting about these Poker hand descriptions is that they differentiate themselves based on a card's Rank (2-10, J, Q, K, A) or a card's Suit (Spades, Clubs, Hearts, Diamonds) or both. This allows for an interesting combination of factors that may make one Poker hand more valuable to the player than another Poker hand. This makes Poker hands different than the matched gems found in Match-X games in that the combination of disparate cards creates value as opposed to the accumulation of like objects.

In some Match-X Wagering Game embodiments, a Poker Hand may be defined using the standard definitions of Poker hands well accepted throughout the world (e.g. Straight, Flush, etc). In other embodiments, non-standard Poker Hands may be defined. By way of example, one embodiment may define a “Short Straight” as being a Poker Hand where four of the five cards may be arranged such that their rank is in strictly ascending (or descending) consecutive order. For example, “4, 5, 6, 7, Jack”. It should be appreciated that the number of possible Poker Hand definitions is very large, and may not be enumerated entirely here.

In traditional skill-based “Match-X” type games such as Bejeweled™ or Candy Crush™, the duality of Rank and Suit does not exist in each of gems, jewels or other icons (“tiles”) that the player is expected to match. Further, a player is typically rewarded based on the count of tiles that he has matched, while sometimes being rewarded differently based on the type of the tiles that he has matched. For example, matching 3 diamonds may reward the player more than matching 3 topazes.

In some Match-X Wagering Game embodiments, a player is allowed to remove a variable number of tiles by selecting a set of neighboring matched tiles. An example of this is the Five Card Poker Hand Match-X Wagering Game. In other Match-X Wagering Game embodiments, a player is allowed to select two adjacent tiles, and after the selection, the two tiles swap position if the resulting tiles yield some set of matching tiles on the playing field. An example of this latter embodiment is the Two Card Swap Match-X Wagering Game.

Other variations of Match-X Wagering Game embodiments may utilize symbols or tiles rather than playing cards. For example, in one illustrative embodiment of a Match-X Wagering Game, the playing field may include an array of tiles, where each tile has associated therewith two distinct attributes such as, for example, a color attribute (e.g., yellow, blue, green, red), and a symbol attribute (e.g., numbers 1-9, set of dots ranging from 1-9 similar to dominos, etc.). Each of these different attributes may be meaningful, and each may respectively influence match selection(s), match event(s), wager-based payout(s), and/or other rewards. In some embodiments, a standard deck of Poker cards may be adapted for use in the playing field as two-dimensional tiles.

In some Match-X Wagering Game embodiments, the Match-X Wagering Game may be configured or designed to utilize gems, shapes, numbers, or other icons. Additionally, some Match-X Wagering Game embodiments may be configured or designed to include functionality for drawing cards and/or incorporating other variations on classic Poker-type games.

In some Match-X Wagering Game embodiments the playing field may include special cards or tiles which may be mixed in with the other cards/tiles of the playing field, and which may alter the typical rules of Match-X Wagering Game play in some way, such as, for example, a “bomb” card or tile that, when included in any set of selected cards/tiles, may blow up and remove all cards/tiles in a certain region of the game.

In some Match-X Wagering Game embodiments, a level may begin with an entire playing field randomly populated with cards, as seen in FIG. 17. In alternate embodiments, there may be “blocked” locations on the playing field where cards are prevented from being displayed. In some embodiments, the population of cards may not be random, but rather defined by some algorithm, some pre-set configuration, or some other method.

### Match-X Wagering Game—End of a Level

In some Match-X Wagering Game embodiments, a “level” or “game level” may be defined by one or more of the following (or combinations thereof): one or more decks of cards, one playing field, and information about what each Poker Hand is worth. In addition, any game design information, such as time to complete the level, cards that may be considered “wild cards”, size of a Poker Hand, how many hands are required to complete the level, etc., may be included in the definition of a level.

In some Match-X Wagering Game embodiments, the player may continue trying to select sets of cards until he has no remaining legitimate selections. For example, if there are only 4 cards on the playing field, then no legitimate selection remains and the level may be considered complete. In another illustrative embodiment, the player may be allowed to select 8 sets of 5 cards for a level, forming 8 distinct Poker Hands. In another Match-X Wagering Game embodiment, the player may be given a specific amount of time to select as many legitimate sets of 5-card poker hands as possible, perhaps with a maximum number of sets selectable, or perhaps until there are no legitimate sets available. In some embodiments, if the source of cards is infinite, then the player may be able to play a level for as long as he likes.

In some Match-X Wagering Game embodiments, the level may be considered complete or otherwise at an end when the player's interactions have been completed. Other times, when the player's interactions have been completed, the level may be left available to the player to begin another wagering experience.

### Match-X Wagering Game—Rewards

In some Match-X Wagering Game embodiments, a player is rewarded based on the relative “strength” of that Player's Poker Hand. By way of example, if the player selected five cards that formed a Straight, he may receive a greater reward/payout than if the player selected cards that formed a Three-of-a-Kind.

Some Match-X Wagering Game embodiments may use the classic Poker Hand ranking system to determine which Player's Poker Hands are worth relatively more or less than other Player's Poker Hands. This is not a requirement, however, and through mathematics it may be observed that in this game, the rankings of standard Poker Hands do not match the statistical probability of those hands appearing within a playing field. Therefore, in at least some embodiments, a Straight may be more valuable than a Flush, despite the opposite classic Poker ranking.

In some Match-X Wagering Game embodiments, each Poker Hand may be associated with a value. This value may represent a certain number of credits, a multiple of the wager, some other value (such as “a new car”), a progressive prize, a dollar amount, an opportunity to participate in some event, etc. There are many types of well-known values that are awarded for gambling activity in casinos, and one or more of these values could be associated with any Poker Hand. By way of example, a Royal Flush may be associated with a progressive prize, while a Three-of-a-Kind may be associated with a 2-times multiple of the wager.

### Match-X Wagering Game—Wagering

### Per Interaction Wagering

In some Match-X Wagering Game embodiments, a player may be required to make a wager prior to each interaction with the playing field. The limits placed on this wager may be determined by the game design/game configuration parameters.

### Per Level Wagering

In some Match-X Wagering Game embodiments, at the beginning of a level, the player may place a first wager or a first set of wagers. The player may then be allowed to make or perform a first set of interactions (e.g., card selections, swaps, etc.) with the playing field objects (e.g., virtual playing cards displayed at the playing field). In some embodiments, the first set of wagers and first set of interactions may be equal, or the first set of interactions may be based in some way on the first set of wagers, or the first set of interactions may be unrelated to the first set of wagers. For example, if the player places 5 wagers at the beginning of a level, the player may then be allowed to swap cards five times. For example, if the player places one wager at the beginning of the level, the player may then be allowed to make 10 interactions with the playing field.

The limits placed on the number of wagers may be configured or predetermined based on game design parameters, and may be defined as a specific value or range of values. For example, the Match-X Wagering Game software may dictate that the player may make exactly 1 wager at the beginning of a level, or the software may dictate that the player may make between 5 and 10 wagers at the beginning of a level.

The number of interactions that the player makes may be a constant value, or it may be a function of the number of wagers placed. For example, a player may be allowed to make five times (5×) as many interactions as wagers placed.

In some Match-X Wagering Game embodiments, the player may be allowed to place additional wagers after the initial number of interactions has been made. This may be at the player's discretion, or it may be predicated on the detection or occurrence of specific conditions/events, as defined by the game configuration parameters. In some Match-X Wagering Game embodiments, this ability to place additional wagers may continue indefinitely, while at other times the game rules may place a limit on the number of additional wagers.

In some Match-X Wagering Game embodiments, the wagering experience may coincide with or occur at the beginning of a level. Other times, the wagering experience may commence at any time after the beginning of a level.

In at least some HAWG Match-X Poker Game embodiments, the EGM may be configured or designed to automatically initiate one or more wager-based game event(s) (e.g., spin of slot reels) in response to the player's interactions with the Match-X Wagering Game playing field. In some HAWG Match-X Poker Game embodiments, one or more independent wagers may be placed on the Poker Hands which the player selects from the Match-X Wagering Game playing field, while concurrently, other wagers are automatically placed on the wager-based game event(s) which are automatically initiated by the system in response to the detection of one or more wager-based triggering events which, for example, are attributable to the player's interactions with the Match-X Wagering Game playing field.

### Match-X Wagering Game—Rewards/Winning

In at least some Match-X Wagering Game embodiments, every player's Match-X Wagering Game Poker Hand potentially has value. Sometimes, this value is awarded directly to the player when the Player's Poker Hand is established or identified. Other times, this value may be accumulated or stored for use at a later time, such as at the end of the level or after all available interactions have been made.

In some Match-X Wagering Game embodiments, the game design may dictate that the player must find a certain combination of Poker Hands in order to win. For example, the player makes a wager, is given 10 interactions with the playing field, and is expected to establish a Three-of-a-Kind, a Straight, a Flush and a Full House. In some embodiments, if the player requires fewer than the prescribed number of interactions, the player is awarded a greater value than if he uses all of the prescribed interactions. In some embodiments, if the player is not able to find the required Poker Hands within the prescribed number of interactions, the player would not receive any reward. In some embodiments, if the player found some, but not all, of the required Poker Hands, he would receive some portion of the value awarded for finding all of the required Poker Hands.

In some Match-X Wagering Game embodiments, the Match-X Wagering Game software may dictate that the player may be given a specific amount of time to make either a fixed number of interactions, or alternatively, an unlimited number of interactions. When the given time has elapsed, the Player's Poker Hands established by the player during the allotted time are evaluated and a prize/payout is awarded. In some embodiments, the prize may be a simple sum of the individual values assigned to each Player's Poker Hand. In other embodiments, the prize may be some function of, or otherwise algorithmically determined by, the Player's Poker Hands that were established.

Game design decisions may play a significant role in determining the value of the various Poker Hands. For example, in the example 5×5 grid of cards (e.g., shown in FIG. 17), a first Match-X Wagering Game design (Design 1) may specify that all of the 25 positions of the grid contain cards, and the player may connect cards horizontally, vertically and diagonally. Alternatively, a second Match-X Wagering Game design (Design 2) may specify that the center position of the 5×5 grid cannot contain a card (e.g., as illustrated in FIG. 24), and that the player may only connect cards horizontally and vertically. It may be considerably easier to identify Poker Hands in Design 1 than in Design 2. By way of example, this may result in a “Straight” in Design 1 being worth 5 times the wager, while a “Straight” in Design 2 being worth 10 times the wager.

### Match-X Wagering Game—Example Levels and Game Designs

Level 1
In this level of a Match-X Wagering Game embodiment, the player may expect to be able to find Poker Hands easily and often.
Grid Size: 6×6
Prohibited Cells: None
Interaction Mode: Select 5 neighboring cards
Neighboring Cards: Horizontal, Vertical, Diagonal
Wagering Mode: Wager 50 credits at the beginning of the level, Select 10 Poker Hands
Reward Mode: Each Player's Poker Hand is evaluated and its value is awarded immediately
Paytable:
Royal Flush=50 credits
Straight Flush=25 credits
Four of a Kind=10 credits
Full House=5 credits
Flush=2 credits
Straight=2 credits

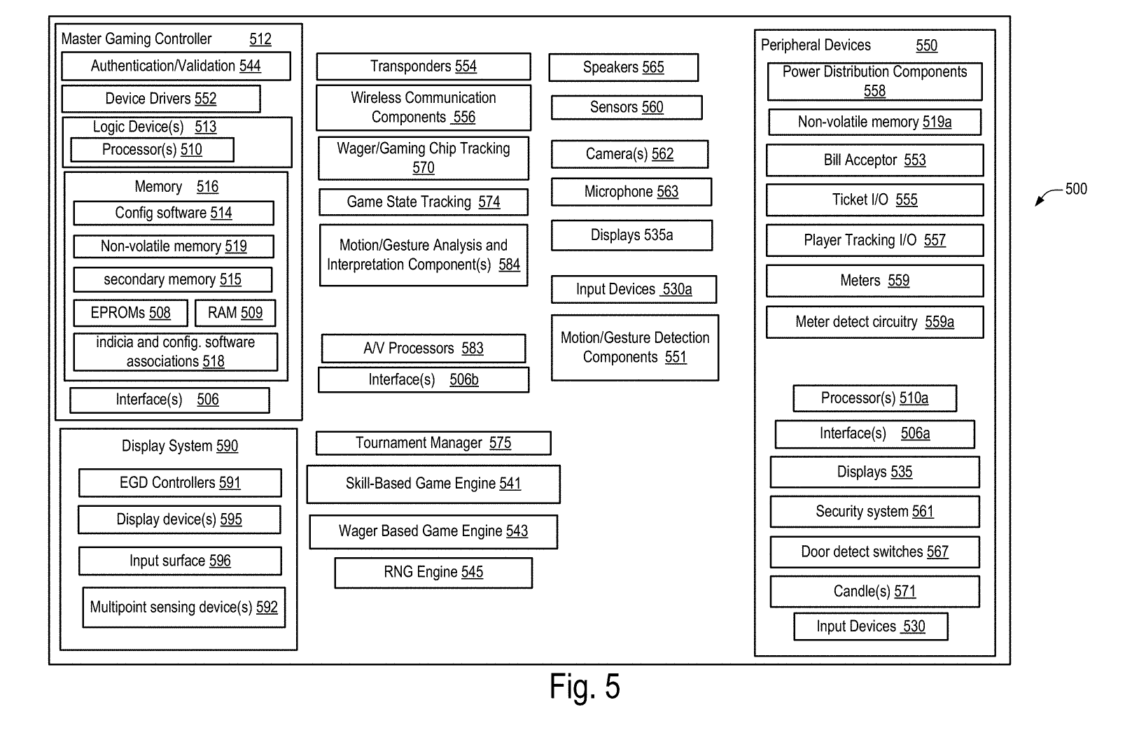

In some Match-X Wagering Game embodiments, the Match-X Wagering Game may be implemented at a regulatory approved wager-based electronic gaming machine (EGM) such as that illustrated and described with respect to FIG. 5. In at least some embodiments, such EGMs may be deployed at a gaming floor of a Casino, and may include functionality including, for example:
a first display;
a first input device;
a first bill or ticket acceptor;
componentry for enabling a player to engage in interactive game play of a wager-based game at the EGM;
componentry for establishing an account balance using at least a portion of cash or credit received via the first bill or ticket acceptor;
componentry for automatically funding an amount wagered on a wager-based game event using the account balance; a
etc.

### Definitions

In at least some embodiments, the meanings or definitions of various words, terms, or phrases described herein may include, but are not limited to, one or more of the following:

CREDIT—In at least one embodiment, a Credit refers to the basic unit of currency. A Wager may be some number of Credits (e.g. 10 Credits) and a Win may be some number of Credits. Each Credit may correspond to some amount of real-world monetary currency, such as U.S. Dollars or Euros. This amount may be fractional (e.g. $0.05, or 5 cents) or it may be a multiple (e.g. 5 Euros). The amount may also be representative of virtual currency (e.g. Bitcoin).

CARD—One of the classically recognized cards in a standard Poker deck (e.g. 2-10, J, Q, K, A each with a suit-Clubs, Spades, Hearts or Diamonds) or any other color, symbol, icon, glyph, indicator or shape, either alone or in combination with other color(s), symbol(s), icon(s), glyph(s), indicator(s) or shape(s), that have been associated with each other in some visual manner, such as by placement on a background or template. For example, one of a “Joker”, a “Red Joker” & a “Blue Joker”, an “11 of Bricks”, a “Purple Cat”, etc. placed on a rectangular background colored white or a circular template with a watermark that is the image of a forest.

POKER HAND—One of the classically recognized type of hands of the game of Poker (e.g. Pair, Straight, Flush, Full House, etc.) or any other combination of cards that can be recognized using an algorithm (e.g. a “Skip Straight” may be defined by example as 2-4-6-8-10, or a “Short Straight” may be defined using the rules for a Straight, but only requiring 4 instead of 5 cards). In at least some embodiments, a Poker Hand is a specifically defined pattern of cards. In at least some embodiments, no Poker Hand may be defined such that it must consist entirely of identical cards.

DECK—One of: (a) The classically recognized set of 52 classically recognized Poker cards (2-10, J, Q, K, A each of a suit-Clubs, Spades, Hearts, Diamonds); (b) A generalized set of cards (as defined above) whereby each card occurs zero or more times in the set; (c) Multiple identical copies of said sets {(a) or (b)} of cards (e.g. multi-deck, double deck, etc); (d) A stream of randomly generated cards from the set of available cards, each of which may or may not have already been “dealt” (removed) from the deck.

The ordering of the cards dictates which card may be next dealt from the deck. In an illustrative embodiment, the cards in the deck may be randomly ordered. However, in other embodiments the cards may have a predictable and/or predefined order. Using a software-based random number generator may result in either ordering, depending on the point of view of the assessment, and is anticipated by this invention.

Shuffling the deck is the process of changing the order of the cards in the deck, or otherwise applying some algorithm to the ordering of the cards in the deck such that expected outcome is that the order of the cards may change.

Except in the case of (d), a typical deck may contain a finite number of cards. Typically, once a card is removed from the deck, that card may not be dealt again until the deck is shuffled. However, this invention anticipates that some embodiments may implement a deck whereby a specific card is somehow re-introduced into the deck after it has been dealt, but before the deck has been shuffled.

It is not necessary to maintain an explicit ordering of the cards in the deck within any software memory. In software, one may implement said deck as a simple set of cards whereby one gets randomly chosen when a card must be dealt.

GAME DESIGN—Game Design refers to the combination of hardware and/or software components which define and embody the specific rules, parameters, variables, processes, and configurations of a game. For instance, one game design may specify that the minimum number of tiles that must match in a Match-X game is 3, while a different game design may specify that this minimum is 4. One game design may specify that all wagers must be exactly 1 credit, while another game design may specify that the player may select a wager amount between 1 and 20 credits. One game design may specify that a Straight pays 5 times the wager, while another game design may specify that the same Straight pays 10 times the wager. One game design may specify that a player's interaction with the game must result in two tiles swapping position, while another game design may specify that the player's interaction with the game must result in a Poker Hand being identified or selected which meets (or exceeds) specific minimum criteria.

### Reduction of Latency

### Predetermined RNG Outcome Batch Retrieval Functionality

Because the occurrence of lag is undesirable in wager-based gaming, it has heretofore been desirable to configure or design wager-based games in a manner which avoids or minimizes the introduction of lag in wager-based game play. For example, since communication latency is one factor which may significantly contribute to the introduction of lag in wager-based game play, it is generally desirable to configure or design wager-based games in a manner which avoids or minimizes the need for the wager-based game to remotely communicate with external systems/services to retrieve game event outcome data and/or wager event outcome data. Accordingly, conventional wisdom suggests that it may be preferable for the design of RNG wager-based games (e.g., such as video slot games, etc.) to include a local RNG Engine to provide localized access to wager event outcome data/results, so as to avoid the need for the wager-based game to remotely communicate with external systems/services to retrieve the wager event outcome data/results. Such traditional wager-based game design techniques have, in the past, proved to be sufficiently adequate with respect to minimizing the occurrence of lag in electronic wager-based games (such as, for example, video slot games, video poker games, etc.).

However, with the introduction of next-generation wager-based games such as, for example, the various hybrid skill-based/wager-based game types described herein, there is an increased risk of lag occurring during skill-based gameplay and/or wager-based gameplay. Occurrences of such lag may be attributable to a number of different factors, including, for example, the “stressing” of local system resources, communication latency, etc. For example, during game play, multiple calls, checks, interactions, NPC spawning, and/or other activities may all occur within the same few milliseconds, causing the gaming system resources to be “stressed”, and resulting in lag. Similarly, in wager-based games where multiple wager-based game events may occur within a relatively short time frame (e.g., substantially simultaneously, within several milliseconds, etc.) lag may occur as a result of the RNG Engine being unable to generate real-time RNG outcomes fast enough. Another factor which may also contribute to lag is communication latency, which, for example, may be caused by delays in communicating with remote devices/servers.

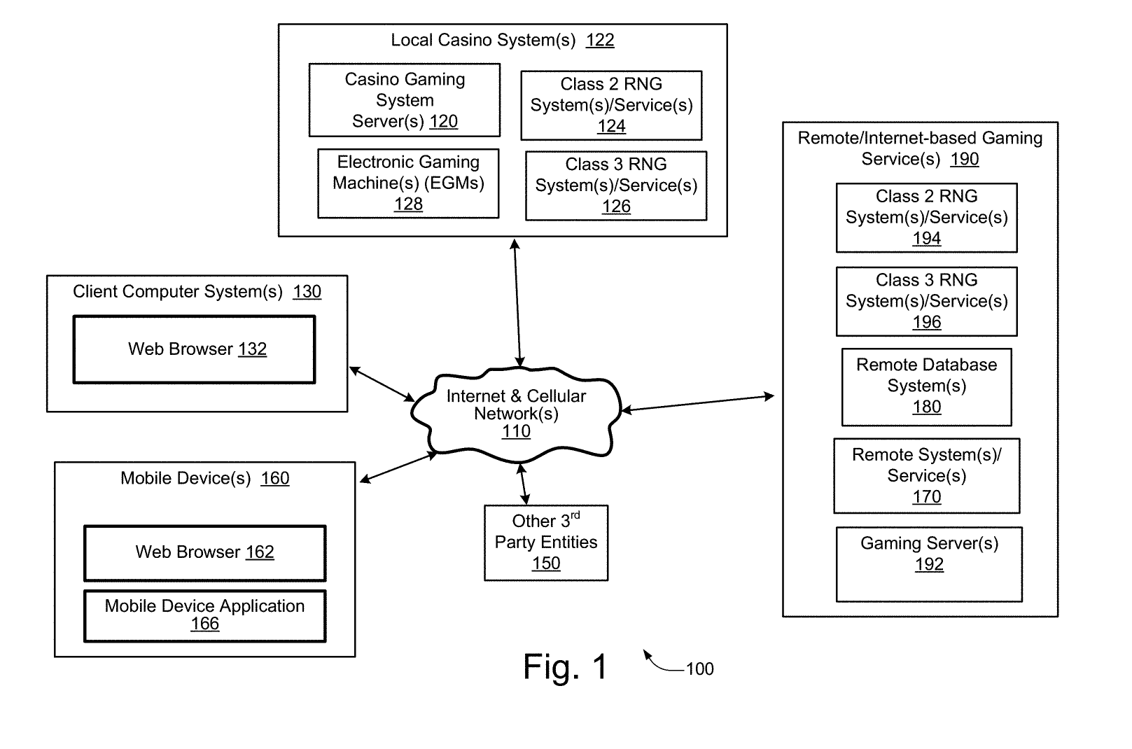

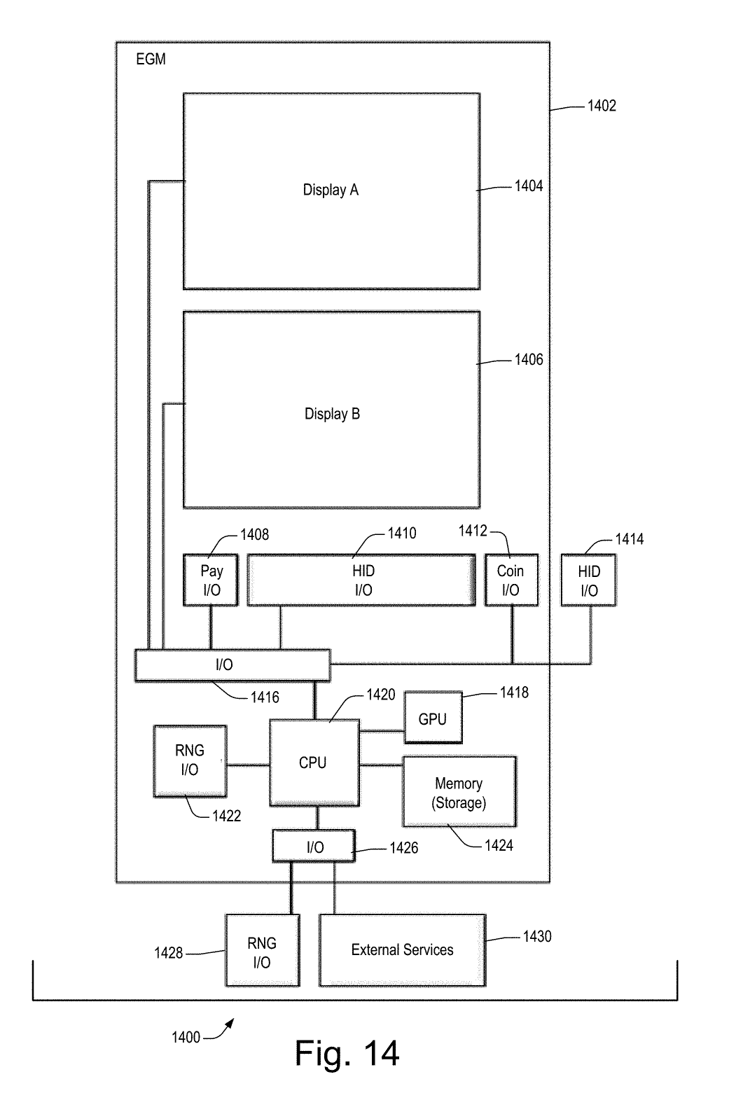

According to different embodiments, RNG I/O component(s) (e.g., 1422, 1428, FIG. 14) may include Class 3-type RNG I/O component(s) and/or Class 2-type RNG I/O component(s). In the event of a wager-based triggering event (e.g., initiated via player HID), a series of calls/checks may be automatically performed by the EGM to access at least one local and/or remote RNG server/service, such as, for example, one or more of the following (or combinations thereof):
Local Casino Class 2 RNG System(s)/Service(s) (e.g., 124, FIG. 1);
Local Casino Class 3 RNG System(s)/Service(s) (e.g., 126, FIG. 1);
Remote Class 2 RNG System(s)/Service(s) (e.g., 194, FIG. 1);
Remote Class 3 RNG System(s)/Service(s) (e.g., 196, FIG. 1);
Etc.

In order to minimize the occurrence of lag in hybrid skill-based/wager-based games, it is preferable to consider and develop new/novel wager-based game design techniques which are capable of supporting real-time play of such hybrid skill-based/wager-based games in a manner which does not result in the gaming system resources being overly “stressed”. One such design technique, as discussed previously, is to configure or design a hybrid skill-based/wager-based game to automatically and/or dynamically access or retrieve, before the triggering of one or more future wager-based game events, one or more “batches” or “pools” of predetermined RNG outcomes from local and/or remote RNG server(s)/service(s). Such a technique enables more intense gambling intervals to occur at the hybrid skill-based/wager-based game without “stressing” the system and/or without causing the occurrence of “lag” (e.g., delay and/or a drop in frames per second) in game play and/or wager-based gaming events.

For example, in at least one embodiment where an EGM is configured to host Match-X Wagering Game play, the EGM may be configured or designed to automatically and/or dynamically access or retrieve one or more “batches” or “pools” of predetermined RNG outcomes from one or more local and/or remote RNG server(s)/service(s), which, in turn, enables more intense gambling intervals to occur at the hybrid skill-based/wager-based game without “stressing” the system and/or without causing the occurrence of “lag” (e.g., delay and/or a drop in frames per second) in game play and/or wager-based gaming events.

Similarly, in at least some embodiments, a hybrid skill-based/wager-based game (and/or EGM on which the HAWG game is hosted) may be configured or designed to automatically and/or dynamically retrieve or “grab” predetermined RNG outcomes (and/or other data) from remote RNG server(s)/service(s) (and/or other remote systems/services) prior to extreme HAWG gameplay intervals, which may then allow the system to handle all current and future operations (e.g., including during extreme HAWG gameplay intervals) while avoiding the possibility of lag interfering with real-time gameplay and/or real-time wager-based events. Further, in at least one embodiment, at least a portion of the retrieved data may be encrypted (e.g., during communication and/or while stored in memory) in a manner which conforms with desired or imposed security regulations/standards.

By way of illustration, in one example embodiment of a HAWG Match-X Poker Game, it may be assumed that a specific game-level may allow the player to select up to 20 different poker hands, which may result in 20 different wager-based spins of the slot reels (e.g., 1522, FIG. 15). Using this information, the HAWG Match-X Poker Game may cause the EGM to automatically and/or dynamically retrieve one or more “batches” or “pools” of predetermined RNG outcomes (e.g., totaling 20 predetermined RNG outcomes) from one or more local and/or remote RNG server(s)/service(s). According to different embodiments:
At least one “batch retrieval” of predetermined RNG outcomes may be called before gameplay setup.
At least one “batch retrieval” of predetermined RNG outcomes may be called after gameplay setup.
At least one “batch retrieval” of predetermined RNG outcomes may be called before wager placement.
At least one “batch retrieval” of predetermined RNG outcomes may be called after wager placement, yet before wager-based game event occurs.
At least one “batch retrieval” of predetermined RNG outcomes may be called before new or additional cards are dealt to the HAWG Match-X Poker Game playing field.
At least one “batch retrieval” of predetermined RNG outcomes may be called after new or additional cards are dealt to the HAWG Match-X Poker Game playing field, but before enabling the player to proceed with gameplay at the specific game-level area.
Etc.

In at least one embodiment, the 20 retrieved predetermined RNG outcomes may be stored in encrypted form in local EGM memory. According to different embodiments, each (or selected ones) of the retrieved predetermined RNG outcomes may be randomly linked to a respectively different type of Poker Hand (e.g., Pair, Straight, Flush, Full House, etc.) which may be selected or identified in the playing field (thereby also effecting doubling randomization). Alternatively, in at least some embodiments, each (or selected ones) of the retrieved predetermined RNG outcomes may be sequentially linked to a respectively different type of Poker Hand.

According to different embodiments, the “batch retrieval” of predetermined RNG outcomes may apply to both Class 2 type hybrid skill-based/wager-based games and/or Class 3 type hybrid skill-based/wager-based games.

In at least one embodiment, the RNG server(s)/service(s) may be configured or designed to record or log the predetermined RNG outcomes which are retrieved by each requesting entity. Such records may subsequently be used for auditing purposes (e.g., to ensure that the wager-based game event outcomes at the EGM match the predetermined RNG outcomes provided by the RNG server(s)/service(s)) and for detecting and preventing cheating/fraud.

Further, according to some embodiments, different techniques may be employed for handling “unused” predetermined RNG outcomes which may occur, for example, when a player stops playing (or stops participating in) a hybrid skill-based/wager-based game. For example, in one embodiment, when a player chooses to disengage from participating in the HAWG Match-X Poker Game, any “unused” predetermined RNG outcomes may be automatically and dynamically discarded/deleted.

In at least some embodiments, “unused” predetermined RNG outcomes may also occur during gameplay, such as, for example, when a player finishes a level of a HAWG Match-X Poker Game without destroying all Zombies on that particular level. Accordingly, in at least some embodiments, the EGM may be configured or designed to periodically and automatically identify and delete selected “unused” predetermined RNG outcomes which are associated with “obsolete” wager-based triggering events (e.g., wager-based triggering events which no longer have any possibility of being initiated in the currently active gaming session). For example, if it is assumed that a player completes (or exits) a level of a HAWG Match-X Poker Game, and fails to claim all possible poker hands which are available to be claimed in that level, the EGM may be configured or designed to automatically identify and discard the “unused” predetermined RNG outcomes which are associated with the unclaimed poker hands.

In at least some embodiments, it is preferable to treat the predetermined RNG outcomes as highly confidential data. Accordingly, appropriate security measures should preferably be employed with respect to the generation, transmission and storage of the predetermined RNG outcome data. Examples of such security measures may include, but are not limited to, one or more of the following (or combinations thereof):
Encryption of the predetermined RNG outcome data during transmission.
Encryption of the predetermined RNG outcome data in memory storage.
Assigning respective expiration time limits to each of the predetermined RNG outcomes. In at least one embodiment, if an expiration time limit of a given predetermined RNG outcome may be exceeded (e.g., time limit expired), that specific predetermined RNG outcome may automatically be discarded by the system and is prevented from being used to determine a wager-based game event outcome. Examples of different expiration time limits may range from about 30 seconds to 60 minutes. In one preferred embodiment, an expiration time limit may be set to about 3 minutes.
And/or imposition of other jurisdiction/regulatory security methods to prevent cheating (e.g., similar to those currently employed at video slot machines and/or other wager-based gaming machines).

In at least one embodiment, the relatively high level of security measures implemented with respect to the generation, acquisition and storage of predetermined RNG outcomes may provide an added benefit of enabling at least a portion of the predetermined RNG outcomes to be retrieved (e.g., individually and/or in batches) from one or more remote RNG server(s)/service(s) (e.g., Class 2 RNG System(s)/Service(s) 194 and/or Class 3 RNG System(s)/Service(s) 196, FIG. 1). This, in turn, may help facilitate and/or enable online wager-based gaming using pre-determined RNG outcomes.

Additionally, according to different embodiments, the various predetermined RNG outcome techniques described herein may also be utilized in larger, more well-known online games for enabling wager-based triggering event functionality, and for enabling wager-based events to occur concurrently during standard (e.g., at home/mobile, skill-based) gameplay.

It is noted that many of the example embodiments described herein are focused on HAWG designs, as well as other popular video game designs. However, the predetermined RNG outcome batch retrieval techniques described herein may also be applied to other types of games and gaming platforms, including, for example, one or more of the following (or combinations thereof):
Currently existing wager-based games (e.g., implemented at casino EGMs) such as, for example:
   Video slot games.
   Other types of wager-based video games such as, poker, bingo, keno, pachinko, dice, cards, wheel games, etc.
Wager-based games implemented on mobile devices.
Wager-based games implemented via the Internet or other gaming networks.
MMO games implemented via the Internet or other gaming networks.
Video console games such as, for example XBOX™, PlayStation™, Nintendo™, etc.
Cloud-based gaming system(s)/service(s).
Other types of video-based games/gaming systems which utilize RNG engines and include functionality for communicating via a secure/encrypted networks.

For example, in at least one embodiment, an online video slot game (or other styled game) may be configured or designed to include predetermined RNG outcome batch retrieval functionality. A player may access the online video slot game via the Internet, and fund the game in a manner similar to that of standard wager-based play (e.g., as implemented at casino EGMs). Thereafter, the predetermined RNG outcome batch retrieval process(es) may be called.

In some embodiments, the wager-based video slot game may be hosted at video slot game EGM remotely located at a casino property. In other embodiments, the wager-based video slot game may be implemented at a local gaming device in the possession of the player (such as, for example, a mobile gaming device, or a video slot game app running on the player's smartphone). In at least some embodiments, the wager-based game events occurring in the video slot game are based on predetermined RNG outcomes which are securely retrieved from authenticated and trusted remote RNG server(s)/service(s). In yet other embodiments, the wager-based video slot game may be hosted at a virtual casino or cloud-based gaming system such as, for example, Remote/Internet-based Gaming Service(s) system 140.

As discussed above, in at least some embodiments, the each of the retrieved predetermined RNG outcomes has associated therewith a respective expiration time limit (or expiration time value). In at least one embodiment, if an expiration time limit of a given predetermined RNG outcome may be exceeded (e.g., time limit expired), that specific predetermined RNG outcome may automatically be discarded by the system and may be prevented from being used in determining a wager-based game event outcomes.

By way of illustration, in one example scenario involving a player playing a wager-based video slot game which may be configured or designed to include predetermined RNG outcome batch retrieval functionality, it is initially assumed that the video slot game executes a call to retrieve an initial batch of ten (10) predetermined RNG outcomes. In this example scenario, it is further assumed that the player decides to initiate three (3) “spins”, and then elects to temporarily stop (or pause) playing the video slot game without exiting or ending the game (e.g., in order to allow the player to have a short break). In this example scenario, only three (3) of the retrieved predetermined RNG outcomes would have been used, while the remaining seven (7) retrieved predetermined RNG outcomes would still be “unused”. Continuing with this example scenario, it is assumed that the length of the player's break exceeds the expiration time limits associated with each of the seven (7) “unused” predetermined RNG outcomes. Accordingly, the gaming system may respond by automatically discarding or invalidating the seven (7) “unused” predetermined RNG outcomes upon detecting that their respective expiration time limits have been exceeded. Additionally, the gaming system may automatically retrieve a new batch of seven (7) pre-determined RNG outcomes (e.g., from a remote, authenticated RNG system/service) after detecting that the user has resumed play of the video slot game.

It may be appreciated that the predetermined RNG outcome batch retrieval technique(s) described herein provide numerous benefits and advantages which may be leveraged to expand existing wager-based gaming markets (including, for example, home, mobile, casino, and cloud based markets), and to open up opportunities for new markets to develop in the wager-based gaming space. Further, the predetermined RNG outcome batch retrieval technique(s) described herein may also be leveraged to enable players to continue engaging in their favorite gambling games anywhere/anytime, and/or to embark on new types of wager-based games anywhere/anytime.

For example, various benefits and/or advantages of the predetermined RNG outcome batch retrieval technique(s) described herein may include, but are not limited to, one or more of the following (or combinations thereof):
Secure/encrypted wager-based interactions.
Prevents/hampers cheating.
Stored predetermined RNG outcomes allow for more graphically intense gambling intervals, which may translate to (and/or facilitate):
   More “butts in seats” (e.g., particularly with respect to players participating from the comfort of their own home);
   Increased coin-in;
   Improved relationships between patron, game, and property;
   Improved or increased player satisfaction.

Additionally, because the wager-based game events are based on predetermined RNG outcomes which may be securely retrieved from authenticated and trusted remote RNG server(s)/service(s), the predetermined RNG outcome batch retrieval technique(s) described herein enable a secure way for players to engage in wager-based gameplay from their homes and/or from other non-casino locations. For example, in at least one embodiment, using the predetermined RNG outcome batch retrieval technique(s) described herein, a player may engage in wager-based game play at his or her favorite casino property, then leave the casino property, and then continue or resume their gaming experience from a different physical location (e.g., from the player's home via online access). In at least some embodiments, the player (or player's mobile gaming device) may continue to be “in touch” with the casino property (e.g., in the “network” sense rather than the “physical” sense). This may also tie into “clicks to bricks” programs/offers which may allow patrons to acquire club points in the comfort of their homes with on-site voucher/redemption (e.g., from casino, to home, back to casino, to home). This “revolving process” is something the gambling industry has heretofore been lacking. However, by using the predetermined RNG outcome batch retrieval technique(s) described herein, the patron's home and personal network device(s) are now accessible for secure wager-based gameplay.

Similarly, the predetermined RNG outcome batch retrieval technique(s) described herein enable a secure way for players to engage in cloud-based, wager-based gameplay. This feature may be particularly desirable for players who do not care for the casino establishment environment. By utilizing a cloud-based system and/or virtual casino environment, players may engage in (similar) wager-based gameplay without the worries of having to go to a casino. In some embodiments, a virtual or cloud-based casino system may be implemented via Remote/Internet-based Gaming Service(s) system 190 of FIG. 1. According to different embodiments, some or all of the systems and processes that coincide with wager-based gameplay may be implemented within this virtual environment. A patron (e.g., player), when gaming on a “cloud only” system, may initiate wager-based events (e.g., as described previously), and the wager-based game may communicate (e.g., via secured/encrypted network communications) to the Remote/Internet-based Gaming Service(s) system 190, which in turn may communicate back to the patron's device(s). Outgoing and incoming communications may be transmitted at the same time and/or in irregular patterns. Communications such as these are known as “asynchronous communications.”

In at least some embodiments, additional security mechanisms may be utilized with respect to retrieved predetermined RNG outcomes from remote RNG servers/services. For example, it is preferable to secure the retrieved RNG information from server to client, and vice versa. Security may be supported in multiple forms, such as, for example, MDS, hash, unique identifiers, etc. All of which may perform or be verified via cross-checking and/or reporting with a host, in order to validate and/or verify determine the authenticity of such secured information and/or in order to authenticate the identity of the remote RNG servers/services. Such security mechanisms may be used to help prevent fraudulent activities, such as, for example, activities performed by individuals attempting to “hack” and “inject” their own RNG outcomes into the wager-based game system in order to manipulate the system.

In at least one embodiment, each retrieved predetermined RNG outcome may be configured or designed to include one or more unique identifier(s) which may be used to for security validation and/or authentication purposes. In some embodiments, specific authentications of the retrieved predetermined RNG outcomes may be required to be performed, for example, during the verification process(es) of batch RNG retrieval and/or before using any one of the predetermined RNG outcomes to determine wager-based game event outcomes. “Hacked” RNG outcomes which have been injected into the gaming system may not pass the security checks from the authentication system. For example, even though the RNG outcome itself may be in a “correct” format for the system internals, the “signature” may not match. In at least some embodiments, the unique identifier(s) associated with each of the predetermined RNG outcomes may be securely encrypted using an encryption algorithm, and the gaming device (which is hosting the wager-based game) may include automated functionality for authenticating the encrypted unique identifier associated with a given predetermined RNG outcome before using that predetermined RNG outcome for determining a wager-based game event outcome. In the event that tampering evidence is detected, the system may have cross-checks and/or calls that may immediately notify the proper personnel in order to seek appropriate measures.

### Example Random Number Generator (RNG) Embodiment(s)

According to different embodiments, one or more different types of RNG engines may be utilized to generate random numbers, game event outcome(s), and/or wager event outcome(s). For example, in at least one embodiment, an RNG engine may be implemented using a standard Mersenne Twister algorithm.

### Initializing and Seeding

Upon initialization of the RNG engine, it may generate a seed value based on values of several different parameters, such as, for example:
Current time in milliseconds,
Process ID of the current process,
The address of the current time variable, and
The last seed value used.

After generating all of the variables, they are all multiplied by the last seed value. An XOR operator is applied to the current time variable, with a variable based on the bits for the current time shifted to the right by 11. In at least one embodiment, the seed value is determined by using an XOR operator to combine all four of the variables.

### Background Generation

After initialization the RNG engine may start generating numbers on a separate thread. This thread may be constantly running in the background resulting in millions of numbers being discarded per second.

### Generating RNG Number(s)

When a component of the hybrid skill-based/wager-based game requests a random number, it may call the GetRandomNumberRange function one or more times (e.g., depending on the number of reels). For example, for a 3 reel slot game, the GetRandomNumberRange function may be called three (3) times (e.g., 1 RNG call per reel).

In some hybrid skill-based/wager-based game embodiments, one or more calls to the RNG engine may occur each time new cards are dealt to the playing field. For example, in a hybrid skill-based/wager-based game which uses a 3 reel virtual slot game to implement wager-based game events, three separate GetRandomNumberRange function calls may be made to the RNG engine to obtain 3 different random numbers, which represent a predetermined outcome of the wager-based 3-reel slot game event which may be initiated if/when a specific type of poker hand is identified or selected in the HAWG Match-X Poker Game playing field.

In at least one embodiment, the GetRandomNumberRange function may utilize 2 parameters representing, for example, a minimum value (e.g., zero) and a maximum value (e.g., 255). When the number is generated by the RNG engine, it may need to be scaled to fit inside the minimum and maximum values. In one embodiment, the value of each generated RNG number may be automatically scaled by performing one or more of the following operations (or combinations thereof):
Increase the maximum value by 1 so when we mod it later we can achieve the maximum number.
Set the limit of the number to equal the difference between the min and max. This may represent how many numbers we can generate.
Use integer division to get the largest number that our limit may mod evenly into our RNG's Maximum number.
Generate a number from the RNG engine.
Check to see if the number is larger than our mod evenly number. If we don't do this, then a lower number has the potential to show more often than higher numbers generated by the RNG engine generator. Comparing it to a large evenly modded number may help ensure that each number has the same chance of being called by disregarding the numbers that are higher than this.
If the number is larger than our mod evenly number, we discard it and generate another number.
Repeat operations 5 and 6 (above) until a number is found/identified.
Mod the identified number generated by our limit, and add the minimum amount to it. This may give us the final RNG number.

In at least one embodiment, the random numbers that are retrieved or generated in connection with the HAWG Match-X Poker Game, are securely encrypted and linked to respectively different wager-based triggering events/conditions which may occur during game play in the skill-based portion of the HAWG Match-X Poker Game. This information is then stored in local memory of the EGM, preferably in non-volatile RAM.

If/when the occurrence of a specific wager-based triggering event is detected, the system identifies the specific wager-based triggering event (e.g., player selects cards corresponding to a Flush poker hand), and uses this information to access, decrypt, and use the 3 stored RNG numbers to check the positions of each reel. These positions are then compared to a math model to get the award value. Thereafter, assuming no errors detected, the award value and reels are displayed for the user to see.

FIG. 1 illustrates a simplified block diagram of a specific example embodiment of a hybrid skill-based/wager-based (e.g., “HAWG”) Gaming System 100 which may be implemented via a computerized data network. As described in greater detail herein, different embodiments of hybrid skill-based/wager-based Gaming Systems may be configured, designed, and/or operable to provide various different types of operations, functionalities, and/or features generally relating to hybrid skill-based/wager-based Gaming System technology. Further, as described in greater detail herein, many of the various operations, functionalities, and/or features of the hybrid skill-based/wager-based Gaming System(s) disclosed herein may provide may enable or provide different types of advantages and/or benefits to different entities interacting with the hybrid skill-based/wager-based Gaming System(s).

According to different embodiments, at least some hybrid skill-based/wager-based Gaming System(s) may be configured, designed, and/or operable to provide a number of different advantages and/or benefits and/or may be operable to initiate, and/or enable various different types of operations, functionalities, and/or features, such as, for example, one or more of those described and/or referenced herein. According to different embodiments, at least a portion of the various functions, actions, operations, and activities performed by one or more component(s) of the hybrid skill-based/wager-based Gaming System may be initiated in response to detection of one or more conditions, events, and/or other criteria satisfying one or more different types of minimum threshold criteria, such as, for example, one or more of those described and/or referenced herein. According to different embodiments, at least a portion of the various types of functions, operations, actions, and/or other features provided by the hybrid skill-based/wager-based Gaming System may be implemented at one or more client systems(s), at one or more System Server(s), and/or combinations thereof. According to different embodiments, the hybrid skill-based/wager-based Gaming System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the hybrid skill-based/wager-based Gaming System may include one or more types of systems, components, devices, processes, etc. (e.g., or combinations thereof) described and/or referenced herein.

According to different embodiments, the hybrid skill-based/wager-based Gaming (e.g., HAWG) System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the hybrid skill-based/wager-based Gaming System may include one or more of the following types of systems, components, devices, processes, etc. (e.g., or combinations thereof):
Local Casino System(s) 122 operable to perform and/or implement various types of functions, operations, actions, and/or other features such as those described or referenced herein. According to different embodiments, one or more Local Casino System(s) 122 may include, but are not limited to, one or more of the following (or combinations thereof):
   Casino Gaming System Server(s) 120—In at least one embodiment, the Casino Gaming System Server(s) may be operable to perform and/or implement various types of functions, operations, actions, and/or other features such as those described or referenced herein.
   Class 2 RNG System(s)/Service(s) 124 operable to perform and/or implement various types of functions, operations, actions, and/or other features such as those described or referenced herein. For example, in at least some embodiments, Class 2 RNG System(s)/Service(s) 124 may be operable to dynamically generate and/or provide Class 2 gaming type RNG outcomes to be used by hybrid skill-based/wager-based Gaming devices as “predetermined” RNG outcome(s) relating to Class 2 type wager-based game event(s) occurring at the hybrid skill-based/wager-based Gaming devices.
   Class 3 RNG System(s)/Service(s) 126 operable to perform and/or implement various types of functions, operations, actions, and/or other features such as those described or referenced herein. For example, in at least some embodiments, Class 3 RNG System(s)/Service(s) 126 may be operable to dynamically generate and/or provide Class 3 gaming type RNG outcomes to be used by hybrid skill-based/wager-based Gaming devices as “predetermined” RNG outcome(s) relating to Class 3 type wager-based game event(s) occurring at the hybrid skill-based/wager-based Gaming devices.
   Electronic Gaming Machine(s) (EGMs) 128 operable to perform and/or implement various types of functions, operations, actions, and/or other features such as those described or referenced herein.
Other Gaming Network(s).
Client Computer System(s) 130 operable to perform and/or implement various types of functions, operations, actions, and/or other features such as those described or referenced herein.
3^{rd} Party System(s) 150 operable to perform and/or implement various types of functions, operations, actions, and/or other features such as those described or referenced herein.
Internet & Cellular Network(s) 110.
Remote/Internet-based Gaming Service(s) 190 operable to perform and/or implement various types of functions, operations, actions, and/or other features such as those described or referenced herein.
According to different embodiments, one or more Remote/Internet-based Gaming Service(s) 190 may include, but are not limited to, one or more of the following (or combinations thereof):
   Class 2 RNG System(s)/Service(s) 194 operable to perform and/or implement various types of functions, operations, actions, and/or other features such as those described or referenced herein. For example, in at least some embodiments, Class 2 RNG System(s)/Service(s) 194 may be operable to dynamically generate and/or provide Class 2 type RNG outcomes to be used by remote hybrid skill-based/wager-based Gaming devices as “predetermined” RNG outcome(s) relating to Class 2 type wager-based game event(s) occurring at the hybrid skill-based/wager-based Gaming devices.
   Class 3 RNG System(s)/Service(s) 196 operable to perform and/or implement various types of functions, operations, actions, and/or other features such as those described or referenced herein. For example, in at least some embodiments, Class 3 RNG System(s)/Service(s) 196 may be operable to dynamically generate and/or provide Class 3 type RNG outcomes to be used by remote hybrid skill-based/wager-based Gaming devices as “predetermined” RNG outcome(s) relating to Class 3 type wager-based game event(s) occurring at the hybrid skill-based/wager-based Gaming devices.
   Remote Database System(s) 180 operable to perform and/or implement various types of functions, operations, actions, and/or other features such as those described or referenced herein.
   Gaming Server(s) 192 operable to perform and/or implement various types of functions, operations, actions, and/or other features such as those described or referenced herein.
   Remote System(s)/Service(s) 170, which, for example, may include, but are not limited to, one or more of the following (e.g., or combinations thereof):
      Content provider servers/services
      Media Streaming servers/services
      Database storage/access/query servers/services
      Financial transaction servers/services
      Payment gateway servers/services
      Electronic commerce servers/services
      Event management/scheduling servers/services
      Etc.
Mobile Device(s) 160—In at least one embodiment, the Mobile Device(s) may be operable to perform and/or implement various types of functions, operations, actions, and/or other features such as those described or referenced herein.
Etc.

In at least one embodiment, the hybrid skill-based/wager-based Gaming System may be operable to utilize and/or generate various different types of data and/or other types of information when performing specific tasks and/or operations. This may include, for example, input data/information and/or output data/information. For example, in at least one embodiment, the hybrid skill-based/wager-based Gaming System may be operable to access, process, and/or otherwise utilize information from one or more different types of sources, such as, for example, one or more local and/or remote memories, devices and/or systems. Additionally, in at least one embodiment, the hybrid skill-based/wager-based Gaming System may be operable to generate one or more different types of output data/information, which, for example, may be stored in memory of one or more local and/or remote devices and/or systems. Examples of different types of input data/information and/or output data/information which may be accessed and/or utilized by the hybrid skill-based/wager-based Gaming System may include, but are not limited to, one or more of those described and/or referenced herein.

According to specific embodiments, multiple instances or threads of the hybrid skill-based/wager-based Gaming System may be concurrently implemented and/or initiated via the use of one or more processors and/or other combinations of hardware and/or hardware and software. For example, in at least some embodiments, various aspects, features, and/or functionalities of the hybrid skill-based/wager-based Gaming System may be performed, implemented and/or initiated by one or more of the various systems, components, systems, devices, procedures, processes, etc., described and/or referenced herein.

In at least one embodiment, a given instance of the hybrid skill-based/wager-based Gaming System may access and/or utilize information from one or more associated databases. In at least one embodiment, at least a portion of the database information may be accessed via communication with one or more local and/or remote memory devices. Examples of different types of data which may be accessed by the hybrid skill-based/wager-based Gaming System may include, but are not limited to, one or more of those described and/or referenced herein.

According to different embodiments, various different types of encryption/decryption techniques may be used to facilitate secure communications between devices in hybrid skill-based/wager-based Gaming System(s) and/or hybrid skill-based/wager-based Gaming Network(s). Examples of the various types of security techniques which may be used may include, but are not limited to, one or more of the following (e.g., or combinations thereof): random number generators, SHA-1 (e.g., Secured Hashing Algorithm), MD2, MDS, DES (e.g., Digital Encryption Standard), 3DES (e.g., Triple DES), RC4 (e.g., Rivest Cipher), ARC4 (e.g., related to RC4), TKIP (e.g., Temporal Key Integrity Protocol, uses RC4), AES (e.g., Advanced Encryption Standard), RSA, DSA, DH, NTRU, and ECC (e.g., elliptic curve cryptography), PKA (e.g., Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

According to different embodiments, one or more different threads or instances of the hybrid skill-based/wager-based Gaming System may be initiated in response to detection of one or more conditions or events satisfying one or more different types of minimum threshold criteria for triggering initiation of at least one instance of the hybrid skill-based/wager-based Gaming System. Various examples of conditions or events which may trigger initiation and/or implementation of one or more different threads or instances of the hybrid skill-based/wager-based Gaming System may include, but are not limited to, one or more of those described and/or referenced herein.

It may be appreciated that the hybrid skill-based/wager-based Gaming System of FIG. 1 is but one example from a wide range of hybrid skill-based/wager-based Gaming System embodiments which may be implemented. Other embodiments of the hybrid skill-based/wager-based Gaming System (e.g., not shown) may include additional, fewer and/or different components/features that those illustrated in the example hybrid skill-based/wager-based Gaming System embodiment of FIG. 1.

Generally, the hybrid skill-based/wager-based Gaming techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the hybrid skill-based/wager-based Gaming techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, system servers, cloud computing systems, network devices, etc.

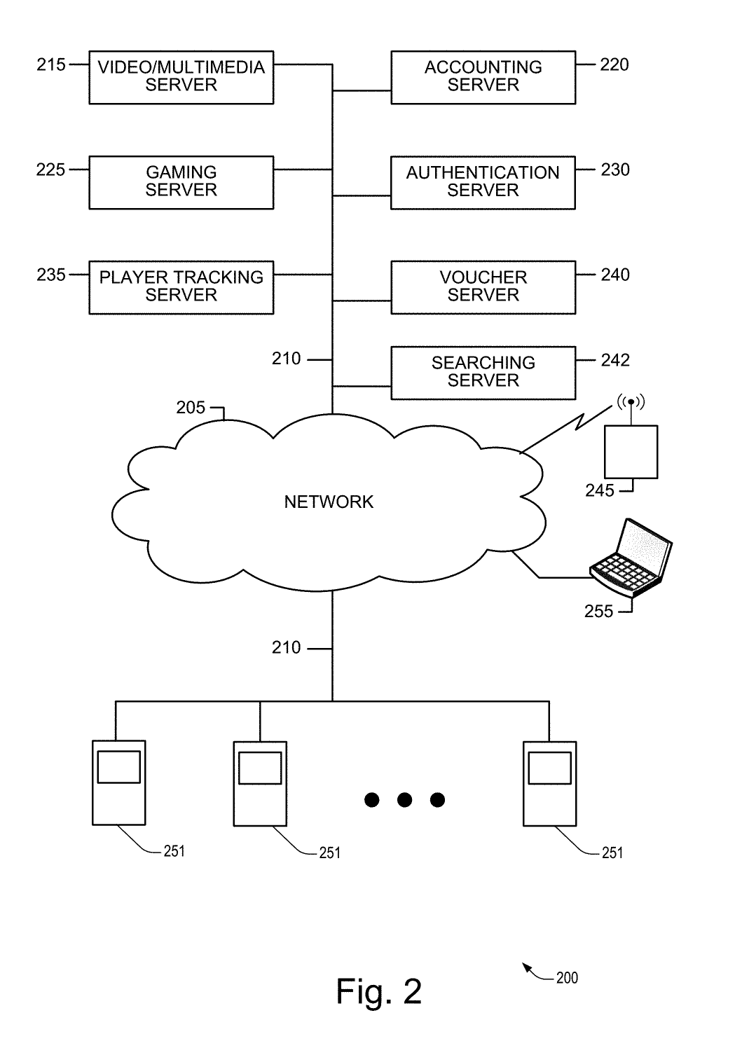

FIG. 2 shows an example block diagram of an electronic gaming system 200 in accordance with a specific embodiment. Electronic gaming system 200 may include electronic gaming devices (e.g., electronic gaming terminals, electronic gaming machines, wager-based video gaming machines, etc.) 251, which may be coupled to network 205 via a network link 210. Network 205 may be the internet or a private network. One or more video streams may be received at video/multimedia server 215 from EGDs 251. Video/Multimedia server 215 may transmit one or more of these video streams to one or more: mobile devices 245, 255, electronic gaming devices (e.g., EGD) 251, and/or other remote electronic device. Video/Multimedia server 215 may transmit these video streams via network link 210 and network 205.

Electronic gaming system 200 may include an accounting/transaction server 220, a gaming server 225, an authentication server 230, a player tracking server 235, a voucher server 240, and a searching server 242.

Accounting/transaction server 220 may compile, track, store, and/or monitor cash flows, voucher transactions, winning vouchers, losing vouchers, and/or other transaction data for the casino operator and for the players. Transaction data may include the number of wagers, the size of these wagers, the date and time for these wagers, the identity of the players making these wagers, and the frequency of the wagers. Accounting/transaction server 220 may generate tax information relating to these wagers. Accounting/transaction server 220 may generate profit/loss reports for predetermined gaming options, contingent gaming options, predetermined betting structures, and/or outcome categories.

Gaming server 225 may generate gaming options based on predetermined betting structures and/or outcome categories. These gaming options may be predetermined gaming options, contingent gaming options, and/or any other gaming option disclosed in this disclosure.

Authentication server 230 may determine the validity of vouchers, players' identity, and/or an outcome for a gaming event.

Player tracking server 235 may track a player's betting activity, a player's preferences (e.g., language, drinks, font, sound level, etc.). Based on data obtained by player tracking server 235, a player may be eligible for gaming rewards (e.g., free play), promotions, and/or other awards (e.g., complimentary food, drinks, lodging, concerts, etc.).

Voucher server 240 may generate a voucher, which may include data relating to gaming options. For example, data relating to the structure may be generated. If there is a time deadline, that information may be generated by voucher server 240. Vouchers may be physical (e.g., paper) or digital.

Searching server 242 may implement a search on one or more gaming devices to obtain gaming data. Searching server 242 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching server 242 may implement a wagering function, which may be an automatic wagering mechanism. These functions of searching server 242 may be integrated into one or more servers.

Searching server 242 may include one or more searching structures, one or more searching algorithms, and/or any other searching mechanisms. In general, the search structures may cover which hybrid skill-based/wager-based games paid out the most money during a time period, which hybrid skill-based/wager-based games kept the most money from players during a time period, which hybrid skill-based/wager-based games are most popular (e.g., top games), which hybrid skill-based/wager-based games are least popular, which hybrid skill-based/wager-based games have the most amount of money wager during a period, which hybrid skill-based/wager-based games have the highest wager volume, which hybrid skill-based/wager-based games are more volatile (e.g., volatility, or deviation from the statistical norms, of wager volume, wager amount, pay out, etc.) during a time period, and the like. Search may also be associated with location queries, time queries, and/or people queries.

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific game types and/or themes (e.g., first person shooter types, first person rail types, TV themes, Movie themes, multiplayer types, etc.). Searching structure may search one or more of these games.

In another example, the searching structure may be based on a player's preferences, past transactional history, player input, a particular game, a particular EGD, a particular casino, a particular location within a casino, game outcomes over a time period, payout over a time period, and/or any other criteria.

Searching algorithms may be dynamic searching programs, which may be modified based on one or more past results. In one example, the search algorithm may determine that a specific triggering event occurs with a ninety percent success rate on a first EGD, a ten percent success rate on a second EGD, a fifty percent success rate on a third EGD, and a seventy percent success rate on a fourth EGD. The search algorithm may generate a search priority based on the probability of success, which may lead to the first EGD being searched first, the fourth EGD being searched second, the third EGD being searched third, and the second EGD being searched fourth. Search algorithm may utilize any dynamic feedback procedure to enhance current and/or future searching results

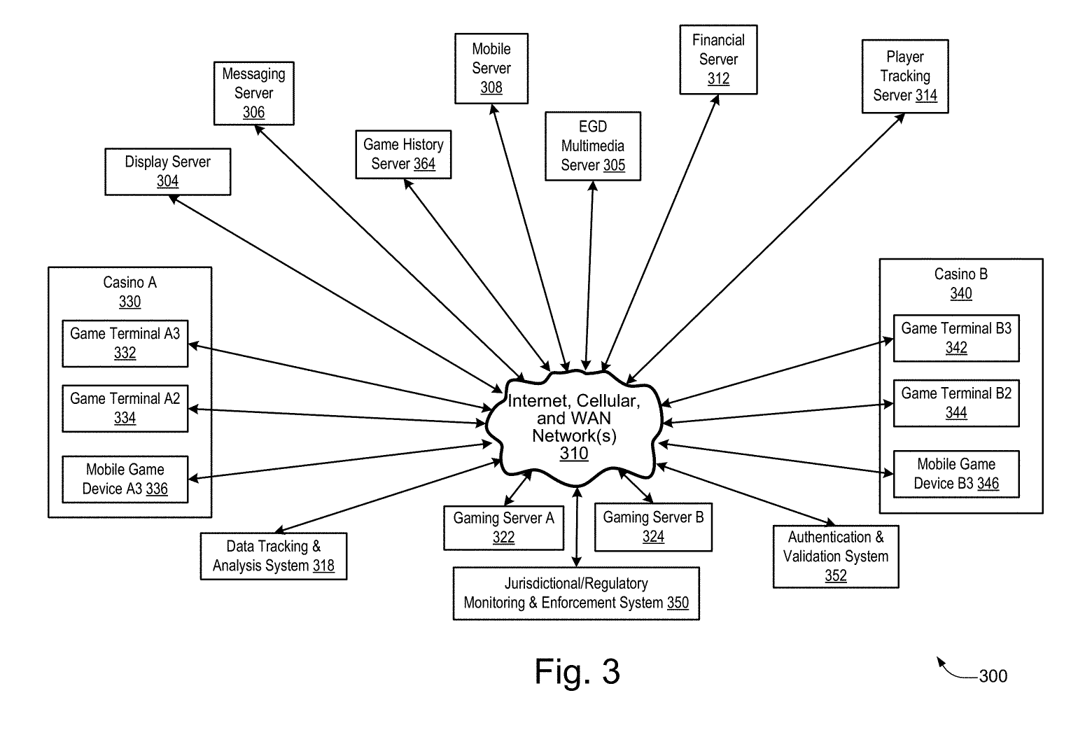

FIG. 3 illustrates a network diagram of an example embodiment of a Gaming Network 300 which may be configured or designed to implement various hybrid skill-based/wager-based gaming techniques described and/or referenced herein. As described in greater detail herein, different embodiments of Gaming Networks may be configured, designed, and/or operable to provide various different types of operations, functionalities, and/or features generally relating to Gaming Network technology. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, at least some Gaming Network(s) may be configured, designed, and/or operable to provide a number of different advantages and/or benefits and/or may be operable to initiate, and/or enable various different types of operations, functionalities, and/or features, such as, for example, one or more of the following (e.g., or combinations thereof):
Enable real-world casino venues to securely and legally provide opportunities for their players/players to participate in online or network-based wager-based gaming sessions. Examples of various types of games which may be played may include, but are not limited to, one or more hybrid skill-based/wager-based game(s) such as those described and/or referenced herein.
Enable casino venues to provide opportunities for their players/players to participate in live, multiplayer, wager-based, skill-based video games where players from different casinos, different locations, and/or different EGDs, are able to compete against one another in a multiplayer, hybrid skill-based/wager-based gaming environment. In at least one embodiment, players can be located at the same and/or at remote gaming venues that are connected via a wide area network such as the Internet, cellular networks, VPNs, cloud-based networks, etc.
Utilize live electronic gaming device dealers and attendants for conducting the wager-based, skill-based video games.
Deploy electronic gaming devices (e.g., EGDs) in multiple different physical casino venues, and utilize the EGDs for enabling casino players/players to participate in wager-based, skill-based video games.
Players may be allowed to manually switch or change their opponents (e.g., in heads-up game play).
Players may be automatically switched (e.g., by gaming system) to play different opponents (e.g., auto switching feature; useful for tournament play).
Gaming system may perform automated matching of players in tournament (e.g., based on various criteria such as, for example: skill level, experience, random, social relationships, etc.). In at least one embodiment, multi-property network connections between various different casino venues (e.g., located at different geographic locations) may be implemented and utilized to facilitate pairing of and/or participation by remote players.
In at least one embodiment, a central clearing house may be utilized for financial transactions (e.g., deposit, debit of player accounts, payouts, lines of credit, etc.) relating to the hybrid skill-based/wager-based game sessions.
Various types of game play rules may be implemented and automatically enforced for the hybrid skill-based/wager-based game sessions, such as, for example: time limit per play, amount per wager, max wager, maximum wager, rules to facilitate speed of game play, rules imposed for conformance with regulatory or jurisdiction requirements, etc. For example, in one embodiment, if a player failed to make a wager within an allotted time interval, the system may be configured or designed to automatically enter default wager for that player.

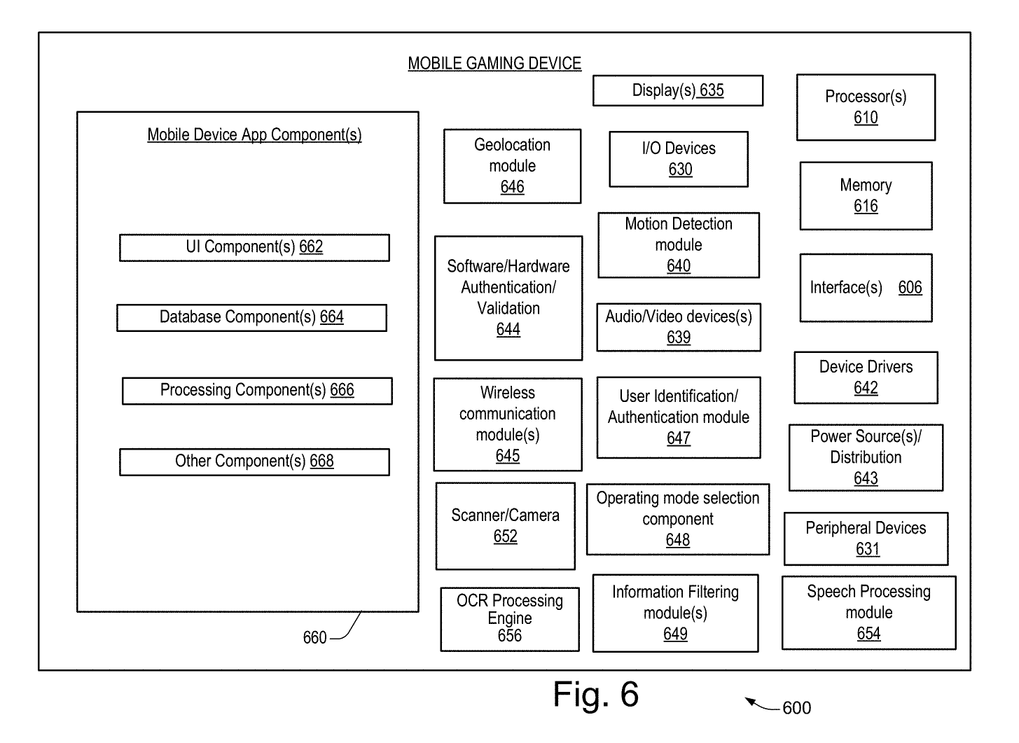

According to different embodiments, the Gaming Network 300 may include a plurality of different types of components, devices, modules, processes, systems, etc., which, for example, may be implemented and/or instantiated via the use of hardware and/or combinations of hardware and software. For example, as illustrated in the example embodiment of FIG. 3, the Gaming Network may include one or more of the following types of systems, components, devices, processes, etc. (e.g., or combinations thereof):
Display System Server(s) 304. In at least one embodiment, the Display System Server(s) may be configured or designed to implement and/or facilitate management of content (e.g., graphics, images, text, video fees, etc.) to be displayed and/or presented at one or more EGDs (e.g., or at one or more groups of EGDs), dealer displays, administrator displays, etc.
EGD Multimedia System Server(s) 305. In at least one embodiment, the Table Multimedia System Server(s) may be configured or designed to generate, implement and/or facilitate management of content (e.g., graphics, images, text, video fees, audio feeds, etc.), which, for example, is to be streamed or provided to one or more EGDs (e.g., or to one or more groups of EGDs).
Messaging System Server(s) 306. In at least one embodiment, the Messaging System Server(s) may be configured or designed to implement and/or facilitate management of messaging and/or other communications among and between the various systems, components, devices, EGDs, players, dealers, and administrators of the gaming network.
Mobile System Server(s) 308. In at least one embodiment, the Mobile System Server(s) may be configured or designed to implement and/or facilitate management of communications and/or data exchanged with various types of mobile devices, including for example: player-managed mobile devices (e.g., smart phones, PDAs, tablets, mobile computers), casino-managed mobile devices (e.g., mobile gaming devices), etc.
Financial System Server(s) 312. In at least one embodiment, the Financial System Server(s) may be configured or designed to implement and/or facilitate tracking, management, reporting, and storage of financial data and financial transactions relating to one or more hybrid skill-based/wager-based game sessions. For example, at least some Financial System Server(s) may be configured or designed to keep track of the game accounting (e.g., money in, money out) for a virtual hybrid skill-based/wager-based game being played, and may also be configured or designed to handle various financial transactions relating to player wagers and payouts. For example, in at least one embodiment, Financial Servers may be configured or designed to monitor each remote player's account information, and may also manage or handle funds transfers between each player's account and the active game server (e.g., associated with the player's game session).
Player Tracking System Server(s) 314. In at least one embodiment, the Player Tracking System Server(s) may be configured or designed to implement and/or facilitate management and exchange of player tracking information associated with one or more EGDs, hybrid skill-based/wager-based game sessions, etc. In at least one embodiment, a Player Tracking System Server may include at least one database that tracks each player's hands, wins/losses, bet amounts, player preferences, etc., in the network. In at least one embodiment, the presenting and/or awarding of promotions, bonuses, rewards, achievements, etc., may be based on a player's play patterns, time, games selected, bet amount for each game type, etc. A Player Tracking System Server may also help establish a player's preferences, which assists the casino in their promotional efforts to: award player comps (e.g., loyalty points); decide which promotion(s) are appropriate; generate bonuses; etc.
Data Tracking & Analysis System(s) 318. In at least one embodiment, the Data Tracking & Analysis System(s) may be configured or designed to implement and/or facilitate management and analysis of game data. For example, in one embodiment the Data Tracking & Analysis System(s) may be configured or designed to aggregate multisite hybrid skill-based/wager-based gaming trends, local wins, jackpots, etc.
Gaming System Server(s) (e.g., 322, 324). In at least one embodiment, different game servers may be configured or designed to be dedicated to one or more specifically designated type(s) of game(s). Each game server has game logic to host one of more virtual hybrid skill-based/wager-based game sessions. At least some game server(s) may also be capable of keeping track of the game accounting (e.g., money in, money out) for a virtual hybrid skill-based/wager-based game being played, and/or for updating the Financial Servers at the end of each game. The game server(s) may also operable to generate the EGD graphics primitives (e.g., game virtual objects and game states), and may further be operable to update EGDs when a game state change (e.g., new card dealt, player upped the ante, player folds/busts, etc.) may be detected.
Jurisdictional/Regulatory Monitoring & Enforcement System(s) 350. In at least one embodiment, the Jurisdictional/Regulatory Monitoring & Enforcement System(s) may be configured or designed to handle tracking, monitoring, reporting, and enforcement of specific regulatory requirements relating to wager-based gameplay activities in one or more jurisdictions.
Authentication & Validation System(s) 352. According to different embodiments, the Authentication & Validation System(s) may be configured or designed to determine and/or authenticate the identity of the current player at a given EGD. For example, in one embodiment, the current player may be required to perform a log in process at the EGD in order to access one or more features. Alternatively, the EGD may be adapted to automatically determine the identity of the current player based upon one or more external signals such as, for example, scanning of a barcode of a player tracking card, an RFID tag or badge worn by the current player which provides a wireless signal to the EGD for determining the identity of the current player. In at least one implementation, various security features may be incorporated into the EGD to prevent unauthorized players from engaging in certain types of activities at the EGD. In some embodiments, the Authentication & Validation System(s) may be configured or designed to authenticate and/or validate various types of hardware and/or software components, such as, for example, hardware/software components residing at a remote EGDs, game play information, wager information, player information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Casino Venues (e.g., 330, 340). In at least one embodiment, each casino venue may correspond to a real-world, physical casino which is located at a particular geographic location. In some embodiments, a portion of the multiple different casino venues may be affiliated with each other (e.g., Harrah's Las Vegas, Harrah's London). In other embodiments, at least a portion of the multiple different casino venues do not share any affiliation with each other.
Electronic gaming devices (e.g., EGDs) 332, 334, 336, 342, 344, 346. As described in greater detail herein, the EGDs may be configured or designed to facilitate and enable players to participate in wager-based, skill-based video game sessions (e.g., and/or other types of hybrid skill-based/wager-based game sessions). Different EGDs may be physically located in one or more different casino venues, and may be connected via a communication network. In some embodiments, EGDs may be implemented as stationary machines. In some embodiments, at least some EGDs may be implemented using mobile devices (e.g., tablets, smartphones, laptops, PC's, and the like).
Internet, Cellular, and WAN Network(s) 310
Game History Server(s) 364. In at least one embodiment, the Game History Server(s) may be configured or designed to track all (e.g., or selected) game types and game play history for all (e.g., or selected) hybrid skill-based/wager-based games. In some embodiments, a Game History Server may also assist the casino manager in case of disputes between players and the casino by, for example, providing the ability to “replay” (e.g., by virtually recreating the game events) the game in dispute, step by step, based on previously stored game states. Such dispute resolution capability is a desirable feature in hybrid skill-based/wager-based game environments.
Remote Database System(s) which, for example, may be operable to store and provide access to various types of information and data described herein.
Remote System Server(s)/Service(s), which, for example, may include, but are not limited to, one or more of the following (e.g., or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Game Device(s) 336, 346—In at least one embodiment, the Mobile Device(s) may be operable to perform and/or implement various types of functions, operations, actions, and/or other features such as those described or referenced herein (e.g., such as those illustrated and/or described with respect to FIG. 6).

According to specific embodiments, a variety of different game states may be used to characterize the state of current and/or past events which are occurring (e.g., or have occurred) at a given EGD. For example, in one embodiment, at any given time in a game, a valid current game state may be used to characterize the state of game play (e.g., and/or other related events, such as, for example, mode of operation of the EGD, etc.) at that particular time. In at least one embodiment, multiple different states may be used to characterize different states or events which occur at the EGD at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the EGD may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

According to specific embodiments, a variety of different entities may be used (e.g., either singly or in combination) to track the progress of game states which occur at a given gaming EGD. Examples of such entities may include, but are not limited to, one or more of the following (e.g., or combination thereof): master controller system, display system, gaming system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

According to a specific embodiment, local game tracking components at the EGD may be operable to automatically monitor game play activities at the EGD, and/or to automatically identify key events which may trigger a transition of game state from one state to another as a game progresses. Depending upon the type of game being played at the gaming table, examples of possible key events may include, but are not limited to, one or more of the following (e.g., or combination thereof):
start of a new hybrid skill-based/wager-based gaming session;
end of a current hybrid skill-based/wager-based gaming session;
start of a virtual slot wheel spin;
game start event;
game end event;
detection of event for triggering initiation of wager-based event (e.g., destroying a zombie on screen triggers spin of virtual slot reel, and subsequent payout/credit award);
detection of event for triggering end of wager-based event (e.g., slot wheel spin, etc.);
detection of event for triggering initiation of randomized game play event;
detection of event for triggering end of randomized game play event;
initial wager period start;
initial wager period end;
subsequent wager period start;
subsequent wager period end;
payout period start;
payout period end;
etc.

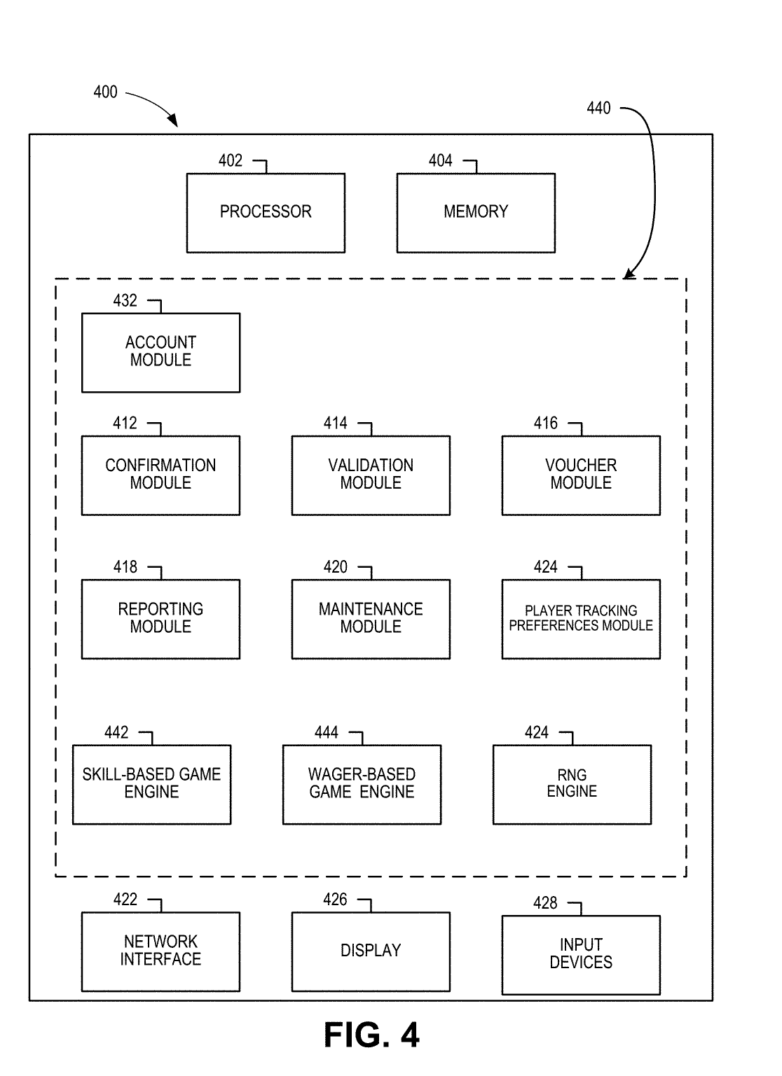

FIGS. 4, 5, 6, and 14 show block diagrams of different example embodiments of electronic gaming machines (e.g., EGMs) or electronic gaming devices (“EGDs) which may be used for facilitating, enabling, initiating, and/or implementing one or more of the hybrid skill-based/wager-based gaming aspects described herein.

FIG. 4 shows a block diagram 400 of electronic gaming device 400, in accordance with a specific embodiment. Electronic gaming device 400 may include a processor 402, a memory 404, a network interface 422, input devices 428, and a display 426.

Processor 402 may generate gaming options based on predetermined betting structures and/or outcome categories. Predetermined betting structures may utilize more than one outcome category to generate via processor 402 gaming options. Predetermined betting structures may combine any outcome category with any other outcome category to gaming options.

Processor 402 may offer a gaming option which is structured so that the gaming option relates to more than one EGD. Processor 402 may generate contingent gaming options and/or predetermined gaming options. Contingent gaming options 410 may be structures such that when a triggering event occurs over one or more than one gaming event, racing event, and/or sporting event, the wager is activated.

Network interface 422 may allow electronic gaming device 400 to communicate with remote devices/systems such as, for example, video/multimedia server(s), accounting/transaction server(s), gaming server(s), authentication server(s), player tracking server(s), voucher server(s), etc.

Input devices 428 may be mechanical buttons, electronic buttons, a touchscreen, a microphone, cameras, an optical scanner, or any combination thereof. Input devices 428 may be utilized to make a wager, to make an offer to buy or sell a voucher, to determine a voucher's worth, to cash in a voucher, to modify (e.g., change sound level, configuration, font, language, etc.) electronic gaming device 400, to select a movie or music, to select type of content to be displayed on main and/or auxiliary screen(s) of EGD, or any combination thereof.

Skill-based Game Engine 442 may be configured or designed to manage the skill-based game play portion (or entertainment portion) of the hybrid skill-based/wager-based game.

Wager-based Game Engine 444 may be configured or designed to manage the wager-based game event portion(s) of the hybrid skill-based/wager-based game.

Random Number Generator (RNG) Engine 446 may include software and/or hardware algorithm and/or processes which are used to generate random outcomes, and may be used by the Wager-Based Game Engine to generate wager-based game event outcomes, at least a portion of which may correspond to predetermined wager-based game event outcomes (as described in greater detail below).

Display 426 may show video streams from one or more gaming devices, gaming objects from one or more gaming devices, computer generated graphics, predetermined gaming options, and/or contingent gaming options.

Memory 404 may include various memory modules 440. Memory 404 via various memory modules 440 may include a confirmation module 412, a validation module 414, a voucher module 416, a reporting module 418, a maintenance module 420, a player tracking preferences module 424, and an account module 432.

Confirmation module 412 may utilize data received from a voucher, the transaction history of the voucher (e.g., the voucher changed hands in a secondary market), and/or the identity of the player to confirm the value of the voucher. In another example, confirmation module 412 may utilize game event data, along with voucher data to confirm the value of the voucher.

Validation module 414 may utilize data received from a voucher to confirm the validity of the voucher.

Voucher module 416 may store data relating to generated vouchers, redeemed vouchers, bought vouchers, and/or sold vouchers.

Reporting module 418 may generate reports related to a performance of electronic gaming device 400, electronic gaming system(s), hybrid skill-based/wager-based game(s), video streams, gaming objects, credit device(s), identification device(s), etc.

In one implementation, reporting module 418 may reside on a central server and can aggregate and generate real time statistics on betting activities at one or more hybrid skill-based/wager-based games at one or more participating casino's. The aggregate betting statistics may include trends (e.g., aggregate daily wager volume and wager amount by game types, by casinos, and the like), top games with the most payouts, top tables with the most payouts, top search structures used by players, most popular hybrid skill-based/wager-based game(s) by wager volume, most searched for game, hybrid skill-based/wager-based game(s) with least payouts, weekly trends, monthly trends, and other statistics related to game plays, wagers, people, location, and searches.

The information and statistics generated by the server-based reporting module 418 can be displayed publicly or privately. For example, popular trending and statistical information on wager volume and wager amount for the top ten hybrid skill-based/wager-based games can be publicly displayed in a casino display system so that players can study and decide what game to play, where, when, etc. Such a public display of general statistics can also be posted on the Internet, sent out as a text, an email, or multimedia message to the player's smart phones, tablets, desktop computer, etc. In another example, the trending and statistical information can also be distributed privately to privileged players such as casino club members.

Maintenance module 420 may track any maintenance that is implemented on electronic gaming device 400 and/or electronic gaming system 200. Maintenance module 420 may schedule preventative maintenance and/or request a service call based on a device error.

Player tracking preferences module 424 may compile and track data associated with a players preferences.

Account module 432 may include data relating to an account balance, a wager limit, a number of wagers placed, credit limits, any other player information, and/or any other account information.

Data from account module 432 may be utilized to determine whether a wager may be accepted. For example, when a search has determined a triggering event, the device and/or system may determine whether to allow this wager based on one or more of a wager amount, a number of wagers, a wager limit, an account balance, and/or any other criteria.

In at least one embodiment, at least a portion of the modules discussed in block diagram 400 may reside locally in gaming terminal 400. However, in at least some embodiments, the functions performed by these modules may be implemented in one or more remote servers. For instance, modules 406-420 and 424 may each be on a remote server, communicating with gaming terminal 400 via a network interface such as Ethernet in a local or a wide area network topology. In some implementations, these servers may be physical servers in a data center. In some other implementations, these servers may be virtualized. In yet some other implementations, the functions performed by these modules may be implemented as web services. For example, the predetermined game options module 408 may be implemented in software as a web service provider. Gaming terminal 400 would make service requests over the web for the available predetermined wager options to be displayed. Regardless of how the modules and their respective functions are implemented, the interoperability with the gaming terminal 400 is seamless.

In one implementation, reporting module 418 may reside on a central server and can aggregate and generate real time statistics on betting activities at one or more hybrid skill-based/wager-based games at one or more participating casino's. The aggregate betting statistics may include trends (e.g., aggregate daily wager volume and wager amount by game types, by casinos, and the like), top games with the most payouts, top EGDs with the most payouts, top search structures used by players, most popular hybrid skill-based/wager-based game(s) by wager volume, most searched for game(s), EGDs with least payouts, weekly trends, monthly trends, and other statistics related to game plays, wagers, people, location, and searches.

The information and statistics generated by the server-based reporting module 418 can be displayed publicly or privately. For example, popular trending and statistical information on wager volume and wager amount for the top ten hybrid skill-based/wager-based games can be publicly displayed in a casino display system so that players can study and decide what game to play, where, when, etc. Such a public display of general statistics can also be posted on the Internet, sent out as a text, an email, or multimedia message to the player's smart phones, tablets, desktop computer, etc. In another example, the trending and statistical information can also be distributed privately to privileged players such as casino club members.

FIG. 5 is a simplified block diagram of an exemplary intelligent multi-player electronic gaming system 500 in accordance with a specific embodiment. In some embodiments, gaming system 500 may be implemented as a gaming server. In other embodiments, gaming system 500 may be implemented as an electronic gaming machine (e.g., EGM) or electronic gaming device (e.g., EGD).

As illustrated in the embodiment of FIG. 5, gaming system 500 includes at least one processor 510, at least one interface 506, and memory 516. Additionally, as illustrated in the example embodiment of FIG. 5, gaming system 500 includes at least one master gaming controller 512, a multi-touch sensor and display system 590, a plurality of peripheral device components 550, and various other components, devices, systems such as, for example, one or more of the following (e.g., or combinations thereof):
Skill-based Game Engine(s) 541;
Wager-based Game Engine(s) 543;
RNG Engine(s) 545;
Candle control system which, for example, may include functionality for determining and/or controlling the appearances of one or more candles, etc.;
Transponders 554;
Wireless communication components 556;
Gaming chip/wager token tracking components 570;
Games state tracking components 574;
Motion/gesture analysis and interpretation components 584.
Audio/video processors 583 which, for example, may include functionality for detecting, analyzing and/or managing various types of audio and/or video information relating to various activities at the gaming system.
Various interfaces 506b (e.g., for communicating with other devices, components, systems, etc.);
Tournament manager 575;
Sensors 560;
One or more cameras 562;
One or more microphones 563;
Secondary display(s) 535a;
Input devices 530a;
Motion/gesture detection components 551;
Peripheral Devices 550;

Skill-based Game Engine(s) 541 may be configured or designed to manage the skill-based game play portion (or entertainment portion) of the hybrid skill-based/wager-based game.

Wager-Based Game Engine(s) 543 may be configured or designed to manage the wager-based game event portion(s) of the hybrid skill-based/wager-based game.

Random Number Generator (RNG) Engine(s) 545 may include software and/or hardware algorithm and/or processes which are used to generate random outcomes, and may be used by the Wager-Based Game Engine to generate wager-based game event outcomes, at least a portion of which may correspond to predetermined wager-based game event outcomes (as described in greater detail below).

Monetary Payout Manager 522 may be configured or designed to include functionality for determining the appropriate monetary payout(s) (if any) to be distributed to player(s) based on the outcomes of the wager-based game events which are initiated during play of one or more hybrid skill-based/wager-based games.

Non-Monetary Payout Manager 524 may be configured or designed to include functionality for determining the appropriate non-monetary payout(s) (if any) to be awarded or distributed to player(s) based on the outcomes of the wager-based game events which are initiated during play of one or more hybrid skill-based/wager-based games.

One or more cameras (e.g., 562) may be used to monitor, stream and/or record image content and/or video content relating to persons or objects within each camera's view. For example, in at least one embodiment where the gaming system is implemented as an EGD, camera 562 may be used to generate a live, real-time video feed of a player (e.g., or other person) who is currently interacting with the EGD. In some embodiments, camera 562 may be used to verify a user's identity (e.g., by authenticating detected facial features), and/or may be used to monitor or tract facial expressions and/or eye movements of a user or player who is interacting with the gaming system.

In at least one embodiment, display system 590 may include one or more of the following (e.g., or combinations thereof):
EGD controllers 591;
Multipoint sensing device(s) 592 (e.g., multi-touch surface sensors/components);
Display device(s) 595;
Input/touch surface 596;
Etc.

According to various embodiments, display surface(s) 595 may include one or more display screens utilizing various types of display technologies such as, for example, one or more of the following (e.g., or combinations thereof): LCDs (e.g., Liquid Crystal Display), Plasma, OLEDs (e.g., Organic Light Emitting Display), TOLED (e.g., Transparent Organic Light Emitting Display), Flexible (e.g., F) OLEDs, Active matrix (e.g., AM) OLED, Passive matrix (e.g., PM) OLED, Phosphor-escent (e.g., PH) OLEDs, SEDs (e.g., surface-conduction electron-emitter display), EPD (e.g., ElectroPhoretic display), FEDs (e.g., Field Emission Displays) and/or other suitable display technology. EPD displays may be provided by E-ink of Cambridge, Mass. OLED displays of the type list above may be provided by Universal Display Corporation, Ewing, N.J.

In at least one embodiment, master gaming controller 512 may include one or more of the following (e.g., or combinations thereof):
Authentication/validation components 544;
Device drivers 552;
Logic devices 513, which may include one or more processors 510;
Memory 516, which may include one or more of the following (e.g., or combinations thereof): configuration software 514, non-volatile memory 519, EPROMS 508, RAM 509, associations 518 between indicia and configuration software, etc.;
Interfaces 506;
Etc.

In at least one embodiment, Peripheral Devices 550 may include one or more of the following (e.g., or combinations thereof):
Power distribution components 558;
Non-volatile memory 519a (e.g., and/or other types of memory);
Bill acceptor 553;
Ticket I/O 555;
Player tracking I/O 557;
Meters 559 (e.g., hard and/or soft meters);
Meter detect circuitry 559a;
Processor(s) 510a;
Interface(s) 506a;
Display(s) 535;
Independent security system 561;
Door detect switches 567;
Candles, etc. 571;
Input devices 530;
Etc.

In one implementation, processor 510 and master gaming controller 512 are included in a logic device 513 enclosed in a logic device housing. The processor 510 may include any conventional processor or logic device configured to execute software allowing various configuration and reconfiguration tasks such as, for example: a) communicating with a remote source via communication interface 506, such as a server that stores authentication information or games; b) converting signals read by an interface to a format corresponding to that used by software or memory in the gaming system; c) accessing memory to configure or reconfigure game parameters in the memory according to indicia read from the device; d) communicating with interfaces, various peripheral devices and/or I/O devices; e) operating peripheral devices such as, for example, card readers, paper ticket readers, etc.; f) operating various I/O devices such as, for example, displays 535, input devices 530; etc. For instance, the processor 510 may send messages including game play information to the displays 535 to inform players of game play/event information, wagering information, and/or other desired information.

In at least one implementation, the gaming system may include card readers such as used with credit cards, or other identification code reading devices to allow or require player identification in connection with play of the card game and associated recording of game action. Such a player identification interface can be implemented in the form of a variety of magnetic card readers commercially available for reading a player-specific identification information. The player-specific information can be provided on specially constructed magnetic cards issued by a casino, or magnetically coded credit cards or debit cards frequently used with national credit organizations such as Visa, Mastercard, American Express, or banks and other institutions.

The gaming system may include other types of participant identification mechanisms which may use a fingerprint image, eye blood vessel image reader, or other suitable biological information to confirm identity of the player. Such personalized identification information could also be used to confirm credit use of a smart card, transponder, and/or player's personal player input device (e.g., UID).

The gaming system 500 also includes memory 516 which may include, for example, volatile memory (e.g., RAM 509), non-volatile memory 519 (e.g., disk memory, FLASH memory, EPROMs, etc.), unalterable memory (e.g., EPROMs 508), etc. The memory may be configured or designed to store, for example: 1) configuration software 514 such as all the parameters and settings for a game playable on the gaming system; 2) associations 518 between configuration indicia read from a device with one or more parameters and settings; 3) communication protocols allowing the processor 510 to communicate with peripheral devices and I/O devices 4) a secondary memory storage device 515 such as a non-volatile memory device, configured to store gaming software related information (e.g., the gaming software related information and memory may be used to store various audio files and games not currently being used and invoked in a configuration or reconfiguration); 5) communication transport protocols (e.g., such as, for example, TCP/IP, USB, Firewire, IEEE1394, Bluetooth, IEEE 802.11x (e.g., IEEE 802.11 standards), hiperlan/2, HomeRF, etc.) for allowing the gaming system to communicate with local and non-local devices using such protocols; etc. In one implementation, the master gaming controller 512 communicates using a serial communication protocol. A few examples of serial communication protocols that may be used to communicate with the master gaming controller include but are not limited to USB, RS-232 and Netplex (e.g., a proprietary protocol developed by IGT, Reno, Nev.).

A plurality of device drivers 552 may be stored in memory 516. Example of different types of device drivers may include device drivers for gaming system components, device drivers for gaming system components, etc. Typically, the device drivers 552 utilize a communication protocol of some type that enables communication with a particular physical device. The device driver abstracts the hardware implementation of a device. For example, a device drive may be written for each type of card reader that may be potentially connected to the gaming system. Examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (e.g., WiFi), etc. Netplex is a proprietary IGT standard while the others are open standards. According to a specific embodiment, when one type of a particular device is exchanged for another type of the particular device, a new device driver may be loaded from the memory 516 by the processor 510 to allow communication with the device. For instance, one type of card reader in gaming system 500 may be replaced with a second type of card reader where device drivers for both card readers are stored in the memory 516.

In some embodiments, the software units stored in the memory 516 may be upgraded as needed. For instance, when the memory 516 is a hard drive, new games, game options, various new parameters, new settings for existing parameters, new settings for new parameters, device drivers, and new communication protocols may be uploaded to the memory from the master gaming controller 512 or from some other external device. As another example, when the memory 516 includes a CD/DVD drive including a CD/DVD designed or configured to store game options, parameters, and settings, the software stored in the memory may be upgraded by replacing a first CD/DVD with a second CD/DVD. In yet another example, when the memory 516 uses one or more flash memory 519 or EPROM 508 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming system 500 may also include various authentication and/or validation components 544 which may be used for authenticating/validating specified gaming system components such as, for example, hardware components, software components, firmware components, information stored in the gaming system memory 516, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Sensors 560 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone; detecting (e.g., in real time) the presence and/or monetary amount of gaming chips which are within the player's personal space; etc.

In one implementation, at least a portion of the sensors 560 and/or input devices 530 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming system player may include input functionality for enabling players to provide their game play decisions/instructions (e.g., and/or other input) to the EGD using the touch keys and/or other player control sensors/buttons. Additionally, such input functionality may also be used for allowing players to provide input to other devices in the casino gaming network (e.g., such as, for example, player tracking systems, side wagering systems, etc.)

Wireless communication components 556 may include one or more communication interfaces having different architectures and utilizing a variety of protocols such as, for example, 802.11 (e.g., WiFi), 802.15 (e.g., including Bluetooth™), 802.16 (e.g., WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

An example of a near-field communication protocol is the ECMA-340 “Near Field Communication-Interface and Protocol (e.g., NFCIP-1)”, published by ECMA International (e.g., www.ecma-international.org), herein incorporated by reference in its entirety for all purposes. It may be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least 5 devices using such wireless communication protocols.

Power distribution components 558 may include, for example, components or devices which are operable for providing wireless power to other devices. For example, in one implementation, the power distribution components 558 may include a magnetic induction system which is adapted to provide wireless power to one or more portable UIDs at the gaming system. In one implementation, a UID docking region may include a power distribution component which is able to recharge a UID placed within the UID docking region without requiring metal-to-metal contact.

In at least one embodiment, motion/gesture detection component(s) 551 may be configured or designed to detect player movements and/or gestures and/or other input data from the player. In some embodiments, each gaming system may have its own respective motion/gesture detection component(s). In other embodiments, motion/gesture detection component(s) 551 may be implemented as a separate sub-system of the gaming system which is not associated with any one specific gaming system or device.

FIG. 14 shows an example block diagram of an alternate embodiment of an electronic gaming machine which may be configured or designed to implement one or more of the hybrid skill-based/wager-based gaming aspects described herein. As illustrated in the example embodiment of FIG. 14, the electronic gaming machine 1400 may include, but are not limited to, one or more of the following component(s) (or combinations thereof):
One or more display(s) (1404, 1406).
HID I/O component(s) (1410, 1414).
Payout I/O component(s) (1408).
Cash/Credit/Coin I/O c component(s) (1412).
CPUs/Processor(s)/Gaming Controller(s) (1420).
Memory (1424).
One or more Graphics Processor(s) (GPU) (1418).
RNG I/O component(s) (1422, 1428).
Other I/O component(s) (1416, 1426).
Interface(s) to one or more External Services (1430).

FIG. 6 is a simplified block diagram of an exemplary mobile gaming device 600 in accordance with a specific embodiment. In at least one embodiment, one or more players may participate in a wager-based, skill-based video game session using mobile gaming devices. In at least some embodiments, the mobile gaming device may be configured or designed to include or provide functionality which is similar to that of an electronic gaming device (e.g., EGD) such as that described, for example, in FIG. 4.

As illustrated in the example of FIG. 6, mobile gaming device 600 may include a variety of components, modules and/or systems for providing various functionality. For example, as illustrated in FIG. 6, mobile gaming device 600 may include Mobile Device Application components (e.g., 660), which, for example, may include, but are not limited to, one or more of the following (e.g., or combinations thereof):
UI Components 662 such as those illustrated, described, and/or referenced herein.
Database Components 664 such as those illustrated, described, and/or referenced herein.
Processing Components 666 such as those illustrated, described, and/or referenced herein.
Other Components 668 which, for example, may include components for facilitating and/or enabling the mobile gaming device to perform and/or initiate various types of operations, activities, functions such as those described herein.

In at least one embodiment, the mobile gaming device may include Mobile Device App Component(s) which have been configured or designed to provide functionality for enabling or implementing at least a portion of the various hybrid skill-based/wager-based game techniques at the mobile gaming device.

According to specific embodiments, various aspects, features, and/or functionalities of the mobile gaming device may be performed, implemented and/or initiated by one or more of the following types of systems, components, systems, devices, procedures, processes, etc. (e.g., or combinations thereof):
Processor(s) 610
Device Drivers 642
Memory 616
Interface(s) 606
Power Source(s)/Distribution 643
Geolocation module 646
Display(s) 635
I/O Devices 630
Audio/Video devices(s) 639
Peripheral Devices 631
Motion Detection module 640
User Identification/Authentication module 647
Client App Component(s) 660
Other Component(s) 668
UI Component(s) 662
Database Component(s) 664
Processing Component(s) 666
Software/Hardware Authentication/Validation 644
Wireless communication module(s) 645
Information Filtering module(s) 649
Operating mode selection component 648
Speech Processing module 654
Scanner/Camera 652
OCR Processing Engine 656
etc.

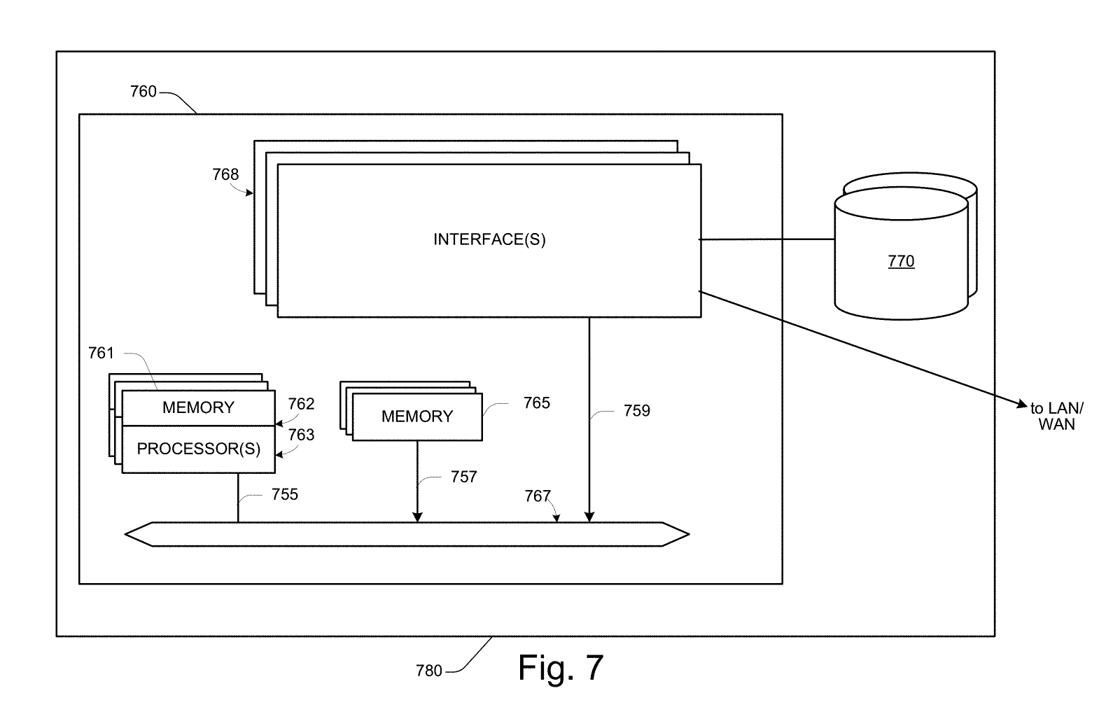

FIG. 7 illustrates an example embodiment of a system server 780 which may be used for implementing various aspects/features described herein. In at least one embodiment, the system server 780 includes at least one network device 760, and at least one storage device 770 (e.g., such as, for example, a direct attached storage device). In one embodiment, system server 780 may be suitable for implementing at least some of the hybrid skill-based/wager-based game techniques described herein.

In according to one embodiment, network device 760 may include a master central processing unit (e.g., CPU) 762, interfaces 768, and a bus 767 (e.g., a PCI bus). When acting under the control of appropriate software or firmware, the CPU 762 may be responsible for implementing specific functions associated with the functions of a desired network device. For example, when configured as a server, the CPU 762 may be responsible for analyzing packets; encapsulating packets; forwarding packets to appropriate network devices; instantiating various types of virtual machines, virtual interfaces, virtual storage volumes, virtual appliances; etc. The CPU 762 preferably accomplishes at least a portion of these functions under the control of software including an operating system (e.g., Linux), and any appropriate system software (e.g., such as, for example, AppLogic (e.g., TM) software).

CPU 762 may include one or more processors 763 such as, for example, one or more processors from the AMD, Motorola, Intel and/or MIPS families of microprocessors. In an alternative embodiment, processor 763 may be specially designed hardware for controlling the operations of system server 780. In a specific embodiment, a memory 761 (e.g., such as non-volatile RAM and/or ROM) also forms part of CPU 762. However, there may be many different ways in which memory could be coupled to the system. Memory block 761 may be used for a variety of purposes such as, for example, caching and/or storing data, programming instructions, etc.

The interfaces 768 may be typically provided as interface cards (e.g., sometimes referred to as “line cards”). Alternatively, one or more of the interfaces 768 may be provided as on-board interface controllers built into the system motherboard. Generally, they control the sending and receiving of data packets over the network and sometimes support other peripherals used with the system server 780. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (e.g., WiFi) interfaces, 802.15 interfaces (e.g., including Bluetooth™), 802.16 (e.g., WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 762 to efficiently perform routing computations, network diagnostics, security functions, etc.

In at least one embodiment, some interfaces may be configured or designed to allow the system server 780 to communicate with other network devices associated with various local area network (e.g., LANs) and/or wide area networks (e.g., WANs). Other interfaces may be configured or designed to allow network device 760 to communicate with one or more direct attached storage device(s) 770.

Although the system shown in FIG. 7 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (e.g., such as, for example, memory block 765, which, for example, may include random access memory (e.g., RAM)) configured to store data, program instructions for the general-purpose network operations and/or other information relating to the functionality of the various hybrid skill-based/wager-based game techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (e.g., ROM) and random access memory (e.g., RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

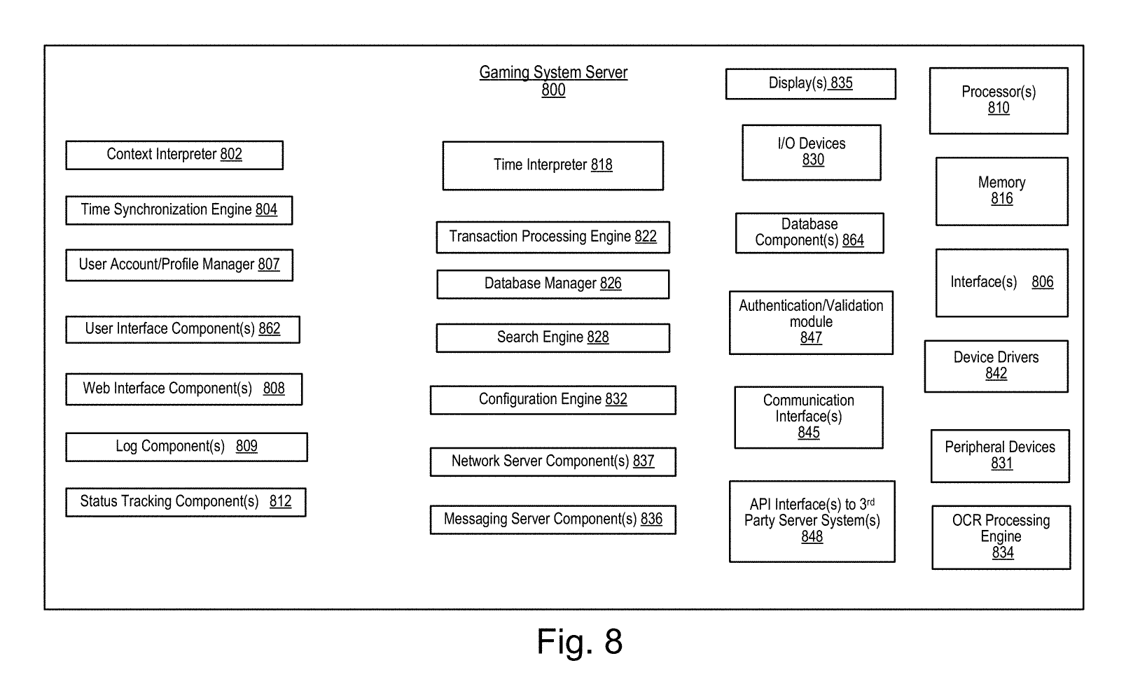

FIG. 8 illustrates an example of a functional block diagram of a Gaming System Server in accordance with a specific embodiment. In at least one embodiment, the Virtual Live electronic gaming device System Server may be operable to perform and/or implement various types of functions, operations, actions, and/or other features, such as, for example, one or more of those described and/or referenced herein.

In at least one embodiment, the Gaming System Server may include a plurality of components operable to perform and/or implement various types of functions, operations, actions, and/or other features such as, for example, one or more of the following (e.g., or combinations thereof):
Context Interpreter (e.g., 802) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (e.g., or combinations thereof):
   location-based criteria (e.g., geolocation of mobile gaming device, geolocation of EGD, etc.)
   time-based criteria
   identity of user(s)
   user profile information
   transaction history information
   recent user activities
   etc.
Time Synchronization Engine (e.g., 804) which, for example, may be operable to manage universal time synchronization (e.g., via NTP and/or GPS)
Search Engine (e.g., 828) which, for example, may be operable to search for transactions, logs, game history information, player information, hybrid skill-based/wager-based game information, etc., which may be accessed from one or more local and/or remote databases.
Configuration Engine (e.g., 832) which, for example, may be operable to determine and handle configuration of various customized configuration parameters for one or more devices, component(s), system(s), process(es), etc.
Time Interpreter (e.g., 818) which, for example, may be operable to automatically and/or dynamically modify or change identifier activation and expiration time(s) based on various criteria such as, for example, time, location, transaction status, etc.
Authentication/Validation Component(s) (e.g., 847) (e.g., password, software/hardware info, SSL certificates) which, for example, may be operable to perform various types of authentication/validation tasks such as one or more of those described and/or referenced herein.
Transaction Processing Engine (e.g., 822) which, for example, may be operable to handle various types of transaction processing tasks such as, for example, one or more of those described and/or referenced herein.
OCR Processing Engine (e.g., 834) which, for example, may be operable to perform image processing and optical character recognition of images such as those captured by a gaming device camera, for example.
Database Manager (e.g., 826) which, for example, may be operable to handle various types of tasks relating to database updating, database management, database access, etc. In at least one embodiment, the Database Manager may be operable to manage game history databases, player tracking databases, etc.
Log Component(s) (e.g., 809) which, for example, may be operable to generate and manage transactions history logs, system errors, connections from APIs, etc.
Status Tracking Component(s) (e.g., 812) which, for example, may be operable to automatically and/or dynamically determine, assign, and/or report updated transaction status information based, for example, on the state of the transaction.
Gateway Component(s) which, for example, may be operable to facilitate and manage communications and transactions with external Payment Gateways.
Web Interface Component(s) (e.g., 808) which, for example, may be operable to facilitate and manage communications and transactions with virtual live electronic gaming device web portal(s).
API Interface(s) to Gaming System Server(s) which, for example, may be operable to facilitate and manage communications and transactions with API Interface(s) to Gaming System Server(s)
API Interface(s) to 3rd Party System Server(s) (e.g., 848) which, for example, may be operable to facilitate and manage communications and transactions with API Interface(s) to 3rd Party System Server(s)
At least one processor 810. In at least one embodiment, the processor(s) 810 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of a gaming system. In a specific embodiment, a memory (e.g., such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 816, which, for example, may include volatile memory (e.g., RAM), non-volatile memory (e.g., disk memory, FLASH memory, EPROMs, etc.), unalterable memory, and/or other types of memory. In at least one implementation, the memory 816 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile gaming system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein.
Interface(s) 806 which, for example, may include wired interfaces and/or wireless interfaces. In at least one implementation, the interface(s) 806 may include functionality similar to at least a portion of functionality implemented by one or more computer system interfaces such as those described herein and/or generally known to one having ordinary skill in the art.
Device driver(s) 842. In at least one implementation, the device driver(s) 842 may include functionality similar to at least a portion of functionality implemented by one or more computer system driver devices such as those described herein and/or generally known to one having ordinary skill in the art.
One or more display(s) 835.
Messaging Server Component(s) 836, which, for example, may be configured or designed to provide various functions and operations relating to messaging activities and communications.
Network Server Component(s) 837, which, for example, may be configured or designed to provide various functions and operations relating to network server activities and communications.
User Account/Profile Manager component(s) 807.
Etc.

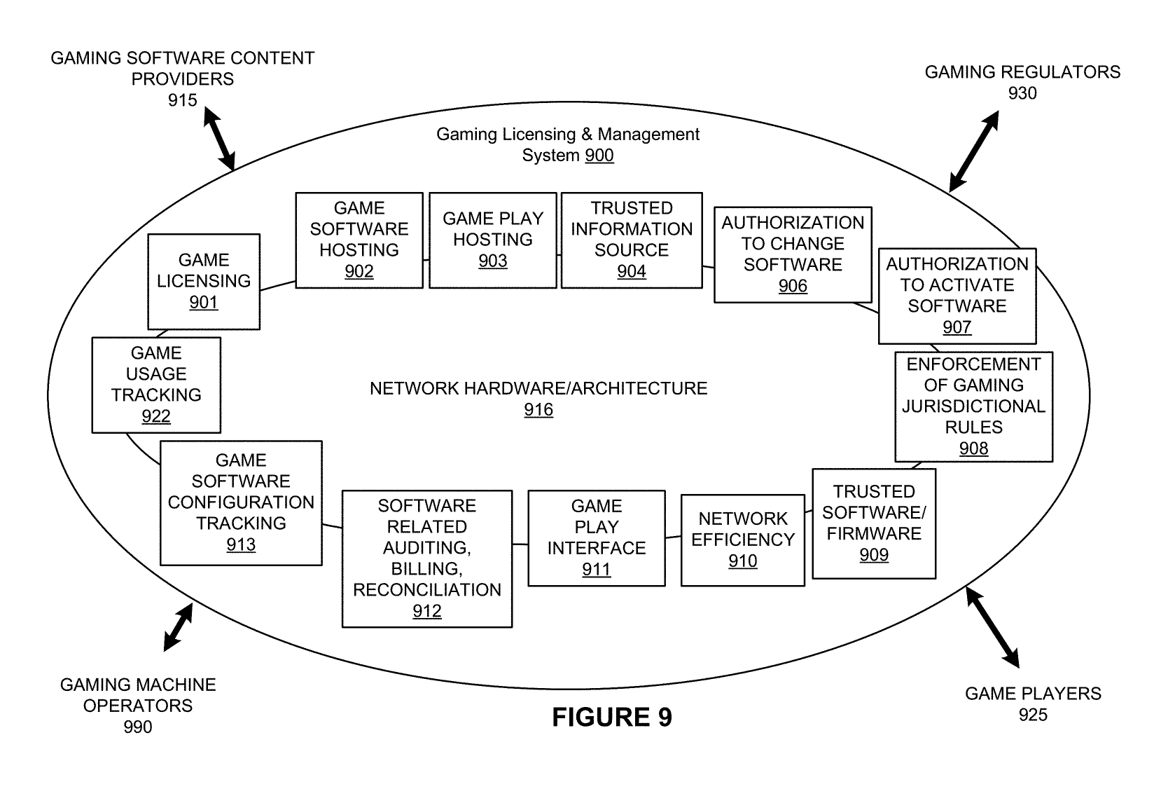

FIG. 9 shows a block diagram illustrating components of a gaming system 900 which may be used for implementing various aspects of example embodiments. In FIG. 9, the components of a gaming system 900 for providing game software licensing and downloads are described functionally. The described functions may be instantiated in hardware, firmware and/or software and executed on a suitable device. In the system 900, there may be many instances of the same function, such as multiple game play interfaces 911. Nevertheless, in FIG. 9, only one instance of each function is shown. The functions of the components may be combined. For example, a single device may comprise the game play interface 911 and include trusted memory devices or sources 909.

The gaming system 900 may receive inputs from different groups/entities and output various services and or information to these groups/entities. For example, game players 925 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 900, receive revenue for the use of their software and compensate the gaming machine operators. The gaming regulators 930 may provide rules and regulations that must be applied to the gaming system and may receive reports and other information confirming that rules are being obeyed.

In the following paragraphs, details of each component and some of the interactions between the components are described with respect to FIG. 9. The game software license host 901 may be a server connected to a number of remote gaming devices that provides licensing services to the remote gaming devices. For example, in other embodiments, the license host 901 may 1) receive token requests for tokens used to activate software executed on the remote gaming devices, 9) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 922 may track the usage of game software on a plurality of devices in communication with the host. The game usage-tracking host 922 may be in communication with a plurality of game play hosts and gaming machines. From the game play hosts and gaming machines, the game usage tracking host 922 may receive updates of an amount that each game available for play on the devices may be played and on amount that may be wagered per game. This information may be stored in a database and used for billing according to methods described in a utility based licensing agreement.

The game software host 902 may provide game software downloads, such as downloads of game software or game firmware, to various devious in the game system 900. For example, when the software to generate the game is not available on the game play interface 911, the game software host 902 may download software to generate a selected game of chance played on the game play interface. Further, the game software host 902 may download new game content to a plurality of gaming machines via a request from a gaming machine operator.

In one embodiment, the game software host 902 may also be a game software configuration-tracking host 913. The function of the game software configuration-tracking host is to keep records of software configurations and/or hardware configurations for a plurality of devices in communication with the host (e.g., denominations, number of paylines, paytables, max/min wagers). Details of a game software host and a game software configuration host that may be used with example embodiments are described in co-pending U.S. Pat. No. 6,645,077, by Rowe, titled, “Gaming Terminal Data Repository and Information System,” filed December 91, 9000, which is incorporated herein in its entirety and for all purposes.

A game play host device 903 may be a host server connected to a plurality of remote clients that generates games of chance that are displayed on a plurality of remote game play interfaces 911. For example, the game play host device 903 may be a server that provides central determination for a bingo game play played on a plurality of connected game play interfaces 911. As another example, the game play host device 903 may generate games of chance, such as slot games or video card games, for display on a remote client. A game player using the remote client may be able to select from a number of games that are provided on the client by the host device 903. The game play host device 903 may receive game software management services, such as receiving downloads of new game software, from the game software host 902 and may receive game software licensing services, such as the granting or renewing of software licenses for software executed on the device 903, from the game license host 901.

In particular embodiments, the game play interfaces or other gaming devices in the gaming system 900 may be portable devices, such as electronic tokens, cell phones, smart cards, tablet PC's and PDA's. The portable devices may support wireless communications and thus, may be referred to as wireless mobile devices. The network hardware architecture 916 may be enabled to support communications between wireless mobile devices and other gaming devices in gaming system. In one embodiment, the wireless mobile devices may be used to play games of chance.

The gaming system 900 may use a number of trusted information sources. Trusted information sources 904 may be devices, such as servers, that provide information used to authenticate/activate other pieces of information. CRC values used to authenticate software, license tokens used to allow the use of software or product activation codes used to activate software are examples of trusted information that might be provided from a trusted information source 904. Trusted information sources may be a memory device, such as an EPROM, that includes trusted information used to authenticate other information. For example, a game play interface 911 may store a private encryption key in a trusted memory device that is used in a private key-public key encryption scheme to authenticate information from another gaming device.

When a trusted information source 904 is in communication with a remote device via a network, the remote device may employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 9003/0203756, by Jackson, filed on April 95, 9002 and titled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering may be detected.

The gaming system 900 of example embodiments may include devices 906 that provide authorization to download software from a first device to a second device and devices 907 that provide activation codes or information that allow downloaded software to be activated. The devices, 906 and 907, may be remote servers and may also be trusted information sources. One example of a method of providing product activation codes that may be used with example embodiments is describes in previously incorporated U.S. Pat. No. 6,264,561.

A device 906 that monitors a plurality of gaming devices to determine adherence of the devices to gaming jurisdictional rules 908 may be included in the system 900. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 900 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

In example embodiments, the devices may be connected by a network 916 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices 910 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 912. For example, a software licensing billing server may generate a bill for a gaming device operator based upon a usage of games over a time period on the gaming devices owned by the operator. In another example, a software auditing server may provide reports on game software downloads to various gaming devices in the gaming system 900 and current configurations of the game software on these gaming devices.

At particular time intervals, the software auditing server 912 may also request software configurations from a number of gaming devices in the gaming system. The server may then reconcile the software configuration on each gaming device. In one embodiment, the software auditing server 912 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 9. Many of the interactions are coupled. For example, methods used for game licensing may affect methods used for game downloading and vice versa. For the purposes of explanation, details of a few possible interactions between the components of the system 900 relating to software licensing and software downloads have been described. The descriptions are selected to illustrate particular interactions in the game system 900. These descriptions are provided for the purposes of explanation only and are not intended to limit the scope of example embodiments described herein.

### Additional Benefits/Features/Embodiments

Different embodiments of the hybrid skill-based/wager-based gaming techniques described herein may be adapted and implemented in a variety of environments. For example, the hybrid skill-based/wager-based gaming techniques described herein are particularly well suited for deployment in any business establishments that house wager-based gaming devices (e.g., class 3 and/or class 2). Additionally, the hybrid skill-based/wager-based gaming techniques described herein may appeal to younger gamblers/gamers who enjoy playing skill-based video games, middle aged gamblers/gamers who may have played some video games, and possibly even veteran gamblers who may be bored with existing wager-based video gaming technology.

The hybrid skill-based/wager-based gaming techniques described herein provide the ability for patrons of casinos and other gaming establishments to experience new and exciting ways of engaging in wager-based video game play with minimized learning curve and intimidation factors. Additionally, using the hybrid skill-based/wager-based gaming techniques described herein, casinos and other gaming establishments hosting such hybrid skill-based/wager-based gaming devices may increase their revenue by ensuring that the number of wager-based gaming event(s) occurring in a hybrid skill-based/wager-based game (e.g., during specified time period) meet minimum specified threshold criteria.

One of the benefits of the hybrid skill-based/wager-based gaming techniques described herein is that it provides the ability for traditional video-type wager-based games (such as those deployed at Casino establishments) to be quickly and easily converted to hybrid-type skill-based/wager-based games in a manner which is already compliant with existing rules and regulations governing wager-based gaming, and/or in a manner which may avoid or significantly reduce requirements for additional regulatory approval. For example, in some embodiments, the hybrid skill-based/wager-based gaming system may include functionality for providing a new display method and interaction thereof for currently approved wager-based games and/or wager-based gaming machines such as, for example, video-style wager-based games/gaming machines which have already been approved (and/or deployed) for player use in one or more gaming jurisdictions.

It may be appreciated that currently existing gaming technology and associated gaming regulations do not allow for “mega title” arcade-type games (e.g., Call Of Duty, Assassin's Creed, etc.) to be directly implemented within gambling gameplay. One reason for this is that any new wager-based game must first obtain various gaming regulatory approvals before being allowed to be deployed in designated gaming jurisdictions. However, if one were to desire to implement a “Call Of Duty” (COD) hybrid skill-based/wager-based game, companies and developers (among other legal and regulatory bodies) may collaborate to create such product (e.g., supply source files and asset libraries, etc.) which may be assembled to conform to desired design/gameplay specifications (such as one or more of those described herein).

In at least some embodiments, it is not possible to simply install and run COD (or other “mega title” arcade-type games) on an existing gaming machine, and have it perform as a hybrid skill-based/wager-based game described herein. Some elements of gameplay may need to be altered in order to achieve and/or provide various hybrid skill-based/wager-based game (HAWG) functionalities. In some embodiments, the initial process to get a hybrid skill-based/wager-based game “on the floor” (e.g., deployed on a casino gaming floor) may take some time (e.g., 4-8 months, including, for example, an amount of time to build the hybrid skill-based/wager-based game). However, this timeframe may be significantly shorter than the timeframes typically required for getting traditional wager-based gaming machines deployed “on the floor”. One reason for this is that the hybrid skill-based/wager-based game technology described herein provides the capability of seamless integration with pre-licensed products, such as, for example, IGT's Ghostbusters Video Slots. For example, in one embodiment, in a relatively short time period, a gaming machine manufacturer/distributor (such as IGT, Bally's, Aristocrat, etc.) could develop a hybrid skill-based/wager-based game version that capitalizes on the popularity of an existing licensed game-theme by providing a newer HAWG-type “gamer” version which incorporates a version of the existing licensed game-theme.

With respect to hybrid skill-based/wager-based gameplay, in at least some embodiments, HAWG may not require “points” to reach or obtain game levels. Rather, in some embodiments, HAWG allows freedom of play by allowing a player simply “continue on” by purely playing the game. This design allows for player defined gameplay progression.

In at least some embodiments, HAWG provides a conjoined and seamless entity wherein the act of wagering is based (at least partially) on the players physical ability to press a button and/or pull a trigger while “holding” a device (e.g., HID) and visually understanding the relationship/nature of the style/theme of game in which they are involved and the process(es) thereof needed to play said game. For example, a standard slot machine may require a player to:
put money in machine;
select wager;
initiate wager (via HID);
be informed of results; and
repeat wager initiation if desired.

For some HAWG embodiments, the process may involve similar steps, plus one or more additional step(s) involving the player operating a HID in order to interact with (e.g., shoot, grab, touch, avoid, etc.) virtual objects displayed on EGM display screen.

In one embodiment, the only “skills” required are human motor skills (e.g., “fine motor skills”) such as hand/eye coordination, to perform various arcade-type game activities such as, for example: point or navigate a reticle onto a NPC (e.g., zombie/alien), pull/press trigger/button, etc. In at least some embodiments, there are no “skillful requirements” needed for participating in a hybrid skill-based/wager-based game. Further, in various embodiments, no skill is needed or required for participating in the wager-based game event portion of the hybrid skill-based/wager-based game. In fact, in at least some embodiments, it is preferable the wager-based game event portion be implemented as a RNG-based game of chance. In this way, HAWG may be designed to be simple and fun without separation of entertainment and gambling.

Other benefits/features/advantages of the various hybrid skill-based/wager-based game embodiments described herein may include, but are not limited to, one or more of the following (or combinations thereof):
In some embodiments, the hybrid skill-based/wager-based game may be configured or designed to include functionality for enabling a player to specify a total maximum amount to be wagered during play of the hybrid skill-based/wager-based game. This allows the player more control over how much the player is willing to risk losing during play of the hybrid skill-based/wager-based game.
In some embodiments, the hybrid skill-based/wager-based gaming machine may distinguish between credits attributable to coin in, and credits attributable to wager-based game event payouts. For example, in some embodiments, the gaming machine may be configured or designed to maintain separate credit balances for: (i) credits funded by coin-in/ticket-in, and (ii) credits accumulated from wager-based game event payouts. In at least some embodiments, this helps facilitate the player's awareness of his or her total overall wager-based game event payouts during play of the hybrid skill-based/wager-based game. For example, in one embodiment, a player may deposit an initial amount of money (e.g., $10) into the gaming machine, and engage in hybrid skill-based/wager-based game play until the initial $10 is used up. In one embodiment, during play of the hybrid skill-based/wager-based game, any winnings/payouts awarded to the player (e.g., from wager-based game event outcomes) deposited and maintained in a separate “winnings” account (e.g., similar to the way physical coin winnings are dropped into the bottom cavity of a mechanical slot machine). At the end of the hybrid skill-based/wager-based game play (e.g., once the initial $10 is used up), the player may review the total value of the “winnings” account to determine how he/she did (e.g., is the player “up” overall, or “down” overall). In some embodiments, the player may optionally elect to have all (or a specified amount or percentage) of his/her “winnings” re-invested into the hybrid skill-based/wager-based game to fund additional wager-based game event(s).

In some HAWG embodiments, the outcome of a wager-based game event may be configured or designed to be dependent on HAWG's gamestate. In some embodiments, the design of gameplay may allow for additional events for both wager initiation and RNG outcome.

In some embodiments, hybrid skill-based/wager-based games may be configured or designed in a manner which allows for a unique credit display setup wherein, while the player is interacting within a specific level, a clearly defined display of gameplay earnings is shown to the player and once said level is complete, and/or player dies, and/or player no longer has credits, and/or player decides to discontinue play, the interactive game portion is “exited” and a “fun” animated display of tallied earnings as well as possible achievements are shown. This could be as simple as showing animated slot reels quickly spin through the collected earnings (e.g., via display of a fast free spin bonus wherein the reels have minimal or no anticipation). The nature of this configuration enables HAWG to provide for different types of experiential opportunities such as, for example, one or more of the following (or combinations thereof):
Corresponding with previous embodiments wherein toggle-able HUD elements provide a more in depth gaming experience.
Being the “end level points tally” seen in most popular games (even though earnings have already been individually displayed during gameplay) where the player “has a moment” to take it some or all in.
Assuming a player decides to discontinue play before the level ending tally screen, their earnings are still theirs and allow for them to simply collect & leave the gaming machine.

In at least some embodiments, HAWG games may be developed using regulatory (e.g., GLI) approved third party engines such as, for example (Unreal, Unity) accompanied by a complex series of blueprints and code which, when compiled, creates a packaged executable ready for storage on a gaming machine, system, and/or device.

It may be appreciated that, via the use of specifically configured computer hardware and software, the problems which are solved and/or overcome by the various hybrid skill-based/wager-based game techniques described herein are necessarily rooted in computer technology in order to overcome problems specifically arising in the realm of computer networks. For example, as described previously, most of wager-based games currently deployed at electronic gaming machines in casino establishments are configured or designed to primarily offer monetary-type payouts for wager-based game event outcomes. Additionally, such monetary-type payouts are typically unrelated to, and have no effect or influence on, the gameplay portion of the wager-based game being executed at the electronic gaming machine. Such problems and limitations specifically arise in the realm of electronic computing devices and computer networks, and the solutions to these problems and limitations (e.g., as described herein) are necessarily rooted in computer technology.

The present application herein incorporates by reference, in its entirety and for all purposes, U.S. Provisional Application Ser. No. 62/091,451 (Attorney Docket No. SYNBP001P), titled “HYBRID ARCADE-TYPE, WAGER-BASED GAMING TECHNIQUES”, naming Washington et al. as inventors, and filed 12 Dec. 2014.

The present application herein incorporates by reference, in its entirety and for all purposes, U.S. Provisional Application Ser. No. 62/127,821 (Attorney Docket No. SYNBP001P2), titled “RPG AND SPORTS THEMED HYBRID ARCADE-TYPE, WAGER-BASED GAMING TECHNIQUES”, naming Washington et al. as inventors, and filed 3 Mar. 2015.

The present application herein incorporates by reference, in its entirety and for all purposes, U.S. patent application Ser. No. 14/831,823 (Attorney Docket No. SYNBP001US) titled “FIRST PERSON SHOOTER, RPG AND SPORTS THEMED HYBRID ARCADE-TYPE, WAGER-BASED GAMING TECHNIQUES” by Washington et al., filed on 20 Aug. 2015.

The present application herein incorporates by reference, in its entirety and for all purposes, U.S. patent application Ser. No. 14/865,538 (Attorney Docket No. SYNBP001X1US) titled “HYBRID ARCADE-TYPE, WAGER-BASED GAMING TECHNIQUES AND PREDETERMINED RNG OUTCOME BATCH RETRIEVAL TECHNIQUES” by Washington et al., filed on 25 Sep. 2015.

The present application herein incorporates by reference, in its entirety and for all purposes, U.S. patent application Ser. No. 15/344,488 (Attorney Docket No. SYNBP003US) titled “HYBRID SKILL-BASED/WAGER-BASED GAMING ASPECTS RELATING TO ENTERTAINMENT AND WAGERING GAMING ACTIVITIES” by Washington et al., filed on 4 Nov. 2016.

The present application herein incorporates by reference, in its entirety and for all purposes, U.S. patent application Ser. No. 15/344,503 (Attorney Docket No. SYNBP004US) titled “GAMING ASPECTS RELATING TO MULTIPLAYER/TOURNAMENT HYBRID SKILL-BASED/WAGER-BASED GAMES” by Washington et al., filed on 4 Nov. 2016.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A computer implemented method employed in a computer network, the computer network including a first electronic, wager-based gaming device (“first EGD”), and a first random number generator engine (“first RNG engine”), the first EGD including a first display and a first input device, the method comprising causing at least one processor to execute a plurality of instructions stored in at least one memory to:
display, at the first display, a first game graphical user interface (“first game GUI”) configured to enable a player to engage in a first wager-based gaming session of a wager-based game conducted at the first EGD, the first game GUI including a skill-based game GUI portion;
display, at the skill-based game GUI portion, a playing field GUI portion, the playing field GUI portion being configured to display an array of virtual playing cards, the playing field GUI portion being further operable to enable the player to engage in interactive activity with at least one virtual playing card displayed at the playing field GUI portion;
store in a first memory a plurality of paytable data structures representing a first plurality of paytables;
store in the first memory, poker hand criteria defining a plurality of different types of poker hands, including a first poker hand type and a second poker hand type;
establish an account balance at the first EGM using at least a portion of cash or credit received from the first player;
enable the player to select a first set of virtual playing cards displayed at the playing field GUI portion;
identify, using the poker hand criteria, the first set of virtual playing cards as corresponding to the first poker hand type;
initiate, during the first wager-based gaming session and in response to the selection of the first set of virtual playing cards, a first wager-based event at the first EGD;
automatically fund a first amount wagered on the first wager-based event using funds from the account balance;
select a first paytable based on the identified first poker hand type, wherein the first paytable includes a first plurality of payout amounts including a first payout amount and a second payout amount which is different from the first payout amount;
randomly select, as an outcome of the first wager-based event, the first payout amount from the first plurality of payout amounts;
automatically distribute the first payout amount to the account balance;
enable the player to select a second set of virtual playing cards displayed at the playing field GUI portion;
identify, using the poker hand criteria, the second set of virtual playing cards as corresponding to the first poker hand type;
initiate, during the first wager-based gaming session and in response to the selection of the second set of virtual playing cards, a second wager-based event at the first EGD;
automatically fund a second amount wagered on the second wager-based event using funds from the account balance;
select the first paytable based on the identified first poker hand type;
randomly select, as an outcome of the second wager-based event, the second payout amount from the first plurality of payout amounts; and
automatically distribute the second payout amount the account balance.

2. The computer implemented method of claim 1:
wherein the first amount wagered and the second amount wagered are identical.

3. The computer implemented method of claim 1, wherein the first EGD includes a first bill or ticket acceptor, the system being further operable to cause the at least one processor to execute instructions stored in the memory to:
establish at least a portion of the account balance using at least a portion of cash or credit received via the first bill or ticket acceptor.

4. The computer implemented method of claim 1 further comprising causing the at least one processor to execute instructions to:
display, at the first game GUI, a wager-based game GUI portion configured to display wager-based game events relating to the wager-based gaming session;
display a representation of the first wager-based event being executed at the wager-based game GUI portion during the wager-based gaming session;
display a representation of the second wager-based event being executed at the wager-based game GUI portion during the wager-based gaming session at the wager-based game GUI portion; and
enable the player to concurrently engage in skill-based game play activities at the skill-based game GUI portion during execution of the second wager-based game event at the wager-based game GUI portion.

5. The computer implemented method of claim 1 further comprising causing the at least one processor to execute instructions to:
enable the player to select a third set of virtual playing cards displayed at the playing field GUI portion;
identify, using the poker hand criteria, the third set of virtual playing cards as corresponding to the second poker hand type;
initiate, during the first wager-based gaming session and in response to the selection of the third set of virtual playing cards, a third wager-based event at the third EGD;
automatically fund a third amount wagered on the third wager-based event using funds from the account balance;
select the second paytable based on the identified second poker hand type, wherein the second paytable includes a second plurality of payout amounts including a third payout amount and a fourth payout amount which is different from the third payout amount;
randomly select, as an outcome of the third wager-based event, the third payout amount from the second plurality of payout amounts; and
automatically distribute the third payout amount the account balance.

6. The computer implemented method of claim 1 further comprising causing the at least one processor to execute instructions to:
enable the player to select a third set of virtual playing cards displayed at the playing field GUI portion;
identify, using the poker hand criteria, the third set of virtual playing cards as corresponding to the second poker hand type;
initiate, during the first wager-based gaming session and in response to the selection of the third set of virtual playing cards, a third wager-based event at the first EGD;
automatically fund a third amount wagered on the third wager-based event using funds from the account balance;
select the second paytable based on the identified second poker hand type, wherein the second paytable includes a second plurality of payout amounts including a third payout amount and a fourth payout amount which is different from the third payout amount;
randomly select, as an outcome of the third wager-based event, the third payout amount from the second plurality of payout amounts;
automatically distribute the third payout amount the account balance;
enable the player to select a fourth set of virtual playing cards displayed at the playing field GUI portion;
identify, using the poker hand criteria, the fourth set of virtual playing cards as corresponding to the second poker hand type;
initiate, during the first wager-based gaming session and in response to the selection of the fourth set of virtual playing cards, a fourth wager-based event at the first EGD;
automatically fund a fourth amount wagered on the fourth wager-based event using funds from the account balance;
select the second paytable based on the identified second poker hand type;
randomly select, as an outcome of the fourth wager-based event, the fourth payout amount from the second plurality of payout amounts;
automatically distribute the third payout amount the account balance; and
wherein the third amount wagered and fourth amount wagered are identical.

7. A computer implemented system employed in a computer network, the computer network including a first electronic, wager-based gaming device (“first EGD”), and a first random number generator engine (“first RNG engine”), the first EGD including a first display and a first input device, the system comprising:
at least one processor;
at least one memory;
the at least one processor being operable to execute a plurality of instructions stored in at least one memory for causing at least one component of the computer network to:
display, at the first display, a first game graphical user interface (“first game GUI”) configured to enable a player to engage in a first wager-based gaming session of a wager-based game conducted at the first EGD, the first game GUI including a skill-based game GUI portion;
display, at the skill-based game GUI portion, a playing field GUI portion, the playing field GUI portion being configured to display an array of virtual playing cards, the playing field GUI portion being further operable to enable the player to engage in interactive activity with at least one virtual playing card displayed at the playing field GUI portion;
store in a first memory a plurality of paytable data structures representing a first plurality of paytables;
store in the first memory, poker hand criteria defining a plurality of different types of poker hands, including a first poker hand type and a second poker hand type;
establish an account balance at the first EGM using at least a portion of cash or credit received from the first player;
enable the player to select a first set of virtual playing cards displayed at the playing field GUI portion;
identify, using the poker hand criteria, the first set of virtual playing cards as corresponding to the first poker hand type;
initiate, during the first wager-based gaming session and in response to the selection of the first set of virtual playing cards, a first wager-based event at the first EGD;
automatically fund a first amount wagered on the first wager-based event using funds from the account balance;
select a first paytable based on the identified first poker hand type, wherein the first paytable includes a first plurality of payout amounts including a first payout amount and a second payout amount which is different from the first payout amount;
randomly select, as an outcome of the first wager-based event, the first payout amount from the first plurality of payout amounts;
automatically distribute the first payout amount to the account balance;
enable the player to select a second set of virtual playing cards displayed at the playing field GUI portion;
identify, using the poker hand criteria, the second set of virtual playing cards as corresponding to the first poker hand type;
initiate, during the first wager-based gaming session and in response to the selection of the second set of virtual playing cards, a second wager-based event at the first EGD;
automatically fund a second amount wagered on the second wager-based event using funds from the account balance;
select the first paytable based on the identified first poker hand type;
randomly select, as an outcome of the second wager-based event, the second payout amount from the first plurality of payout amounts; and
automatically distribute the second payout amount the account balance.

8. The computer implemented system of claim 7:
wherein the first amount wagered is the same as the second amount wagered.

9. The computer implemented system of claim 7, wherein the first EGD includes a first bill or ticket acceptor, the system being further operable to cause the at least one processor to execute instructions stored in the memory to:
establish at least a portion of the account balance using at least a portion of cash or credit received via the first bill or ticket acceptor.

10. The computer implemented system of claim 7 being further operable to cause the at least one processor to execute instructions to:
display, at the first game GUI, a wager-based game GUI portion configured to display wager-based game events relating to the wager-based gaming session;
display a representation of the first wager-based event being executed at the wager-based game GUI portion during the wager-based gaming session;
display a representation of the second wager-based event being executed at the wager-based game GUI portion during the wager-based gaming session at the wager-based game GUI portion; and
enable the player to concurrently engage in skill-based game play activities at the skill-based game GUI portion during execution of the second wager-based game event at the wager-based game GUI portion.

11. The computer implemented system of claim 7 being further operable to cause the at least one processor to execute instructions to:
enable the player to select a third set of virtual playing cards displayed at the playing field GUI portion;
identify, using the poker hand criteria, the third set of virtual playing cards as corresponding to the second poker hand type;
initiate, during the first wager-based gaming session and in response to the selection of the third set of virtual playing cards, a third wager-based event at the third EGD;
automatically fund a third amount wagered on the third wager-based event using funds from the account balance;
select the second paytable based on the identified second poker hand type, wherein the second paytable includes a second plurality of payout amounts including a third payout amount and a fourth payout amount which is different from the third payout amount;
randomly select, as an outcome of the third wager-based event, the third payout amount from the second plurality of payout amounts; and
automatically distribute the third payout amount the account balance.

12. The computer implemented system of claim 7 being further operable to cause the at least one processor to execute instructions to:
enable the player to select a third set of virtual playing cards displayed at the playing field GUI portion;
identify, using the poker hand criteria, the third set of virtual playing cards as corresponding to the second poker hand type;
initiate, during the first wager-based gaming session and in response to the selection of the third set of virtual playing cards, a third wager-based event at the first EGD;
automatically fund a third amount wagered on the third wager-based event using funds from the account balance;
select the second paytable based on the identified second poker hand type, wherein the second paytable includes a second plurality of payout amounts including a third payout amount and a fourth payout amount which is different from the third payout amount;
randomly select, as an outcome of the third wager-based event, the third payout amount from the second plurality of payout amounts;
automatically distribute the third payout amount the account balance;
enable the player to select a fourth set of virtual playing cards displayed at the playing field GUI portion;
identify, using the poker hand criteria, the fourth set of virtual playing cards as corresponding to the second poker hand type;
initiate, during the first wager-based gaming session and in response to the selection of the fourth set of virtual playing cards, a fourth wager-based event at the first EGD;
automatically fund a fourth amount wagered on the fourth wager-based event using funds from the account balance;
select the second paytable based on the identified second poker hand type;
randomly select, as an outcome of the fourth wager-based event, the fourth payout amount from the second plurality of payout amounts;
automatically distribute the third payout amount the account balance; and
wherein the third amount wagered and fourth amount wagered are identical.

13. A non-transitory computer usable medium for use in a computer network, the computer network including a first electronic, wager-based gaming device (“first EGD”), and a first random number generator engine (“first RNG engine”), the first EGD including a first display and a first input device, the computer usable medium having computer readable code embodied therein, the computer readable code comprising:
computer code for causing at least one processor to execute instructions to display, at the first display, a first game graphical user interface (“first game GUI”) configured to enable a player to engage in a first wager-based gaming session of a wager-based game conducted at the first EGD, the first game GUI including a skill-based game GUI portion;
computer code for causing at least one processor to execute instructions to display, at the skill-based game GUI portion, a playing field GUI portion, the playing field GUI portion being configured to display an array of virtual playing cards, the playing field GUI portion being further operable to enable the player to engage in interactive activity with at least one virtual playing card displayed at the playing field GUI portion;
computer code for causing at least one processor to execute instructions to store in a first memory a plurality of paytable data structures representing a first plurality of paytables;
computer code for causing at least one processor to execute instructions to store in the first memory, poker hand criteria defining a plurality of different types of poker hands, including a first poker hand type and a second poker hand type;
computer code for causing at least one processor to execute instructions to establish an account balance at the first EGM using at least a portion of cash or credit received from the first player;
computer code for causing at least one processor to execute instructions to enable the player to select a first set of virtual playing cards displayed at the playing field GUI portion;
computer code for causing at least one processor to execute instructions to identify, using the poker hand criteria, the first set of virtual playing cards as corresponding to the first poker hand type;
computer code for causing at least one processor to execute instructions to initiate, during the first wager-based gaming session and in response to the selection of the first set of virtual playing cards, a first wager-based event at the first EGD;
computer code for causing at least one processor to execute instructions to automatically fund a first amount wagered on the first wager-based event using funds from the account balance;
computer code for causing at least one processor to execute instructions to select a first paytable based on the identified first poker hand type, wherein the first paytable includes a first plurality of payout amounts including a first payout amount and a second payout amount which is different from the first payout amount;
randomly select, as an outcome of the first wager-based event, the first payout amount from the first plurality of payout amounts;
computer code for causing at least one processor to execute instructions to automatically distribute the first payout amount to the account balance;
computer code for causing at least one processor to execute instructions to enable the player to select a second set of virtual playing cards displayed at the playing field GUI portion;
computer code for causing at least one processor to execute instructions to identify, using the poker hand criteria, the second set of virtual playing cards as corresponding to the first poker hand type;
computer code for causing at least one processor to execute instructions to initiate, during the first wager-based gaming session and in response to the selection of the second set of virtual playing cards, a second wager-based event at the first EGD;
computer code for causing at least one processor to execute instructions to automatically fund a second amount wagered on the second wager-based event using funds from the account balance, wherein the second wagered amount is identical to the first wagered amount;
computer code for causing at least one processor to execute instructions to select the first paytable based on the identified first poker hand type;
computer code for causing at least one processor to execute instructions to randomly select, as an outcome of the second wager-based event, the second payout amount from the first plurality of payout amounts;
computer code for causing at least one processor to execute instructions to automatically distribute the second payout amount the account balance.
